(19) United States
(12) Patent Application Publication
(10) Pub. No.: US 2014/0039135 A1
(43) Pub. Date: Feb. 6, 2014

(54) CROSS-LINKED REACTIVE POLYMER MICROPARTICLES

(71) Applicants: Tamara Dikic, Bergen op Zoom (NL); Tom Verbrugge, Mariakerke (BE); Matteo Traina, Tenno (IT); Jocelyne Galy, Villeurbanne (FR); Jean-Francois Gerard, Bron (FR); Ludo Aerts, Mariakerke (BE)

(72) Inventors: Tamara Dikic, Bergen op Zoom (NL); Tom Verbrugge, Mariakerke (BE); Matteo Traina, Tenno (IT); Jocelyne Galy, Villeurbanne (FR); Jean-Francois Gerard, Bron (FR); Ludo Aerts, Mariakerke (BE)

(21) Appl. No.: 14/111,724

(22) PCT Filed: Apr. 16, 2012
(86) PCT No.: PCT/US12/33767

§ 371 Date: Oct. 14, 2013

Related U.S. Application Data
(60) Provisional application No. 61/476,114, filed on Apr. 15, 2011.

(51) Int. Cl. C08G 59/14

(52) U.S. Cl. CPC C08G 59/1477
USPC 525/523

(57) ABSTRACT

Embodiments of the present disclosure include a composition of cross-linked reactive polymer microparticles and a method of producing cross-linked reactive polymer microparticles that includes reacting an epoxy resin with an amine curing agent in a dispersing media at a temperature of 50° C. to 120° C. for a reaction time of no greater than 17 hours so that the cross-linked reactive polymer microparticles have no greater than 0.001 weight percent of the dispersing media bound to the cross-linked reactive polymer microparticles; and phase separating the cross-linked reactive polymer microparticles and the dispersing media.

### CROSS-REFERENCE TO RELATED APPLICATIONS

This application claims the benefit under 35 U.S.C. §119(e) of U.S. Provisional Patent Application No. 61/476,114, filed Apr. 15, 2011, which is incorporated herein by reference in its entirety.

### FIELD OF DISCLOSURE

This disclosure relates to polymers and in particular to cross-linked polymer particles and a method of their production.

### BACKGROUND

Toughness is the ability of a material to absorb energy and plastically deform without rupture and as a consequence the material will resist fracture when under stress. Polymers are often modified to improve their toughness. This is especially true with glassy polymers, such as thermosets with high cross-link densities. Such modifications can include the incorporation of a second phase consisting of particles that are usually spherical and of a rubbery polymer having a glass transition temperature, T_{g}, which is below the glassy polymers. The addition of this second phase can lead to improvements in the mechanical behavior of the glassy polymer.

In addition to having a lower Tg, the rubbery particles also typically have a modulus that is lower than the glassy polymers, which leads to stress concentrations at the equators of the particles during mechanical deformation. These stress concentrations can lead to shear yielding or crazing around the particles and throughout a large volume of the material. In this way, the glassy polymer can absorb a large amount of energy during deformation and is toughened.

In addition to rubber polymers, crosslinked particles having chemistries varying from acrylic to epoxy to urethane are also utilized as toughening agents. They are mainly produced by dispersion polymerization and stabilized by surfactants. Theses surfactants are either chemically or physically bounded to the particle surface. Once the toughening agents are incorporated into the final product, the interface created by the presence of surfactant between particles and the surrounding network is usually the place of the mechanical breakdown thus the toughening is achieved.

The presence of an interface, however, can also be a cause of premature, degradation and poor barrier properties, among other issues. In addition, formulations containing toughening particles, often need to be reformulated with the compatibilizer that will provide better wetting of the particles with the formulation. The presence of a surface active compound in the formulation can often result in its migration to the surface, which impacts the coatability of these networks. Therefore a number of applications, such as coatings and composites, would benefit from fully integrating the toughening agents.

### SUMMARY

Embodiments of the present disclosure provide for toughening agents that can be fully integrated into a curable epoxy system, as discussed herein. Specifically, embodiments of the present disclosure include a composition of cross-linked reactive polymer microparticles that are a reaction product of an epoxy resin and an amine curing agent reacted in a dispersing media at a temperature of 50° C. to 120° C. for a reaction time of no greater than 17 hours, during which the cross-linked reactive polymer microparticles phase separate in a discrete non-agglomerated form from the dispersing media, and where the dispersing media bound to the cross-linked reactive polymer microparticles have a concentration of no greater than 0.001 weight percent based on the weight of the cross-linked reactive polymer microparticles. So, the dispersing media bound to the cross-linked reactive polymer microparticles is no greater than 0.001 weight percent of the cross-linked reactive polymer microparticles based on the total weight of the cross-linked reactive polymer microparticles.

For the various embodiments, the reaction product is formed with an excess of one of the amine curing agent and the epoxy resin as expressed in an equivalent weight ratio. So, the reaction product is formed with an excess of the amine curing agent or the epoxy resin as expressed in an equivalent weight ratio. For the various embodiments, this excess can be expressed using an equivalent weight ratio, where, for example, the excess of the amine curing agent can be 1.35 to 1 (e.g., a 0.35 excess moles of amine hydrogen to moles of epoxy groups, which is provided herein as the amine to epoxy ratio or “de ratio”). Equivalent weight ratio, as used herein, uses the moles of amine hydrogen (from the amine curing agent) and the moles of epoxy groups (from the epoxy resin).

For the various embodiments, the epoxy resin and the amine curing agent each can have a concentration in the dispersing media of 5 to 30 weight percent based on the total weight of the dispersing media, the epoxy resin and the amine curing agent. For the various embodiments, the dispersing media is selected from the group consisting of poly(oxypropylene), dodecane, aliphatic ketone, cyclic ketone, alkene aliphatic, aromatic alkene, polyethers and combinations thereof.

For the various embodiments, the cross-linked reactive polymer microparticles of the present disclosure include no surfactant.

The embodiments of the present disclosure also include a method of producing the cross-linked reactive polymer microparticles. For the various embodiments, the method includes reacting the epoxy resin with the amine curing agent in the dispersing media at a temperature of 50° C. to 120° C. for a reaction time of no greater than 17 hours so that the cross-linked reactive polymer microparticles have no greater than 0.001 weight percent of the dispersing media bound to the cross-linked reactive polymer microparticles; and phase separating the cross-linked reactive polymer microparticles and the dispersing media. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. For the various embodiments, reacting the epoxy resin with the amine curing agent includes forming the cross-linked reactive polymer microparticles with an excess of one of the amine curing agent or the epoxy resin. So, forming the cross-linked reactive polymer microparticles is with an excess of the amine curing agent or the epoxy resin as expressed in an equivalent weight ratio. For example, forming the cross-linked reactive polymer microparticles can be with an excess of the amine curing agent expressed using an equivalent weight ratio of 1.35 amine curing agent to 1 of the epoxy resin (e.g., a 0.35 excess equivalent reactivity of the amine curing agent relative the epoxy resin). In other words, the equivalent weight ratio of 1.35 of the amine curing agent to 1 of the epoxy resin provides a 0.35 excess of moles of amine hydrogen in the amine curing agent relative to 1 mole of epoxy groups in the epoxy resin.

For the various embodiments, the method can also include removing the dispersing media from the cross-linked reactive polymer microparticles to leave no greater than 0.001 weight percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. For the various embodiments, the method includes using a solvent to remove the dispersing media from the cross-linked reactive polymer microparticles to leave no greater than 0.001 weight percent of the dispersing media bound to the cross-linked reactive polymer microparticles. The basis for the no greater than 0.001 weight percent of the dispersing media bound to the cross-linked reactive polymer microparticles is the total weight of the reactive polymer microparticles.

For the various embodiments, the method can further include not using a surfactant in producing the cross-linked reactive polymer microparticles.

### BRIEF DESCRIPTION OF THE DRAWINGS

FIG. 1A provides a DSC thermogram of DGEBA+DAT system (a/e ratio=1.35) according to the present disclosure.

FIG. 1B provides a glass transition temperature of a DGEBA+DAT system (a/e ratio=1.35) versus a/e ratio according to the present disclosure.

FIG. 2A provides a DSC thermogram of DGEBA+IPDA system (a/e ratio=1.35) according to the present disclosure.

FIG. 2B provides a glass transition temperature (Tg) DGEBA+IPDA system (a/e ratio=1.35) versus a/e ratio according to the present disclosure.

FIG. 3 provides a phase separation measurement, T=130° C., according to the present disclosure.

FIG. 4A-4C provide a SEC—where FIG. 4A: initial compounds (PPG-1000: D.E.R. 331: and DAT) c=3 mg/ml, RI signal; FIG. 4B: final residual solution and PPG-1000 at c=5 mg/ml, RI signal; and FIG. 4C: residual solution at c=5 mg/ml and DAT at c=0.01 mg/ml, according to the present disclosure.

FIG. 5 provides a thermogram of cross-linked reactive polymer microparticles, 1st scan and 2nd scan after 15 hours at 130° C., according to the present disclosure.

FIGS. 6A-6D: MDSC and TGA-MS Results for cross-linked reactive polymer microparticles (17 hours at 80° C.).

FIGS. 7A-7D: MDSC and TGA-MS Results for cross-linked reactive polymer microparticles (5 hours at 100° C.).

FIGS. 8A-8D: MDSC and TGA-MS Results for cross-linked reactive polymer microparticles (17 hours at 100° C.)

FIGS. 9A-9D: MDSC and TGA-MS Results for cross-linked reactive polymer microparticles (5 hours at 120° C.)

FIGS. 10A-10D: MDSC and TGA-MS Results for cross-linked reactive polymer microparticles (17 hours at 120° C.)

FIGS. 11A-11B: Overlay Plots for First Heating Results of Examples 14-18.

FIGS. 12A-12B: Overlay Plots for Second Heating Results of Examples 14-18.

FIGS. 13A-13B: An Overlay Plot for Second Heating Results of Examples 14-18.

FIGS. 14A-14D: MDSC and TGA-MS Results for dried cross-linked reactive polymer microparticles (17 hours at 80° C.).

FIGS. 15A-15D: MDSC and TGA-MS Results for dried cross-linked reactive polymer microparticles (17 hours at 100° C.).

FIGS. 16A-16D: MDSC and TGA-MS Results for dried cross-linked reactive polymer microparticles (5 hours at 120° C.).

FIGS. 17A-17D: MDSC and TGA-MS Results for dried cross-linked reactive polymer microparticles (17 hours at 120° C.).

FIG. 18: Overlay of MDSC Results (First Heating) for Dried Epoxy Particles

FIGS. 18A-18B: Overlay Plots for First Heating Results of Examples 14-18, dried.

FIGS. 19A-19B: Overlay Plots for Second Heating Results of Examples 14-18, dried.

FIGS. 20A-20B: Comparison of TGA-MS Results for PPG, Cross-Linked Reactive Polymer Microparticles and Epoxy matrix.

FIGS. 21A-21B: Comparison of TGA-MS Results for PPG, Cross-Linked Reactive Polymer Microparticles and Epoxy matrix.

FIGS. 22A-22B: Identification of Evolving Species at Low Temperature: Cross-Linked Reactive Polymer Microparticles produced over 17 hrs at 80° C.

FIGS. 23A-23B: Identification of Evolving Species at Low Temperature: Cross-Linked Reactive Polymer Microparticles produced over 5 hrs at 100° C.

FIGS. 24A-24B: Identification of Evolving Species at Low Temperature: Cross-Linked Reactive Polymer Microparticles produced over 17 hrs at 100° C.

FIGS. 25A-25B: Identification of Evolving Species at Low Temperature: Cross-Linked Reactive Polymer Microparticles produced over 5 hrs at 120° C.

FIGS. 26A-26B: Identification of Evolving Species at Low Temperature: Cross-Linked Reactive Polymer Microparticles produced over 17 hrs at 120° C.

FIG. 27 provides a SEM micrographs of Cross-Linked Reactive Polymer Microparticles as a function of reaction time at 130° C. according to the present disclosure.

FIG. 28 provides a particle size distribution as a function of reaction time (line: Gaussian fitting curves), according to the present disclosure.

FIG. 29 provides a cloud point as a function of monomer concentration (T=130° C.) according to the present disclosure.

FIG. 30 provides a comparison of Cross-Linked Reactive Polymer Microparticles diameter and yield as a function of reaction time according to the present disclosure.

FIG. 31 provides a Tg (2^{nd} scan, long reaction time) versus monomer concentration according to the present disclosure.

FIG. 32 provides a SEM micrographs obtained from solution of different monomer concentration according to the present disclosure.

FIGS. 33A and 33B provide an average diameter as a function of time and monomer concentration according to the present disclosure.

FIG. 34 provides a SEM micrographs of Cross-Linked Reactive Polymer Microparticles having different stoichiometry according to the present disclosure.

FIGS. 35A and 35B provide an average diameter as a function of molar ratio and reaction time according to the present disclosure.

FIG. 36 provides a cloud point as a function of temperature (full dots: light transmittance measurement, empty dots: visual observation) according to the present disclosure.

FIG. 37 provides SEM micrographs of cross-linked reactive polymer microparticles reacted at different temperature according to the present disclosure.

FIGS. 38A and 38B provide an average diameter as a function of time and temperature of reaction according to the present disclosure.

FIG. 39 provides SEM micrographs of cross-linked reactive polymer microparticles synthesized in a mixture of PPG and dodecane according to the present disclosure.

FIGS. 40A and 40B provides a cross-linked reactive polymer microparticles diameter as a function of reaction time and wt % of dodecane in the solvent mixture according to the present disclosure.

FIGS. 41A and 41B provide a thermograms of IPDA-based cross-linked reactive polymer microparticle, top: 17 hours at 80° C., bottom: 24 hours at 80° C. according to the present disclosure.

FIG. 42 provides SEM micrographs of cross-linked reactive polymer microparticles as a function of reaction time at 80° C.: 4.5 hours and 24 hours according to the present disclosure.

FIG. 43 provides diameter as a function of reaction time at 80° C. according to the present disclosure.

FIGS. 44A and 44B provide a SEM micrograph of cross-linked reactive polymer microparticle based on IPDA and variation of diameter as a function of temperature and time of reaction according to the present disclosure.

### DETAILED DESCRIPTION

Embodiments of the present disclosure provide for cross-linked reactive polymer microparticles. For the various embodiments, the cross-linked reactive polymer microparticles of the present disclosure can be used in a curable epoxy system. Unlike other approaches, however, the cross-linked reactive polymer microparticles of the present disclosure can react with at least one of the epoxy resins and/or the hardener of the curable epoxy system so as to fully integrate into the cured curable epoxy system. In other words, the cross-linked reactive polymer microparticles of the present disclosure do not form discrete interfaces with the surrounding curable epoxy system, but are rather chemically integrated therein as a contiguous part of the curable epoxy system.

For the various embodiments, the cross-linked reactive polymer microparticles of the present disclosure can be synthesized via precipitation polymerization and subsequently stored and dispersed with an epoxy resin and a hardener of a curable epoxy system. As provided herein, the reaction conditions used in forming the cross-linked reactive polymer microparticles allow the microparticles to be formed without a surfactant. In addition, the reaction conditions used in forming the cross-linked reactive polymer microparticles also allows the microparticles to be essentially free of a dispersing agent, or agents, used in the synthesis of the microparticles. As such, the surface of the microparticles of the present disclosure does not include a surfactant or a significant amount of the dispersing agent(s) used in the reaction mixture (e.g., polyethers, as discussed herein). Rather, as discussed herein, the reaction conditions used in forming the microparticles can be used to preferentially present either epoxy reactive groups and/or amine reactive groups at the surface of the microparticles.

For the various embodiments, the presence of either the epoxy reactive group and/or the amine reactive group at the surface of the microparticles allows for the microparticles to be chemically integrated in a contiguous fashion into the cured curable epoxy system. As such, when the microparticles of the present disclosure are used with a curable epoxy system having the same epoxy resin and hardener of the microparticles, the resulting cured epoxy system can be compositionally homogeneous.

In addition, the microparticles of the present disclosure also allow for the resulting curable epoxy system to be morphologically heterogeneous. For example, the cross-linked reactive polymer microparticles can have a cross-link density that is different than a cross-link density of the curable epoxy system in which they are chemically integrated. It is also possible that the cross-linked reactive polymer microparticles can have two or more cross-link densities that are different than a cross-link density of the curable epoxy system in which they are chemically integrated. The curable epoxy system with the chemically integrated cross-linked reactive polymer microparticles could be compositionally homogeneous, but morphologically and topologically heterogeneous. This is because the reaction composition and the reaction conditions of the cross-linked reactive polymer microparticles can be controlled independent of those of a curable epoxy system.

So, ‘heterogeneities’ can be imparted into the curable epoxy system in which the microparticles are added, while still maintaining compositional homogeneity (e.g., when the microparticles, or a mixture of microparticles, can have a cross-link density that is different than the remainder of the curable epoxy system). This integration of the cross-linked reactive polymer microparticles into the curable epoxy system can allow for the curable epoxy system to have a heterogeneous morphology, which may help in improving the toughness of the curable epoxy system. Possible applications for such curable epoxy system can include wind mill blades and automotive panels.

As discussed herein, the cross-linked reactive polymer microparticles of the present disclosure can be fully integrated (e.g., covalently integrated) in the curable epoxy system network by virtue of having unreacted amine and/or epoxy groups present at the surface and/or within the microparticles. For example, they can interact with the curable epoxy system network via surface active groups or within its volume if the microparticles are swollen by formulation ingredients and are not fully crosslinked. These microparticles can be employed as toughening agents, or simply as additives to the curable epoxy system. If the compositions of both the microparticles and the curable epoxy system are identical, the integration can be full without identifiable interfaces being present.

For the various embodiments, the composition of cross-linked reactive polymer microparticles can be the reaction product of at least one epoxy resin and at least one amine curing agent in the presence of a dispersing media, where the reaction conditions (e.g., reaction temperature, reaction time, epoxy to amine ratio, among others) allow for the cross-linked reactive polymer microparticles to phase separate in a discrete non-agglomerated form with little or no dispersing media bound to the cross-linked reactive polymer microparticles.

The cross-linked reactive polymer microparticles can be produced by reacting the epoxy resin with the amine curing agent in the dispersing media. The reaction can proceed without stirring and, depending on the choice of the epoxy resin, the amine curing agent and/or the dispersing media, at a point along the reaction, a phase separation occurs in which the cross-linked reactive polymer microparticles are formed. Parameters that potentially have an influence on the structure (e.g., the size, the polydispersity, the surface chemistry, and the Tg, among others), the yield and the phase separation of the cross-linked reactive polymer microparticles include the concentration of the monomers dissolved (expressed as a weight percent of the monomer); the amine/epoxy molar ratio; the reaction temperature and time; the dispersing media and the chemical structure of the amine curing agent.

More specifically, embodiments of the present disclosure include a composition of cross-linked reactive polymer microparticles that is a reaction product of the epoxy resin and the amine curing agent reacted in the dispersing media at a temperature of 50° C. to 120° C. for a reaction time of no greater than 17 hours, during which the cross-linked reactive polymer microparticles phase separate in a discrete non-agglomerated form from the dispersing media. For the various embodiments, the dispersing media can be bound to the cross-linked reactive polymer microparticles at a concentration of no greater than 0.001 weight percent based on the weight of the cross-linked reactive polymer microparticles. So, the dispersing media bound (e.g., absorbed) to the cross-linked reactive polymer microparticles is no greater than 0.001 weight percent of the cross-linked reactive polymer microparticles based on the total weight of the cross-linked reactive polymer microparticles.

For the various embodiments, the cross-linked reactive polymer microparticles can be formed via precipitation polymerization process without the use of a surfactant. Precipitation polymerization is a polymerization process that begins initially as a homogeneous system in a continuous phase, where the monomers (e.g., epoxy resin and amine curing agent) are completely soluble in the dispersion media, but upon initiation the formed polymer microparticle become insoluble and precipitate. Precipitation polymerization allows the cross-linked reactive polymer microparticles to be formed in a micron-size range. The cross-linked reactive polymer microparticles of the present disclosure can be produced via the precipitation polymerization method without the need for and/or the use of a surfactant.

Surprisingly, the microparticles of the present disclosure are relatively monodisperse. In addition, in some specific cases (like the presence of a nonsolvent, as provided herein) a bimodal distribution with the submicron diameter particles is also possible. As such, the cross-linked reactive polymer microparticles of the present disclosure are less likely to form an interface, as discussed herein, with the curable epoxy system as there is no surfactant on the surface of the microparticles. For the various embodiments, no surfactant is present on the surface of the microparticles because no surfactant was used in producing the cross-linked reactive polymer microparticles.

For the precipitation polymerization, the dispersing media can be either a neat solvent or a mixture of solvents, as long as the solubility parameters of the dispersing media can be matched to those of the epoxy resin and hardener monomers so as to provide a phase separation of the cross-linked reactive polymer microparticles. For the various embodiments, a variety of dispersion media can be used in the dispersion polymerization of the present disclosure. For example, the dispersing media can be selected from the group consisting of polyethers (e.g., polypropylene glycol (PPG) and/or polyisobutylene ether), poly(oxypropylene), polybutylene oxide, aliphatic ketone, cyclic ketone such as cyclohexane and/or cyclohexanone, polyethers and combinations thereof. Preferably, the dispersing media is polypropylene glycol.

For the various embodiments, a nonsolvent can also be used with the dispersing media. Examples of suitable nonsolvents include, but are not limited to, alkenes (either aliphatic (dodecane) or cyclic), aromatic alkene, orthopthalates, alkyl azelates, other alkyl capped-esters and ethers, and combinations thereof.

For the various embodiments, the cross-linked reactive polymer microparticles can be produced by dissolving the epoxy resins and the amine curing agent in the dispersing media such that each has a concentration in the dispersing media of 5 to 30 weight percent based on the total weight of the dispersing media, the epoxy resin and the amine curing agent. Preferably, the epoxy resins and the amine curing agent in the dispersing media have a concentration in the dispersing media of 10 to 30 weight percent based on the total weight of the dispersing media, the epoxy resin and the amine curing agent. Most preferably, the epoxy resins and the amine curing agent in the dispersing media have a concentration in the dispersing media of 10 weight percent based on the total weight of the dispersing media, the epoxy resin and the amine curing agent.

The epoxy resin and the amine curing agent can be dissolved individually or together in the dispersing media. The reaction is allowed to proceed at a rate of reaction which can be adjusted by means of the reaction temperature. During this process, the initially clear solution changes into a dispersion as the microparticles precipitate out of the dispersing media. The size of the polymer particles in the dispersing media dispersion can be influenced by the selection of the raw materials as well as their concentration in the dispersing media, the reaction time, and the reaction temperature.

For the various embodiments, the reaction temperatures can be from 50° C. to 170° C., preferably 80° C. to 120° C. The reaction times are a function of the temperature, the amine/epoxy molar ratio; the dispersing media, the use of a catalyst (among others) and are dependent upon the chemical structure of the epoxy resins and the amine curing agent. When using polyamines as the amine curing agent, for instance, the rate of the polyaddition reaction can be influenced by the amine's basicity as well as by steric factors. For the various embodiments, the reaction time in forming the composition of cross-linked reactive polymer microparticles can be no greater than 17 hours. Other suitable reaction times can include, but are not limited to, a time of 5 to 17 hours. Preferably, the reaction time can be no greater than 5 hours. Again this depends on the temperature, the amine/epoxy molar ratio; the dispersing media, the use of a catalyst and the chemical structure of the epoxy resins and the amine curing agent.

It is also possible to use a catalyst in forming the cross-linked reactive polymer microparticles of the present disclosure. Such catalysts are known in the art. Suitable catalysts are, for example, amines, preferably ethylene diamine, diethylene triamine, triethylene tetraamine, aminoethyl piperazine, organic acids, e.g. dicarboxylic acids, phenol compounds, imidazole and its derivatives, and calcium nitrate.

For the various embodiments, the choice of the reaction temperature, the dispersing media and the amine curing agent, as provided herein, influence the solubility of the cross-linked reactive polymer microparticles. These choices allow for a phase separation of the cross-linked reactive polymer microparticles from the dispersing media to occur before a significant amount of the dispersing media has an opportunity to react with either of the amine curing agent and/or the epoxy resin. For example, with a rapid phase separation of the microparticles due to the choice of reaction temperature, the amine curing agent, and the solubility parameters of the dispersing media, the opportunity for the dispersing media to react with the epoxy resin can be greatly reduced. In other words, the less solubility the cross-linked reactive polymer microparticles have at a given reaction temperature and time, the less likely they are to react or interact with the dispersing media. It is appreciated that not all dispersing media reacts with the epoxy and/or amine groups, where most dispersants do not react at all.

A wide variety of epoxy resins are useful for the purpose of the present disclosure. The epoxy resins are organic materials having an average of at least 1.5, generally at least 2, reactive 1,2-epoxy groups per molecule. These epoxy resins can have an average of up to 6, preferably up to 4, most preferably up to 3, reactive 1,2-epoxy groups per molecule. These epoxy resins can be monomeric or polymeric, saturated or unsaturated, aliphatic, cyclo-aliphatic, aromatic or heterocyclic and may be substituted, if desired, with other substituents in addition to the epoxy groups, e.g. hydroxyl groups, alkoxyl groups or halogen atoms.

Suitable examples include epoxy resins from the reaction of polyphenols and epihalohydrins, polyalcohols and epihalohydrins, amines and epihalohydrins, sulfur-containing compounds and epihalohydrins, polycarboxylic acids and epihalohydrins, polyisocyanates and 2,3-epoxy-1-propanol (glycide) and from epoxidation of olefinically unsaturated compounds.

Preferred epoxy resins are the reaction products of polyphenols and epihalohydrins, of polyalcohols and epihalohydrins or of polycarboxylic acids and epihalohydrins. Mixtures of polyphenols, polyalcohols, amines, sulfur-containing compounds, polycarboxylic acids and/or polyisocyanates can also be reacted with epihalohydrins. Illustrative examples of epoxy resins useful herein are described in The Handbook of Epoxy Resins by H. Lee and K. Neville, published in 1967 by McGraw-Hill, New York, in appendix 4-1, pgs 4-56, which is incorporated herein by reference.

For bisphenol A type epoxy resin the average epoxy equivalent weight is advantageously from about 170 up to about 3000, preferably from about 170 up to about 1500. The average epoxy equivalent weight is the average molecular weight of the resin divided by the number of epoxy groups per molecule. The molecular weight is a weight average molecular weight.

Preferred examples of epoxy resins are bisphenol A type epoxy resins having an average epoxy equivalent weight of from about 170 to about 200. Such resins are commercially available from The Dow Chemical Company, as D.E.R. 330, D.E.R. 331 and D.E.R. 332 epoxy resins. Further preferred examples are resins with higher epoxide equivalent weight, such as D.E.R. 667, D.E.R. 669 and D.E.R. 732, all of which are commercially available from The Dow Chemical Company.

Another class of polymeric epoxy resins which are useful for the purpose of the present disclosure includes the epoxy novolac resins. The epoxy novolac resins can be obtained by reacting, preferably in the presence of a basic catalyst, e.g. sodium or potassium hydroxide, an epihalohydrin, such as epichlorohydrin, with the resinous condensate of an aldehyde, e.g. formaldehyde, and either a monohydric phenol, e.g. phenol itself, or a polyhydric phenol. Further details concerning the nature and preparation of these epoxy novolac resins can be obtained in Lee, H. and Neville, K., Handbook of Epoxy Resins, McGraw Hill Book Co. New York, 1967, which teaching is included herein by reference. Other useful epoxy novolac resins include those commercially available from The Dow Chemical Company as D.E.N. 431, D.E.N. 438 and D.E.N. 439 resins, respectively.

For the various embodiments, a variety of amine curing agents can be used in preparing the cross-linked reactive polymer microparticles of the present disclosure. Those amine curing agents which may be employed are primarily the multifunctional, preferably di- to hexafunctional, and particularly di- to tetrafunctional primary amines. Examples of such amine curing agents include, but are not limited to, isophorone diamine (IPDA), ethylene diamine, tetraethyle amine and 2,4-diaminotoluene (DAT) diamines. Mixtures of two or more of the amine curing agents can also be used. Also modified hardeners where amines are reacted in vast excess with epoxy resin can be good candidates as amine curing agents.

For the various embodiments, the reaction product of the composition of cross-linked reactive polymer microparticles can be formed with a molar excess of one of the amine curing agent or the epoxy resin. For example, a molar excess of the amine curing agent, relative the epoxy resin, can be used in forming the cross-linked reactive polymer microparticles. In other words, a molar excess of the amine hydrogen's, relative the epoxy groups, can be used in forming the cross-linked reactive polymer microparticles. Alternatively, a molar excess of the epoxy groups, relative the amine hydrogens, can be used in forming the cross-linked reactive polymer microparticles. For the various embodiments, this molar excess can be expressed as an equivalent weight ratio of the amine curing agent used in reacting with the epoxy resin. For example, the equivalent weight ratio of amine to epoxy, or epoxy to amine, can be from 0.7 to 1.35. For the various embodiments, the equivalent weight ratio could also be 1. Equivalent weight ratio, as used herein, uses the moles of amine hydrogen (from the amine curing agent) and the moles of epoxy groups (from the epoxy resin).

A further aspect of the present disclosure is a method of producing the cross-linked reactive polymer microparticles by reacting the epoxy resin and the amine curing agent, as discussed herein. For the various embodiments, the method of producing the cross-linked reactive polymer microparticles includes reacting the epoxy resin with the amine curing agent in the dispersing media at a temperature as provided herein (e.g., a temperature of 50° C. to 120° C.).

As discussed herein, the epoxy resin can be mixed with the amine curing agent to provide a molar excess of one of the amine curing agent or the epoxy resin. The mixture can be heated to the reaction temperature to allow the reaction between the epoxy and amine to proceed for the reaction time. For the various embodiments, stirring the reaction mixture is not necessary.

As discussed herein, the reaction time for the method can be of no greater than 17 hours. The cross-linked reactive polymer microparticles produced according to this method have no greater than 0.001 weight percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. So, the dispersing media bound to the cross-linked reactive polymer microparticles constitutes no greater than 0.001 weight percent of the cross-linked reactive polymer microparticles based on the total weight of the cross-linked reactive polymer microparticles. This is achieved, in part, through the reaction temperature, the reaction time, and the phase inversion that is facilitated by the choice of dispersing agent provided herein. As discussed herein, a surfactant is not used in the method of forming the microparticles of the present disclosure.

For the various embodiments, the method may further include phase separating the cross-linked reactive polymer microparticles and the dispersing media. For the various embodiments, the microparticles can also undergo one or more washings so as to remove the dispersing media from the cross-linked reactive polymer microparticles to leave no greater than 0.001 weight percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. This may be especially preferred when it is desired to remove more of the dispersing media from the cross-linked reactive polymer microparticles than would be possible by evaporation alone. For example, following the formation of the microparticles, the dispersing media and the microparticles can be separated (e.g., by centrifugation followed by decanting). The microparticles can then be re-suspended in a washing liquid at room temperature (e.g., 23° C.). The microparticles can then be separated from the washing liquid (e.g., by centrifugation followed by decanting). The microparticles can be washed more than once.

As variety of washing liquids are possible. Examples of such washing liquids include, but are not limited to, acetone, ethanol, tetrahydrofuran, ketones such as methylethyl ketone, end capped ethers, and combinations thereof.

For the various embodiments, the cross-linked reactive polymer microparticles of the present disclosure can have a number average diameter for a monomodial distribution of 10 nm to 10000 nm, preferably of 50 nm to 5000 nm, most preferably of 100 nm to 3000 nm. For the various embodiments, when the dispersing media includes polybutylene oxide, the cross-linked reactive polymer microparticles can have a bimodal size distribution of a first diameter and a second diameter, the first number average diameter being from 100 to 300 nanometers and the second number average diameter being from 0.5 to 10 μm.

As more fully illustrated in the Examples section below, the reaction conditions (e.g., reaction temperature, reaction time, epoxy to amine ratio, among others) discussed herein influence at least the dimensional, morphological, thermal and surface properties of the cross-linked reactive polymer microparticles. In addition, the surface chemistry of the microparticles is also dependent upon the reaction conditions and the molar ratios of the amine curing agent and the epoxy resin, as discussed herein.

The following examples illustrate the present disclosure. Unless otherwise mentioned, all parts and percentages are weight parts and weight percentages. The examples should not be construed to limit the present disclosure.

### EXAMPLES

The following examples are given to illustrate, but not limit, the scope of this disclosure. The examples provide methods and specific embodiments of the cross-linked reactive polymer microparticles of the present disclosure. As provided herein, the cross-linked reactive polymer microparticles can provide, among other things, the ability to impart an increase in the heterogeneity of a curable epoxy system (epoxy formulation).

### Materials

Diglycidyl ether of Bisphenol A (DGEBA, D.E.R. 331™, The Dow Chemical Company).

2,4-Diaminotoluene (DAT), an aromatic curing agent (Aldrich, used as received).

Isophorone diamine (IPDA), a cycloaliphatic curing agent (Aldrich, used as received).

Poly(propylene glycol) (PPG), two different molecular weights (PPG-1000 and PPG-3500), a solvent (Aldrich, used as received).

Dodecane, a solvent (Aldrich, used as received).

Polybutylene oxide (PBO) with different molecular weight and terminal groups as provided in Table 1 (Aldrich, used as received).

Acetone (Aldrich, used as received).

Tetrahydrofuran (Sigma Aldrich, analytic grade, used as received).

Table 1 lists the chemical structures and characteristics of the above compounds.

TABLE 1
Characteristics of the compounds used.

| Name | | Chemical structure (reference) |
|---|---|---|
| Diglycidyl ether of Bisphenol A (D.E.R. 331 ™) | DGEBA | 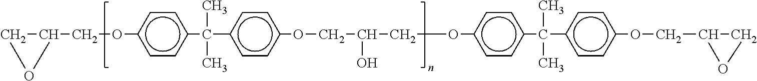 |
| 2,4- diamino- toluene | DAT | 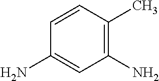 |
| Iso- phorone diamine | IPDA | 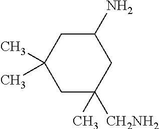 |
| Poly (propylene glycol) | PPG | 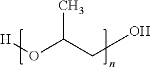 |
| Dodecane | | H₃C—(—(CH₂—)₁₀—CH₃ |

| | Mn | Solubility parameter |
|---|---|---|
| Name | (g/mol) | (MPA^{1/2}) |
| Diglycidyl ether of | 374 | |
| Bisphenol A (D.E.R. 331 ™) | | |
| 2,4-diaminotoluene | 122 | |
| Isophorone diamine | 170 | |
| Poly(propylene glycol) | 1000 | 18.9 |
| | 3500 | |
| Dodecane | | 17.1 |

### Examples 1-18

### Preparation Based on DGEBA and DAT of the Cross-Linked Reactive Polymer Microparticles

Table 2 provides the experimental conditions to use in preparing Examples 1-18 of cross-linked reactive polymer microparticles based on the reaction between DGEBA and DAT, as discussed herein. The cross-linked reactive polymer microparticles of Examples 1-18 were produced via a dispersion polymerization method without the use of a surfactant. Polypropylene glycol (PPG) was utilized as the dispersing media, either alone or with the addition of a nonsolvent (dodecane).

For each of the Examples 1-18, dissolve DGEBA and DAT separately in the solvent, as provided in Table 2, at T=40 degrees Celsius (° C.) for 20 minutes (min) and T=40° C. for 30 min, respectively, to obtain a homogeneous solution for each monomer having a monomer concentration as provided in Table 2. Mix the DGEBA solution and the DAT solution to prepare the different molar ratios of amine to epoxy (a/e ratio), as provided in Table 2. Place the mixtures in a pre-heated oven (from 80° C. to 160° C., as provided in Table 2) to allow the reaction between epoxy and amine to proceed for the reaction time provided in Table 2 without stirring and with periodic sampling.

Separate each sample of the cross-linked reactive polymer microparticles from the solvent by centrifugation at 4000 rotations per minute (rpms) for 20 minutes (min) to remove most of the solvent. Wash the cross-linked reactive polymer microparticles with an excess of acetone at room temp (23° C.) and repeat centrifugation. Dry the cross-linked reactive polymer microparticles in vacuo at room temperature (23° C.). The details concerning the experimental conditions are reported in Table 2.

Reference cross-linked reactive polymer microparticles (referred to as “Reference A” in Table 2) provide an amine to epoxy ratio of 1.35 a/e ratio, monomer concentration of 10 weight percent (wt %), PPG-1000 solvent, reaction temperature: 130° C. and reaction time: 15 hours.

TABLE 2
Experimental conditions used for Examples 1-18 of cross-linked reactive polymer
microparticles based on DGEBA-DAT

| | | Amine to | | Monomer | Reaction |
|---|---|---|---|---|---|
| | | Epoxy ratio | Temperature | Concentration | time |
| Example | Solvent | (a/e ratio) | (° C.) | (wt %) | (hours) |
| Reference A | PPG-1000 | 1.35 | 130 | 10 | 15 |
| 1 | PPG-1000 | 0.7 | 130 | 10 | 15 |
| 2 | | 1 | | | |
| 3 | | 2 | | | |
| 4 | PPG-1000 | 1.35 | 80 | 10 | 100 |
| 5 | | | 100 | | 50 |
| 6 | | | 160 | | 15 |
| 7 | PPG-1000 | 1.35 | 130 | 5 | 20 |
| 8 | | | | 30 | 5 |
| 9 | PPG-1000 + | 1.35 | 80 | 10 | 100 |
| 10 | 10 wt % | | 130 | 10 | 15 |
| 11 | dodecane | | 130 | 30 | 20 |
| 12 | PPG-1000 + | 1.35 | 130 | 10 | 10 |
| | 50 wt % | | | | |
| | dodecane | | | | |
| 13 | PPG-1000 + | 1.35 | 80 | 10 | 5 |
| | 10 wt % | | | | |
| | dodecane | | | | |
| 14 | PPG-1000 + | 1.35 | 80 | 10 | 17 |
| | 10 wt % | | | | |
| | dodecane | | | | |
| 15 | PPG-1000 + | 1.35 | 100 | 10 | 5 |
| | 10 wt % | | | | |
| | dodecane | | | | |
| 16 | PPG-1000 + | 1.35 | 100 | 10 | 17 |
| | 10 wt % | | | | |
| | dodecane | | | | |
| 17 | PPG-1000 + | 1.35 | 120 | 10 | 5 |
| | 10 wt % | | | | |
| | dodecane | | | | |
| 18 | PPG-1000 + | 1.35 | 120 | 10 | 17 |
| | 10 wt % | | | | |
| | dodecane | | | | |

### Examples 19-25

### Preparation Based on DGEBA and IPDA of the Cross-Linked Reactive Polymer Microparticles

Table 3 provides the experimental conditions to use in preparing Examples 19-25 of cross-linked reactive polymer microparticles based on the reaction between DGEBA and IPDA, as discussed herein. The cross-linked reactive polymer microparticles of Examples 19-25 were produced via a dispersion polymerization method without the use of a surfactant. PPG was utilized as the dispersing media, either alone or with the addition of a nonsolvent (dodecane).

For each of the Examples 19-25, dissolve DGEBA and IPDA separately in the solvent, as provided in Table 3, at T=40° C. for 20 min and T=80° C. for 30 min, respectively, to obtain a homogeneous solution having a monomer concentration as provided in Table 3. Mix the DGEBA solution and the IPDA to prepare the different ratios of amine to epoxy (a/e ratio), as provided in Table 3. Place the mixtures in a pre-heated oven (from 80° C. to 130° C., as provided in Table 3) to allow the reaction between epoxy and amine to proceed for the reaction time provided in Table 3, without stirring and with periodic sampling.

Separate each sample of the cross-linked reactive polymer microparticles as discussed above for example 1-18. The details concerning the experimental conditions are reported in Table 3. Reference cross-linked reactive polymer microparticles (Reference B in Table 3) provides an amine to epoxy molar ratio of 1.35 a/e ratio, monomer concentration of 10 weight percent (%). PPG-1000 solvent, reaction temperature: 80° C. and reaction time: 17 hours.

TABLE 3
Experimental conditions used for Examples 19-25 of cross-linked reactive polymer
microparticles based on DGEBA-IPDA.

| | | Amine to | | Monomer | Reaction |
|---|---|---|---|---|---|
| | | Epoxy ratio | Temperature | Concentration | time |
| Example | Solvent | (a/e ratio) | (° C.) | (wt %) | (hours) |
| Reference B | PPG-1000 | 1.35 | 80 | 10 | 17 |
| 19 | PPG-1000 | 1 | 80 | 10 | 17 |
| 20 | PPG-1000 + | 1.35 | 80 | 10 | 5 |
| 21 | 10 wt % | | 100 | 10 | 5 |
| 22 | dodecane | | 130 | 10 | 5 |
| 23 | | | 100 | 10 | 17 |
| 24 | | | 130 | 10 | 17 |
| 25 | PPG-1000 + | 0.7 | 130 | 10 | 17 |
| | 10 wt % | | | | |
| | dodecane | | | | |

### Bulk Epoxy Networks

Bulk epoxy networks prepared with DGEBA and DAT (Comparative Epoxy Example A), and DGEBA and IPDA (Comparative Epoxy Example B) were synthesized at different amine/epoxy molar ratios with a curing cycle in a pre-heated oven at 130° C. for 4 hours and then in a pre-heated oven at 180° C. for 4 hours. DSC was used to determine the enthalpy of the reactions and the glass transition temperature for each of the Comparative Epoxy Examples A and B. These values were used for comparison with the values obtained for Examples 1-25. Comparative Epoxy Examples A and B are also used to validate other data such as elemental analysis and XPS as provided herein.

### Characterization Methods

Light Transmittance Measurements (Cloud Point Measurements)

Light transmittance was measured through the solution during the synthesis of the cross-linked reactive polymer microparticles. Light transmittance was measured using an instrument composed of an electrical heating device, a temperature control for the heating device, a glass test tube attached to the electrical heating device, where the tube is filled with the sample to be analysed, a light source and sensor (Zeiss KL1500 LCD) and a computer for the data (e.g., light intensity) acquisition.

Cloud points were determined with the light transmittance device described above. With this technique the intensity of a light through a sample is recorded as a function of temperature or as a function of time. When the sample turns from transparent to cloudy/opaque (or the opposite) the intensity of the light transmitted through the sample shows a decrease (or an increase respectively). The beginning of this decrease is called the cloud point, it corresponds to the appearance of particles (by a phase separation process) having a diameter in the order of 0.1 μm.

Size Exclusion Chromatography (SEC)

SEC was used to separate and calculate the content of DGEBA, DAT and PPG monomers in the reaction solution at the end of the reaction. Calibration was previously realized for each compound, using different concentrations. The elution media used was tetrahydrofuran (THF), the flow rate was 1 ml/min, and three columns (Waters HR0.5, HR1 and HR2) were used for the separation; the detection was done using a refractive index detector and a UV-Vis detector (λ=254 nm).

Modulated Differential Scanning Calorimetry (MDSC) Experiments Thermal Properties

MDSC experiments were performed on a TA Instruments model Q2000 DSC equipped with a refrigerated cooling system. Data were collected using the Thermal Advantage for Q series (version 2.7.0.380) software package and reduced using version 4.4A of the Universal Analysis 2000 software package. The calorimeter was calibrated for temperature with Adamantane (Mp=−64.53° C.), n-Octadecane (Mp=28.24° C.), Indium (Mp=156.60° C.) and Zinc (Mp=419.47° C.) at a scan rate of 10° C./min. The enthalpy signal was calibrated from the Indium (ΔH=28.71 J/g) analysis. Circa 7 mg samples were accurately weighed using a Mettler analytical balance. Light-weight (ca 25 mg) Al pans were employed for the experiments on the cross-linked reactive polymer microparticles. The pans were crimped to improve sample/pan contact but the seal is not hermetic. Prior to a second analysis of the cross-linked reactive polymer microparticles the samples were dried at 40° C. in a vacuum oven (pressure: 10 mbar) for about 64 hours. T-zero pans with hermetic lid were employed to study the curing of the Comparative Epoxy (DER 331 plus IPDA) matrix. The same temperature profile was employed as for the cross-linked reactive polymer microparticle samples.

TABLE 4
Experimental conditions used for the MDSC Analysis
of the cross-linked reactive polymer microparticles
MDSC Method

| | | | | | |
|---|---|---|---|---|---|
| Temperature | 5° | C./Min | Sample Container | See text | Closed |
| Scan Rate | | | | | |
| Minimum Test | 0° | C. | Sample Weight | 7-10 | mg |
| Temperature | | | | | |
| Maximum Test | 200° | C. | | | |
| Temperature | | | | | |
| Amplitude | +/−0.5° | C. | Period | 40 | sec |

Thermal Gravimetric Analysis Coupled with Mass Spectroscopy (TGA-MS) Experiments

The TGA-MS experiments were performed via a TA Instruments model Q5000 TGA coupled to a Balzer Thermostar GSD 300 MS. Data were collected using the Thermal Advantage for Q series (version 2.7.0.380) software package and reduced using version 4.4A of the Universal Analysis 2000 software package for the TGA data and Quadstar 422 software (Version 6.0) for the MS data. The MS data were exported in ASCII format and further reduced in the Universal Analysis package. The samples were placed on a Pt-pan and accurately weighed by the calibrated TGA-balance.

TABLE 5
Experimental conditions used for the TGA-MS Analysis
of the cross-linked reactive polymer microparticles
TGA-MS Method

| | | | | | |
|---|---|---|---|---|---|
| Temperature Scan | 10° | C./Min | Sample Container | Pt | Open |
| Rate | | | Material | | |
| Minimum Test | 25° | C. | Sample Weight | ~5 | mg |
| Temperature | | | | | |
| Maximum Test | 380° | C. | Atmosphere | He | |
| Temperature | | | | | |

| | | | | |
|---|---|---|---|---|
| Detector | Channeltron | Mass range | 10-120 | amu |

| | | |
|---|---|---|
| Scan speed | 0.2 | sec |

Differential Scanning Calorimetry (DSC)

The dried cross-linked reactive polymer microparticles powders were analyzed by using DSC in order to obtain the residual enthalpy of reaction (if any) and the glass transition temperature of the cross-linked reactive polymer microparticles. DSC measurements were performed with Q20 (TA) and Mettler DSC 30 (Mettler Toledo GmbH) calorimeters. A first heating ramp (10° C./min) from −60 up to 250° C. was followed by a cooling stage down to 0° C. (50° C./min) and by a second heating ramp up to 200° C. All the tests were conducted under helium (TA Q20 calorimeter) or argon (Mettler DSC 30 calorimeter). The data were analyzed by using the software Universal Analysis 2000 v.4.2E (Q20) and STARe v.8.10 (Mettler DSC 30). DSC was also used to characterize the bulk networks.

Scanning Electron Microscopy (SEM)

SEM was carried out to study the morphology of the cross-linked reactive polymer microparticles and to evaluate their size. The dried cross-linked reactive polymer microparticles were observed with a Philips XL20 SEM. Preparation of the sample was as follows: the cross-linked reactive polymer microparticle powder was put on a metal stub covered with a conductive graphite adhesive and then gold coated by sputtering. Micrographs were collected at several magnifications by applying typically a voltage of 15 kV. The SEM micrographs were used to determine the particle size distribution. The particle size distribution was calculated by using a not-weighted counting procedure of the cross-linked reactive polymer microparticles. This fact practically means that the two tails of the particle distribution has the same weight even if the tail at smaller dimension represents a smaller weight (or volume) fraction of the system. The measurements were conducted by using the open source software ImageJ (Version 1.42q. Available at http://rsb.info.nih.gov/ij): for each sample at least 300 particles were measured in order to have statistical meaning of the data.

### Results and Discussion

The Examples 1-25 provide non-agglomerated cross-linked reactive polymer microparticles with narrow size distribution. The diameter was in the micrometer-size range although in some specific cases (like the presence of a nonsolvent) bimodal distribution with the submicron diameter particles was observed. The reaction conditions used in the reactions influence the size, yield and phase separation of the cross-linked reactive polymer microparticles. Hence, effective amine to epoxy ratio, temperature of the reaction and reaction time were considered as parameters of the cross-linked reactive polymer microparticles synthesis. DAT/D.E.R. 331™ in a PPG formulation were used to establish some relationships between the reaction parameters and cross-linked reactive polymer microparticles properties. These relationships include the observation that as the epoxy to amine ratio increases, the diameter of the cross-linked reactive polymer microparticles decreases. As the reaction time increases, the diameter of the cross-linked reactive polymer microparticles increases. As the reaction temperature increases, the rate of reaction increases and the cross-linked reactive polymer microparticles had a smaller diameter. Finally, as the monomer content increases, the diameter of the cross-linked reactive polymer microparticles increases while the polydispersity remains relatively constant.

The weight percent (wt. %) of the monomers used in forming the cross-linked reactive polymer microparticles (e.g., epoxy resin and diamine) also has an impact on the reaction yield. In case of 50 wt % monomer loading, cross-linked reactive polymer microparticles were phase separating faster as the reaction progressed and were agglomerated. Hence a 10 wt % of monomer loading was used to better ensure a sufficiently high yield and prevent agglomeration of particles. The reaction yield in the PPG was above 90% (as determined by SEC).

Reference Cross-Linked Reactive Polymer Microparticles

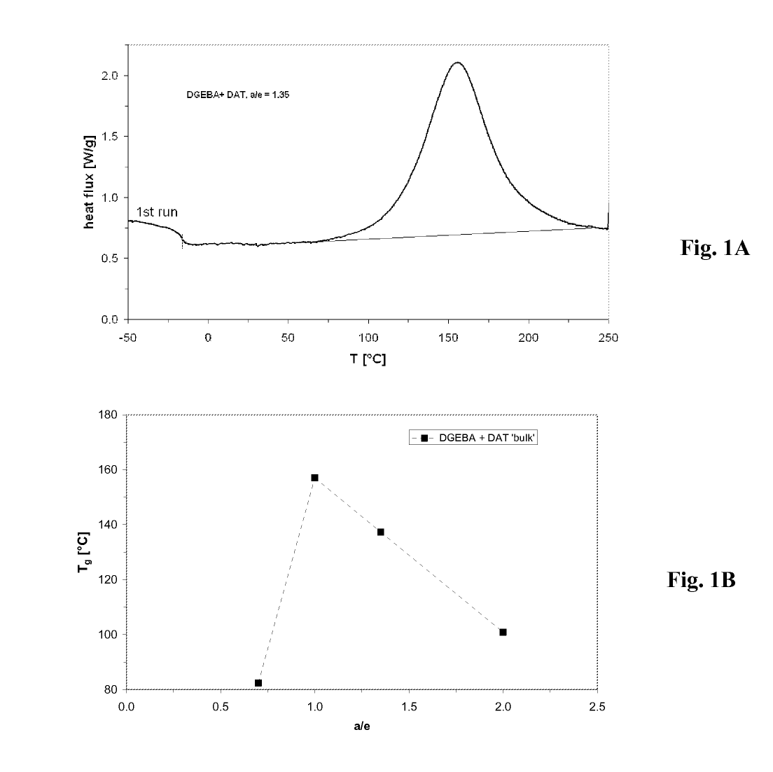

An example of a DSC thermogram obtained on Reference A (Table 1, DGEBA+DAT, a/e ratio=1.35) is shown in FIG. 1A. The glass transition temperature (Tg₀) of the epoxy compound of Reference A before reaction and the exothermic peak of reaction are observed. This peak has a maximum at about 160° C. and an enthalpy of reaction ΔH=378 J/g. The results of the Tg values (on cured samples) as function of a/e ratio are shown in FIG. 1B. A trend with a maximum Tg=157° C. for a/e ratio=1 is obtained. This plot is useful for comparison with the Tg values of the cross-linked reactive polymer microparticles of Examples 1-12.

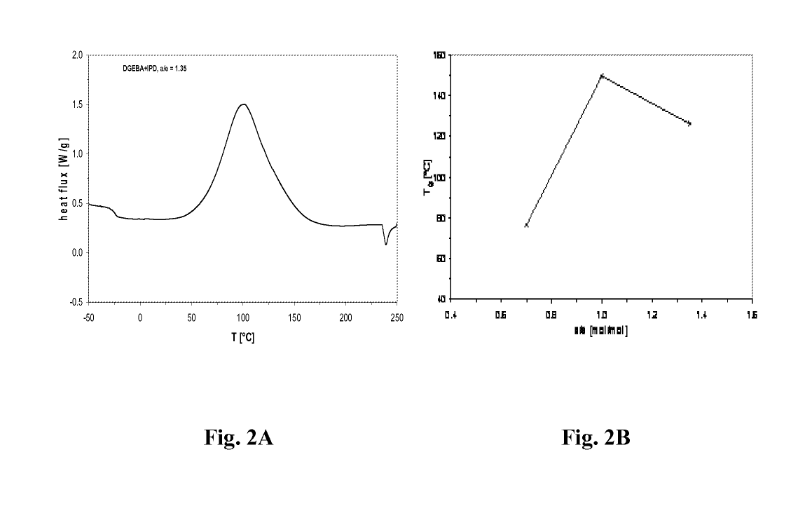

Similar experiments were done on Reference B (Table 2, DGEBA+IPDA, a/e ratio=1.35). FIG. 2A shows the IPDA reacting at a lower temperature, the temperature at the maximum of the exothermic peak is about 100° C. and the enthalpy of reaction is equal to ΔH=390 J/g. The variation of Tg versus a/e ratio follows the trend, i.e. maximum of Tg for a/e ratio=1, as shown in FIG. 2B.

Characterization of Reference A

The cross-linked reactive polymer microparticles of Reference A having a molar ratio a/e ratio=1.35 (i.e. an excess of amine) were expected to favour the presence of amino groups on the surface of the cross-linked reactive polymer microparticles. The solvent was PPG-1000 due to its high boiling point (the reaction temperature was 130° C.) in order to have reasonable reaction time using DAT, the monomer concentration was 10 wt %. The structure of the cross-linked reactive polymer microparticles was explored by employing several techniques.

Synthesis of Reference A

During the progress of the reaction, the initially colourless transparent homogenous monomer solution became cloudy and slightly yellowish. After centrifugation, washing and drying, as discussed above, a yellowish/brown powder was obtained.

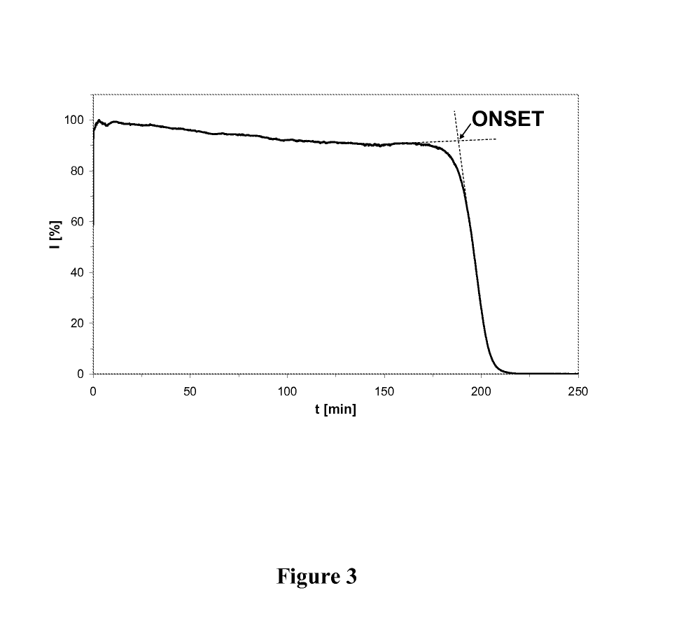

Phase separation occurred in less than 4 hours of reaction; in order to have more precise value of the phase separation kinetics, the light transmittance through the solution was monitored at 130° C. and presented in the plot in FIG. 3: for the given reaction conditions, the phase separation occurs after 187 min (3.1 hours).

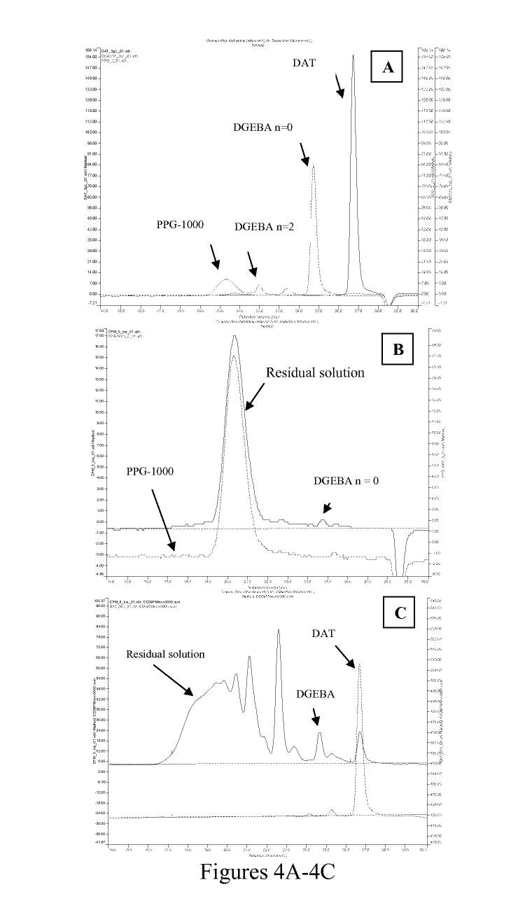

The residual solutions are also analyzed by SEC (by diluting the residual solution with THF (3 mg/ml and 5 mg/ml, 2 times)). Examples of typical chromatograms obtained on the initial compounds (DGEBA/DAT/PPG-1000) and at the end product of the reaction (reaction time=15 hours) are shown in FIG. 4. The elution volumes of PPG-1000, DGEBA and DAT are Ve=20.3 ml, 24.7 ml and 26.7 ml respectively (FIG. 4A). All compounds are very well separated. In FIG. 4b, a main peak (RI signal) corresponding to PPG-1000 is observed and a very small peak corresponding to unreacted DGEBA (n=0). There is no peak corresponding to DAT at 26.7 ml, but this is a very small amount that can be in the limits of detection of the refractive index detector. The UV signal at 254 nm (FIG. 4C) was also utilized to detect end products of the reaction since it is more sensitive to DEGBA and DAT (due to the presence of aromatic rings). A DAT peak is observed as well as the presence of oligomers.

From calibration curves established for each component, it is possible to deduce the amount of DGEBA and DAT present in the residual solution. Twelve percent (12%) of the initial DGEBA and 2% of the initial DAT remain in the solution (average value over the three, tests) so it gives a yield of 86% for the epoxy+amine reaction (if the oligomers which remain in the solution are neglected). The yield by SEC is slightly lower than the value obtained by the gravimetric method, because SEC considered only the epoxy-amine conversion into the cross-linked reactive polymer microparticles. It was not determined whether the difference is due to the presence of PPG in the cross-linked reactive polymer microparticles of Reference A or to sedimentation of cross-linked reactive polymer microparticles of Reference A.

Characterization of the Cross-Linked Reactive Polymer Microparticles Thermal Properties

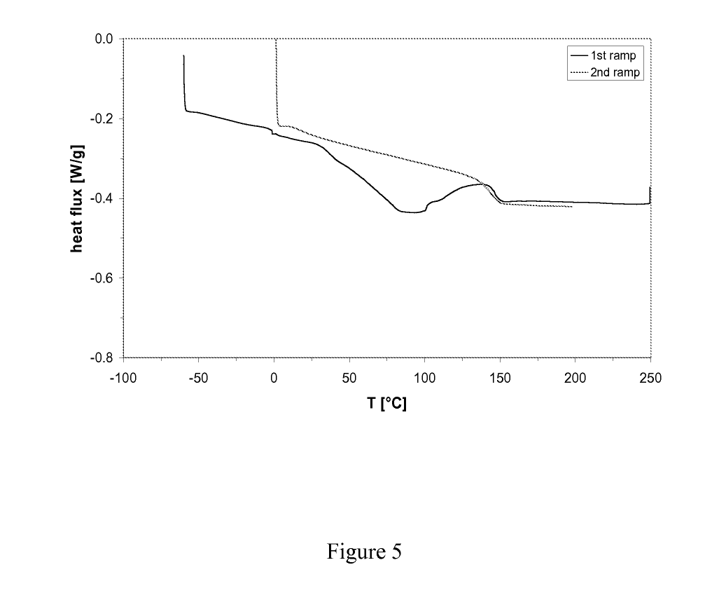

An example of the curves of the heat flux as a function of temperature from the DSC experiments on the dried cross-linked reactive polymer microparticles (Example 1 obtained after 15 hours of reaction at 130° C.) are shown in FIG. 5. The thermograph of the first heating scan is rather complex: there is an endothermic peak in the temperature region between 50° C. and 100° C. and then a glass transition is observed. The endothermic peak is related to the residual acetone (used in the washing process); using the specific heat of evaporation of the acetone, i.e. 538.9 J/g, the residual amount of acetone was estimated to be in the range 5-7 wt.-%. The second heating scan showed a clear glass transition at 147° C., very similar to the one observed during the first scan. These comments are valid for all Examples 1-12: there is no significant difference between the 1^{st} and the 2^{nd} scan.

If the cross-linked reactive polymer microparticles have a stoichiometry similar to the initial one in the feed mixture, a/e ratio=1.35, then the Tg should be equal to 137° C. The value obtained is higher so the effective stoichiometry of the cross-linked reactive polymer microparticles must be close to 1.2 if there are only made of DGEBA and DAT (FIG. 1). However the results from yield, TGA and XPS suggested that there is PPG-1000 in the cross-linked reactive polymer microparticles of Examples 1-12. The following hypothesis can be advanced: (1) PPG is adsorbed or reacted at the surface of the microparticles and its amount is very small (because of the several washing treatments) and (2) PPG may be inside the microparticles in phase separated domains; it cannot be in the cross-linked reactive polymer microparticles as a miscible polymer because it will lead to a decrease of Tg (only few polymers are miscible with epoxy networks, ex: PMMA).

MDSC Experiments:

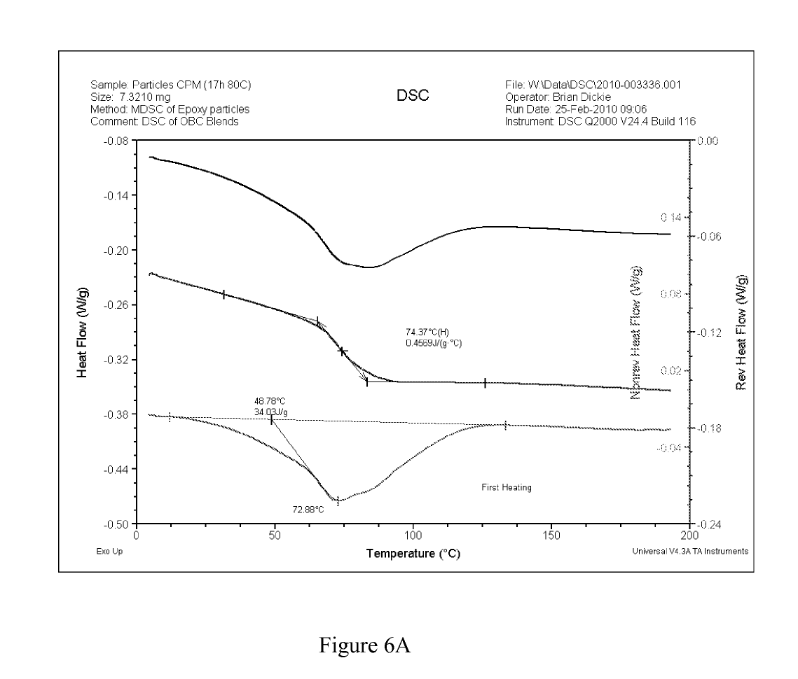

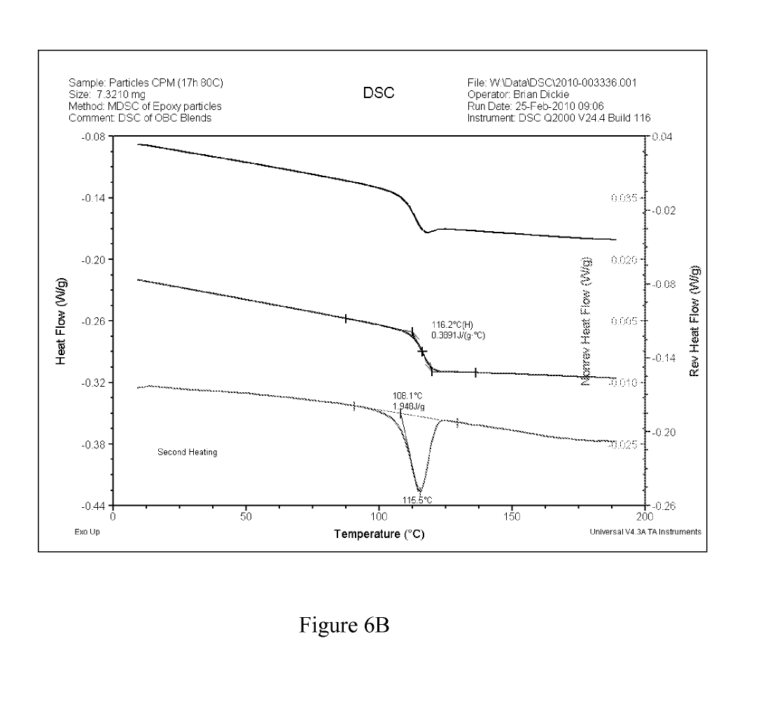

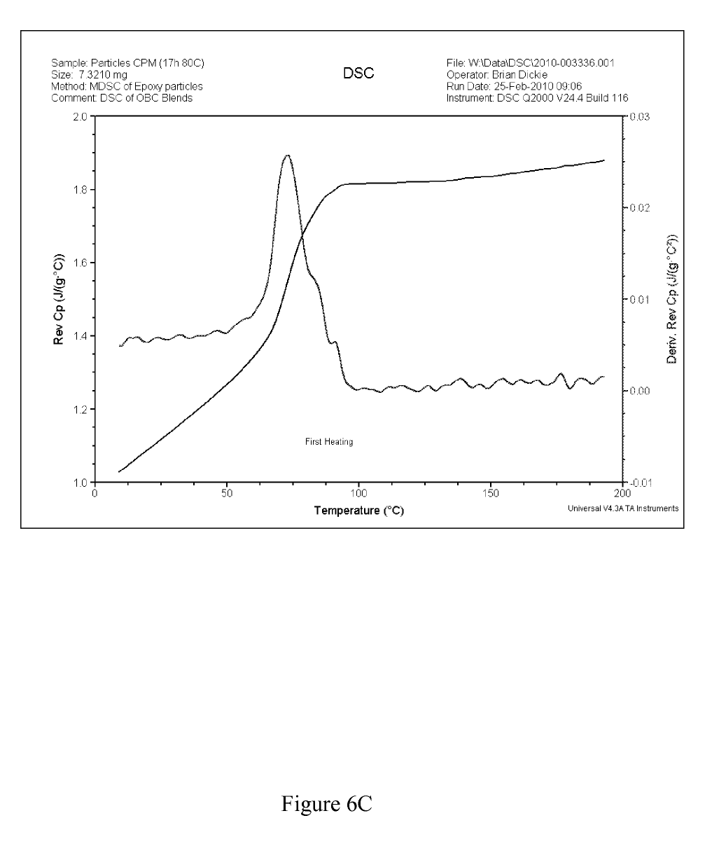

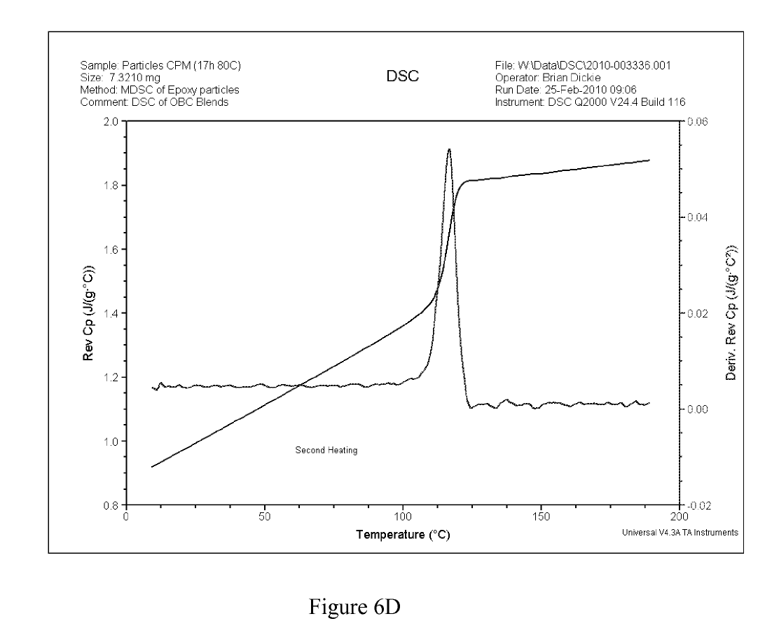

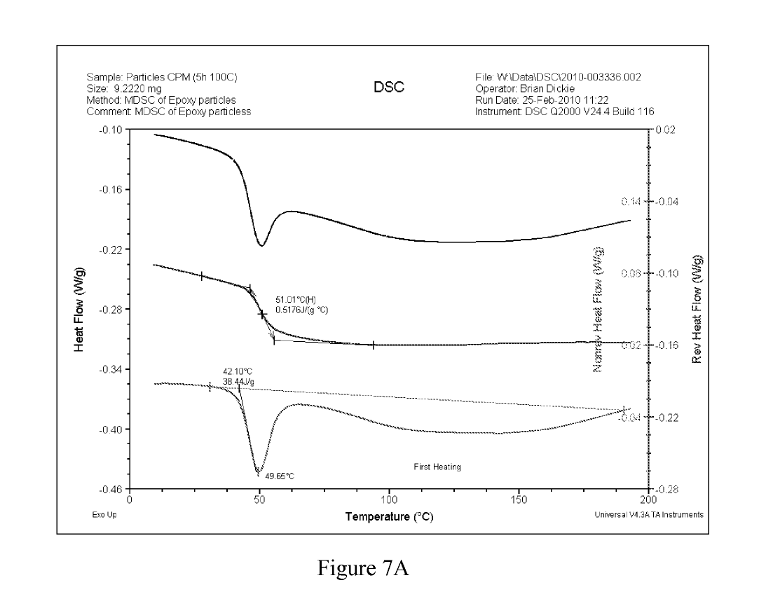

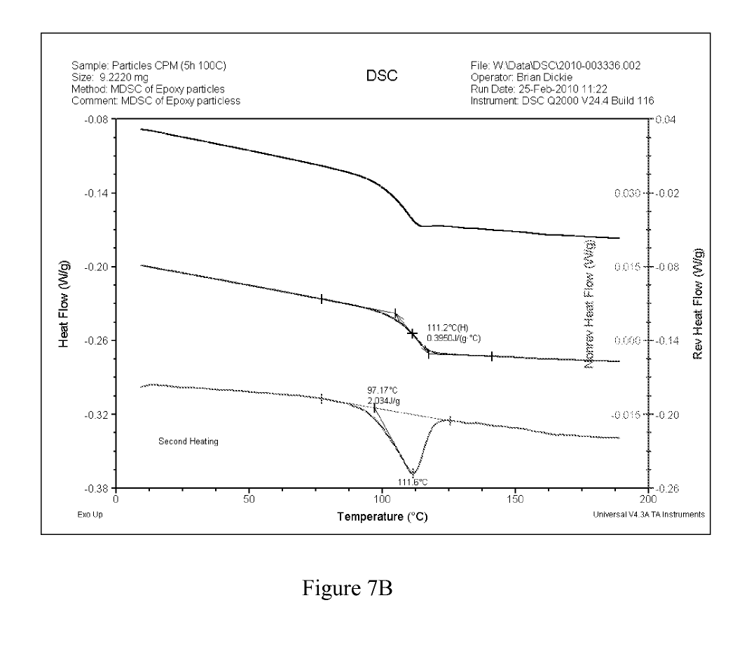

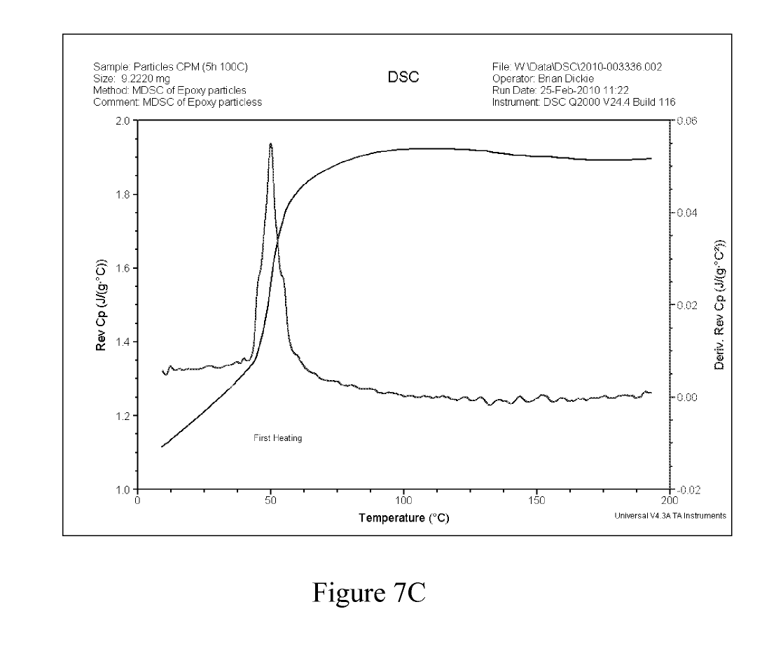

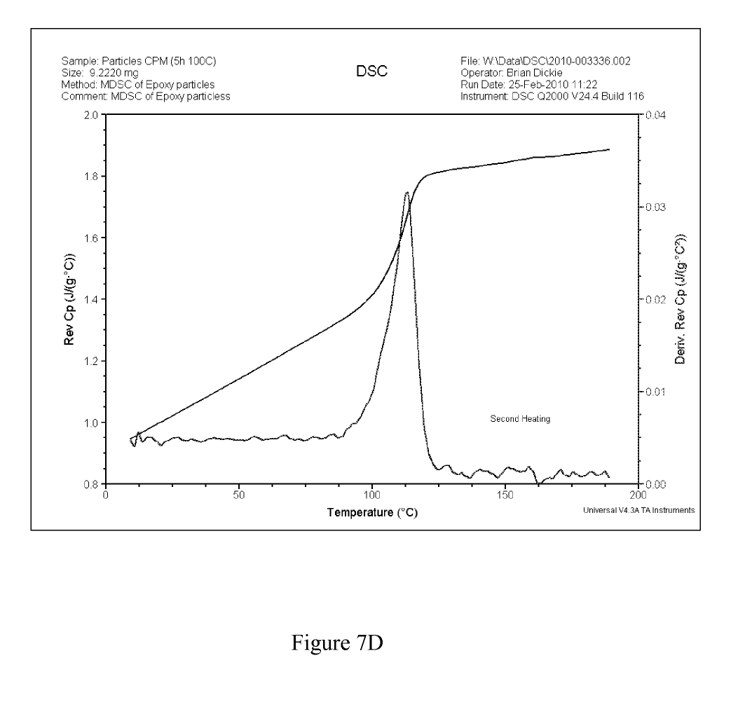

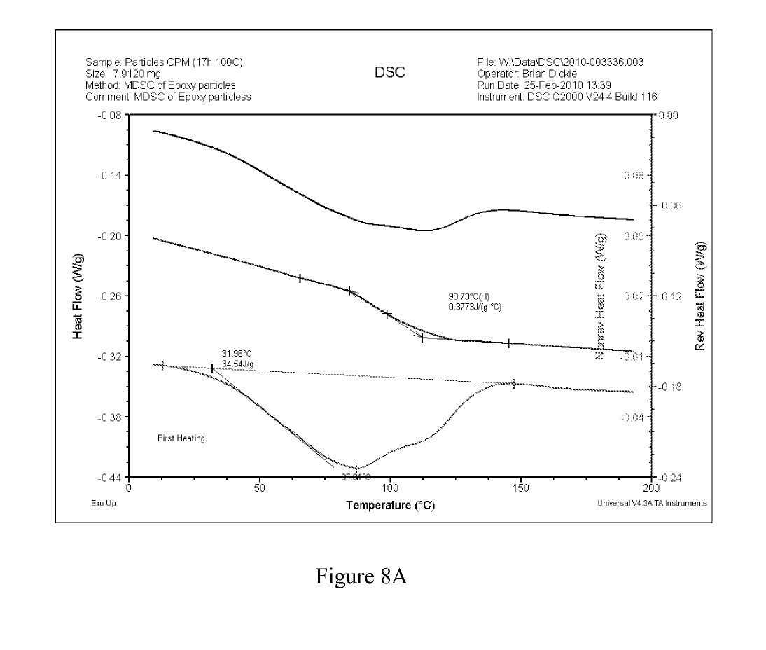

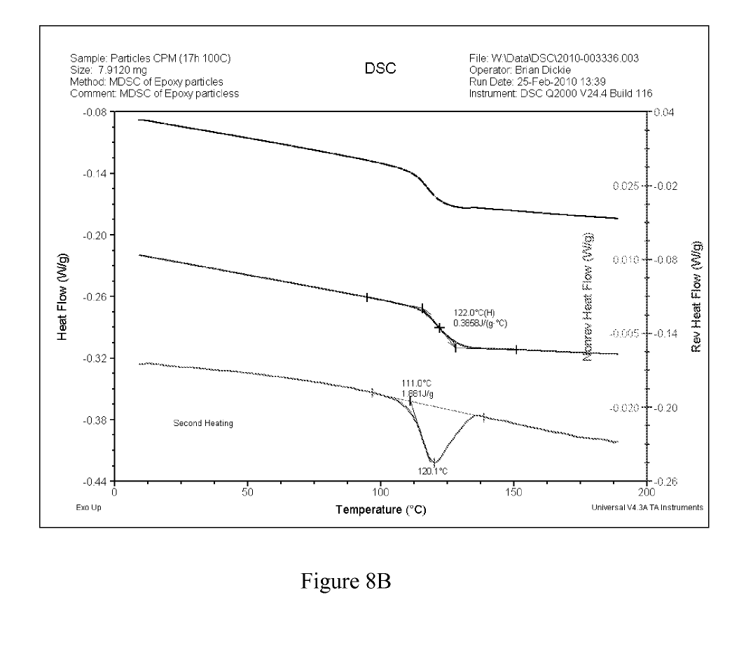

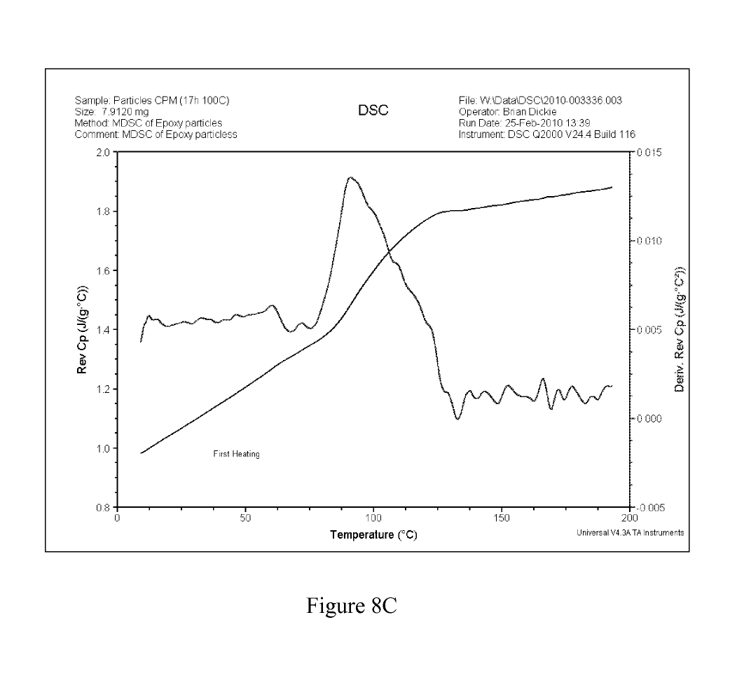

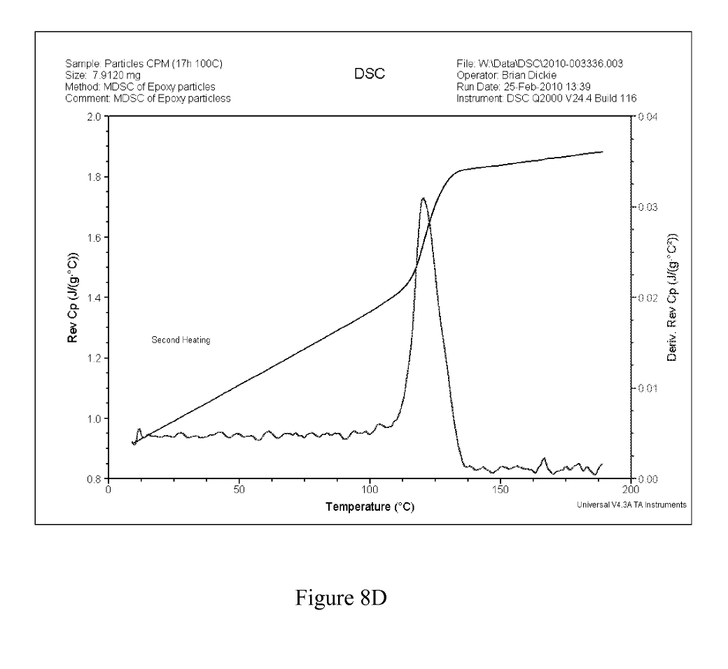

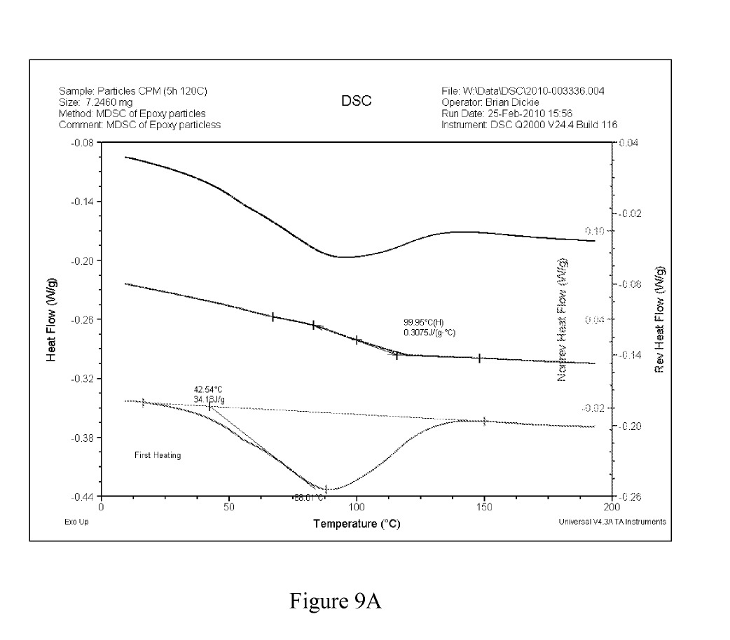

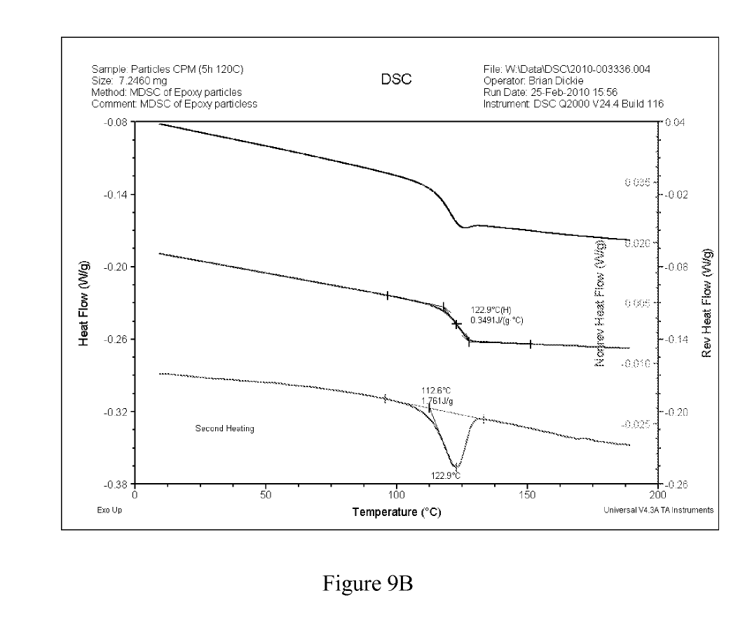

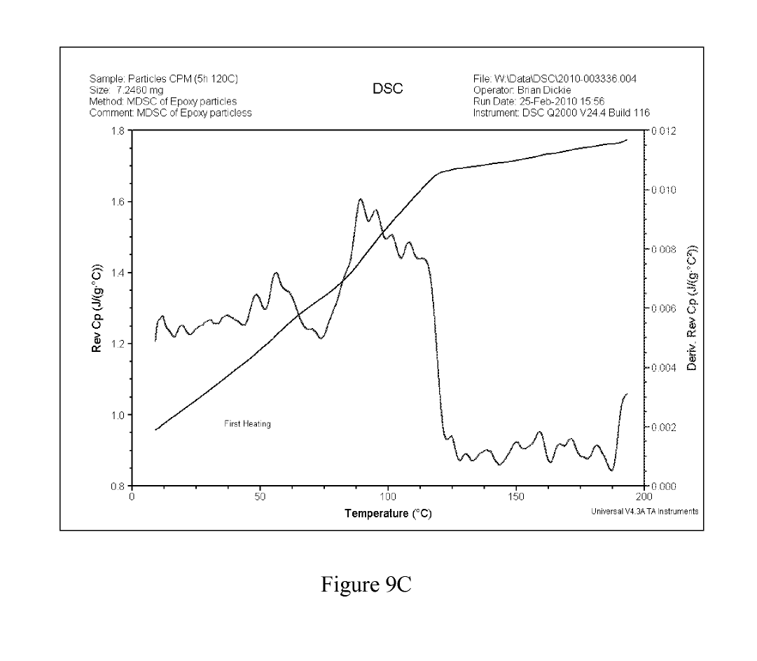

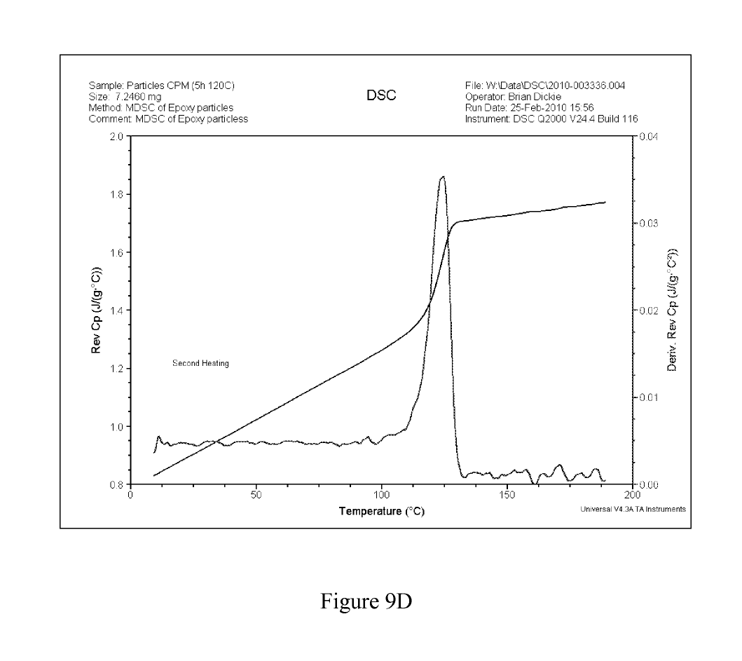

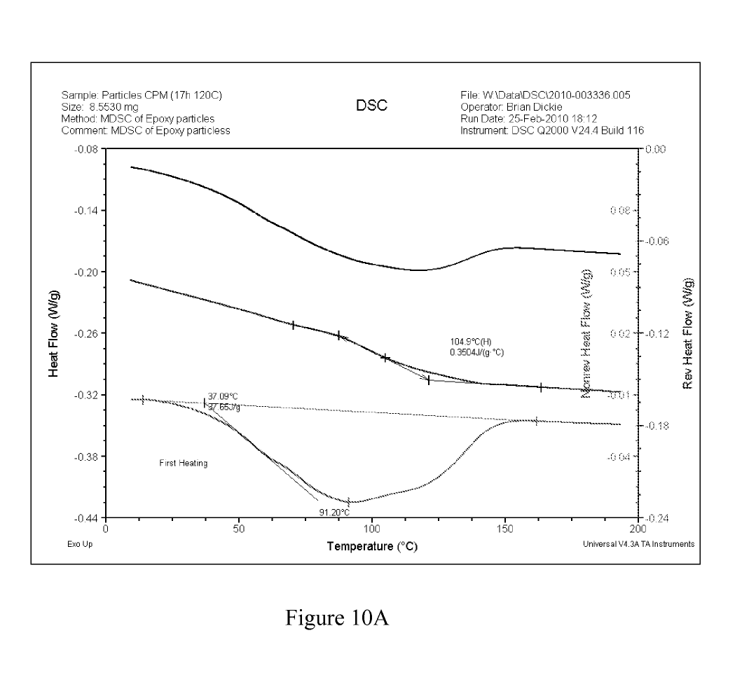

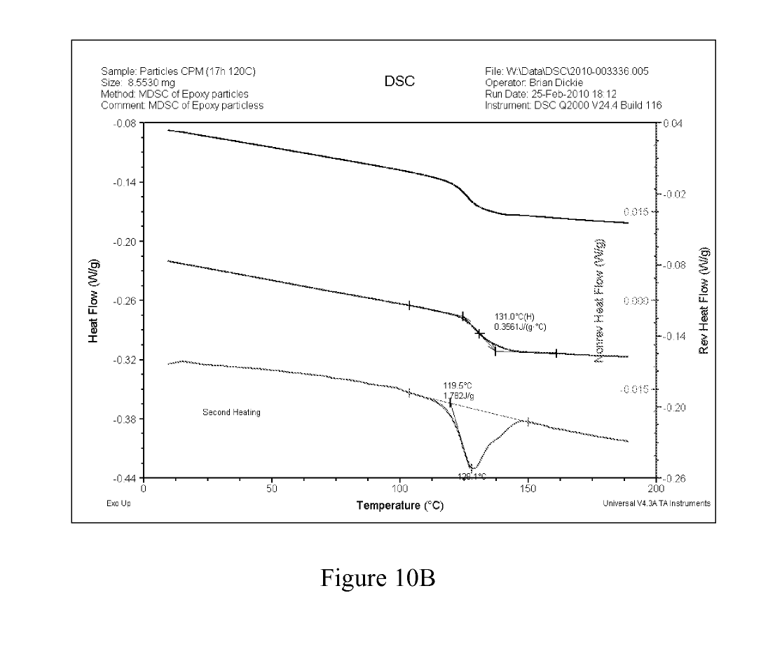

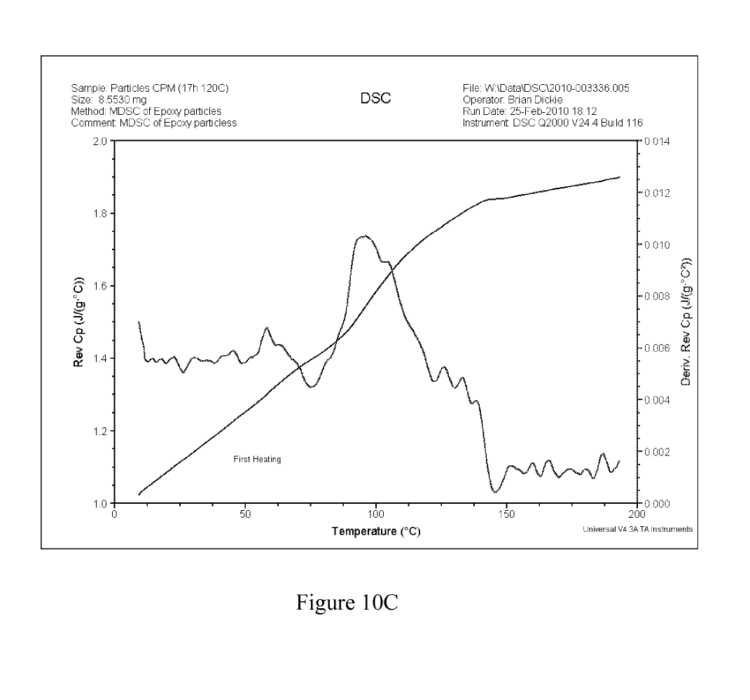

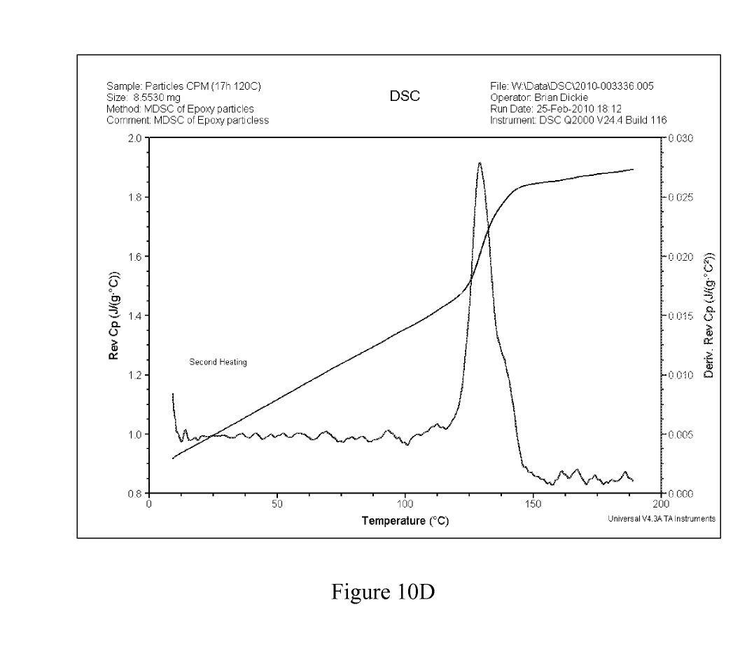

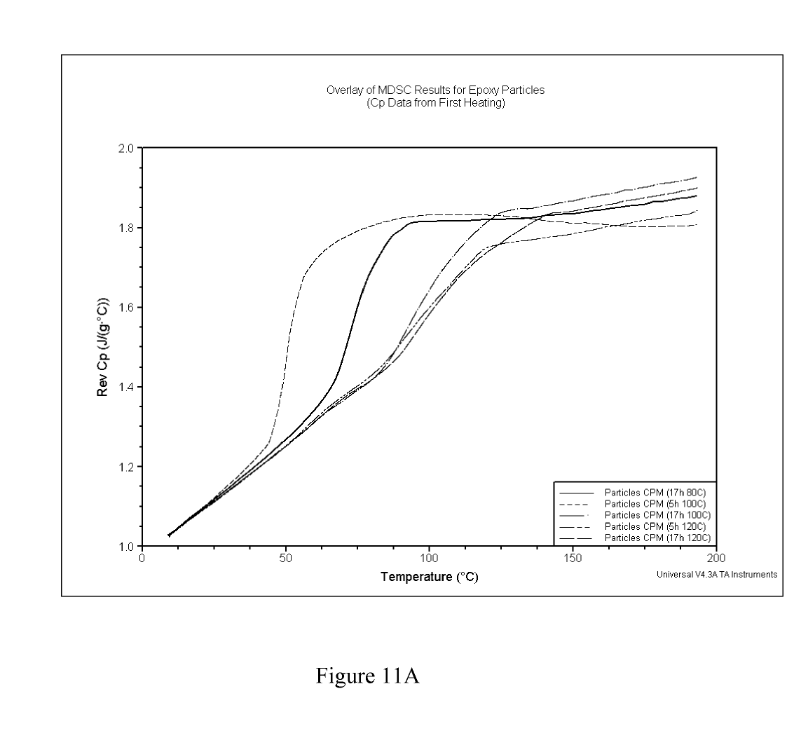

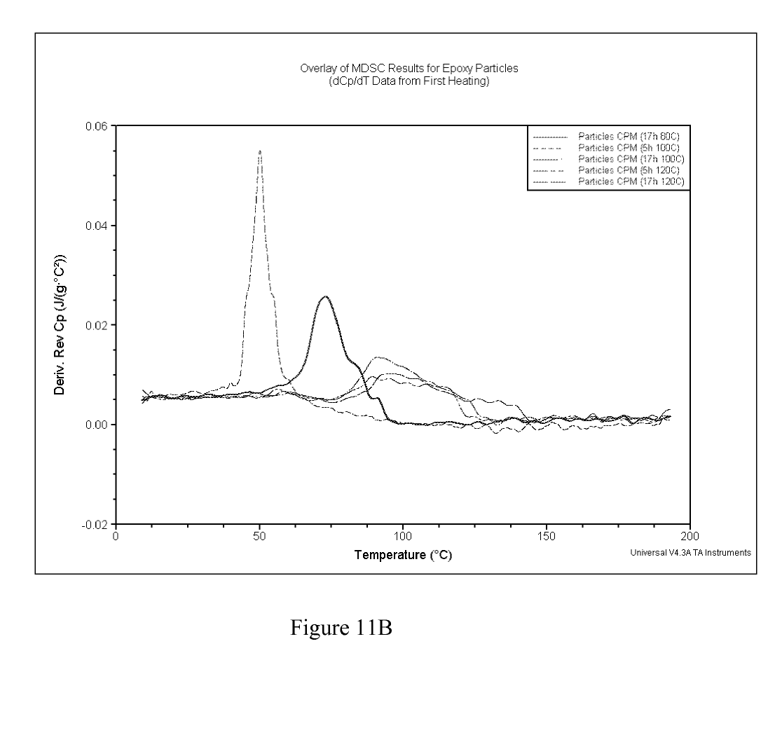

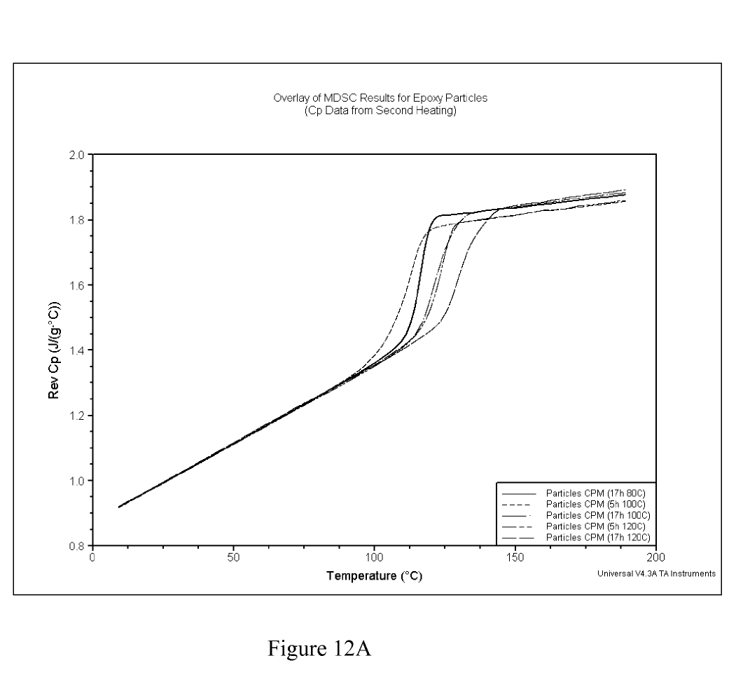

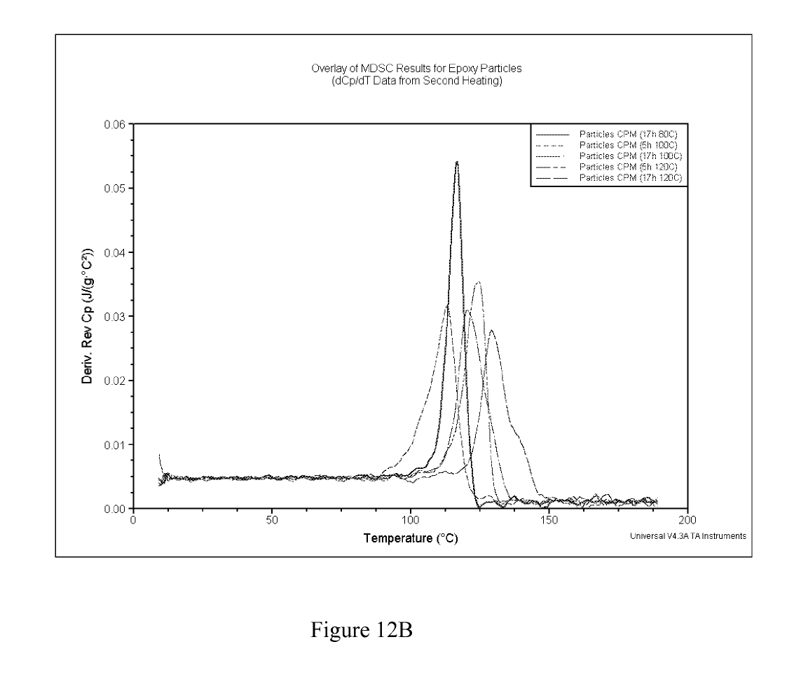

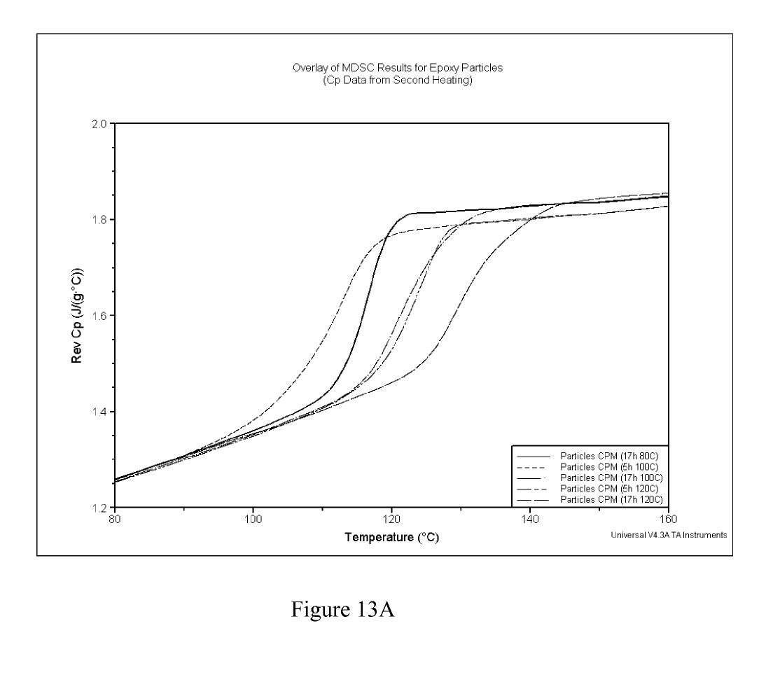

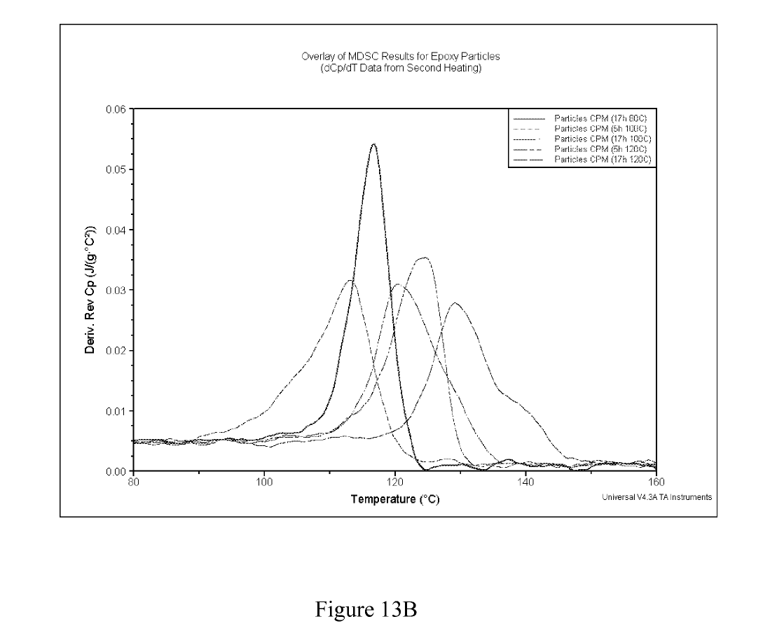

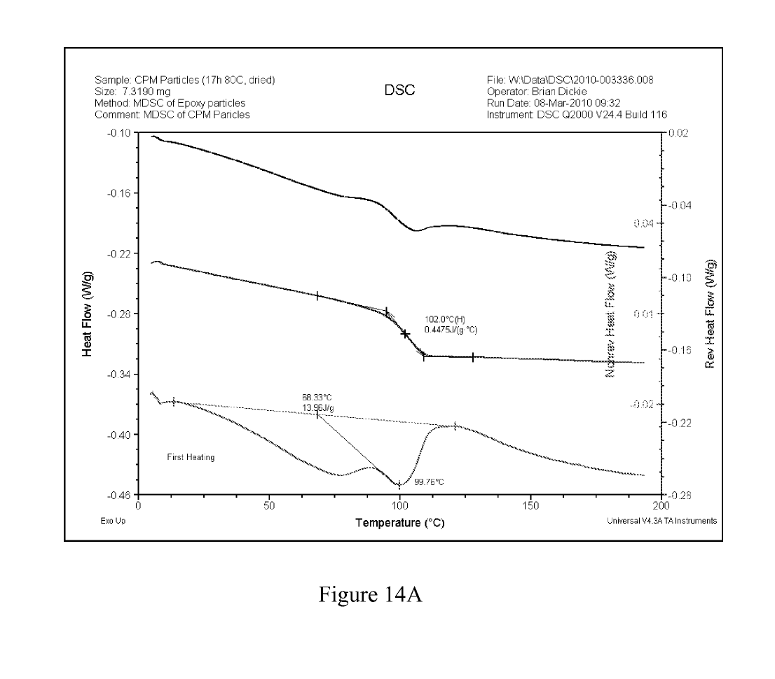

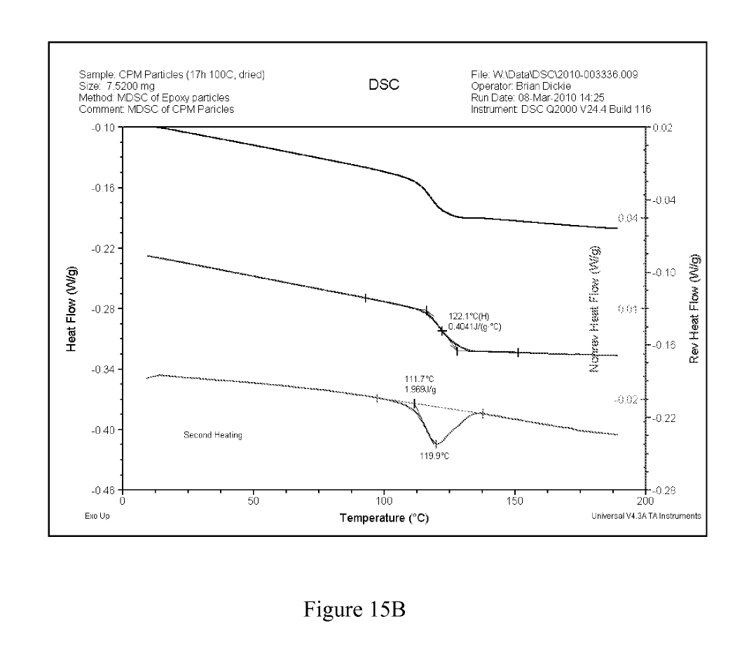

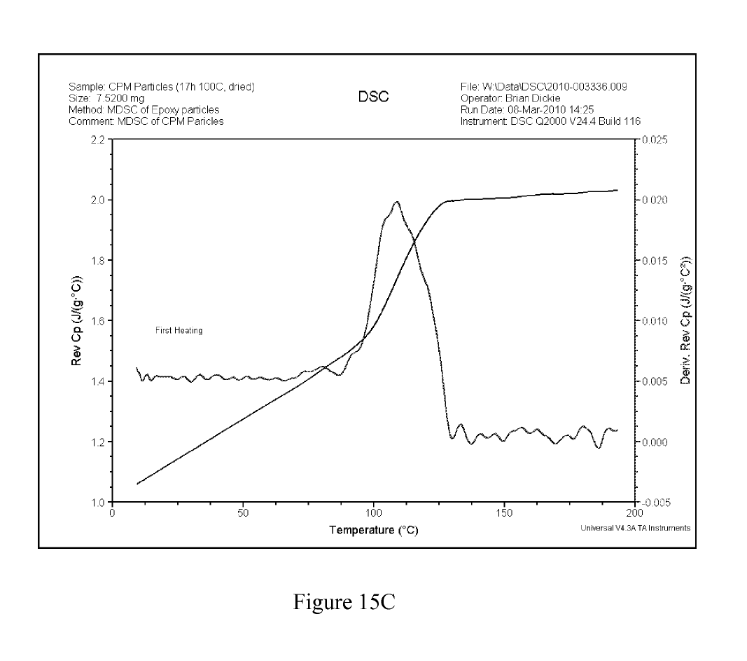

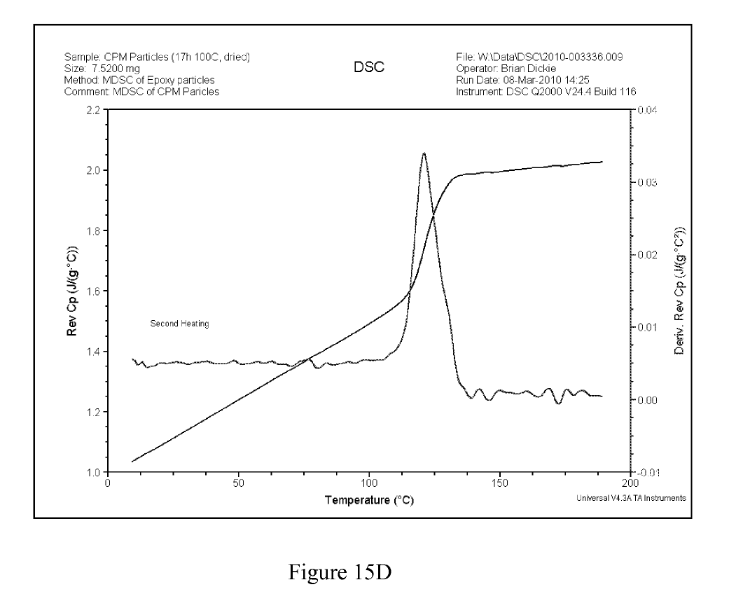

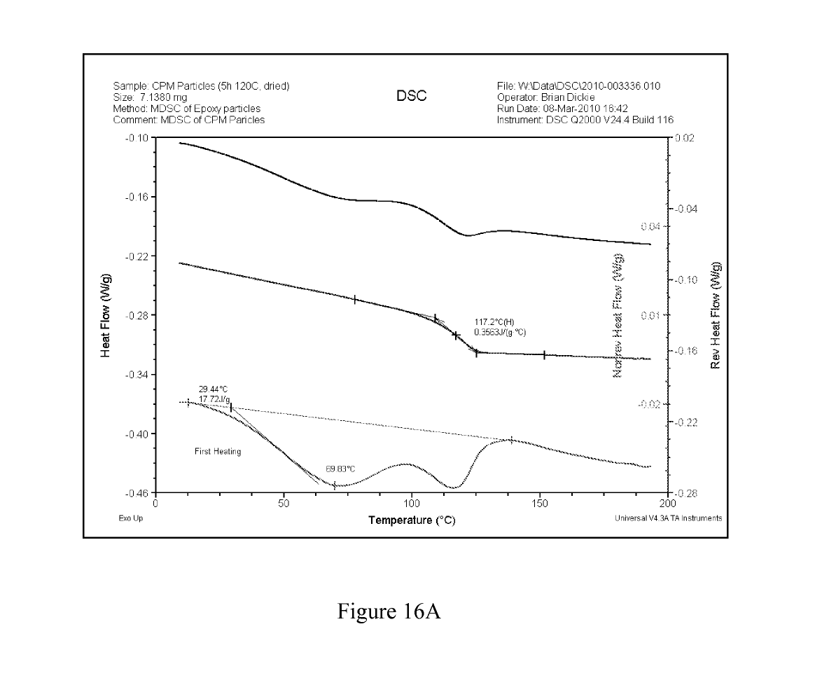

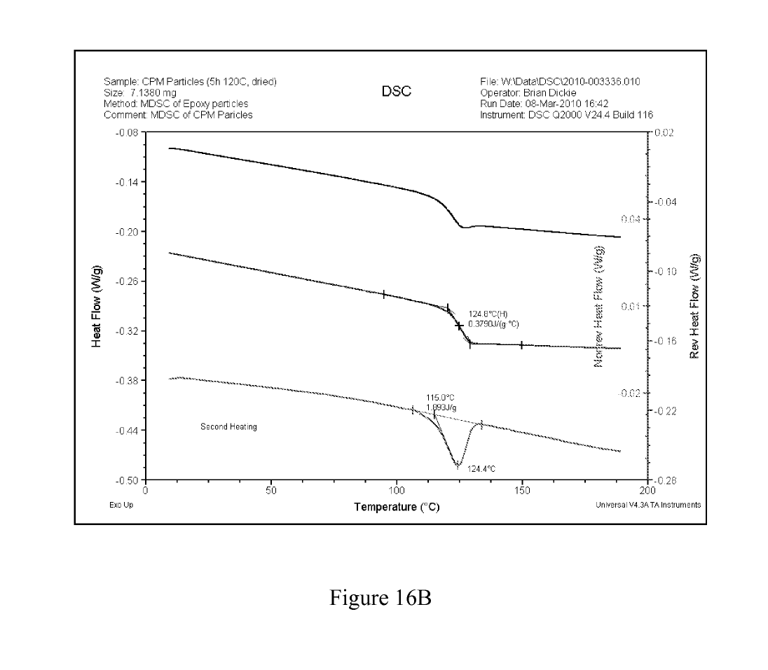

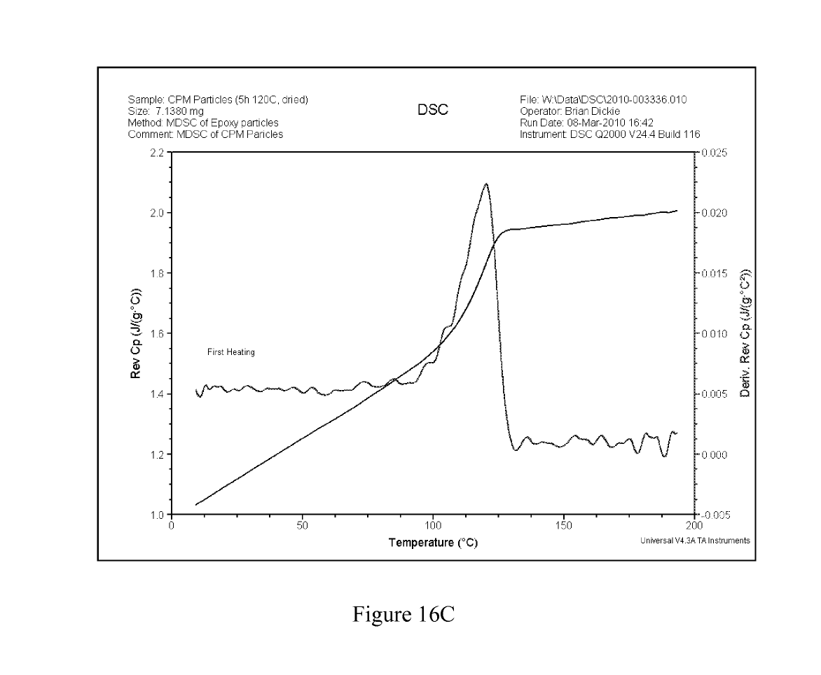

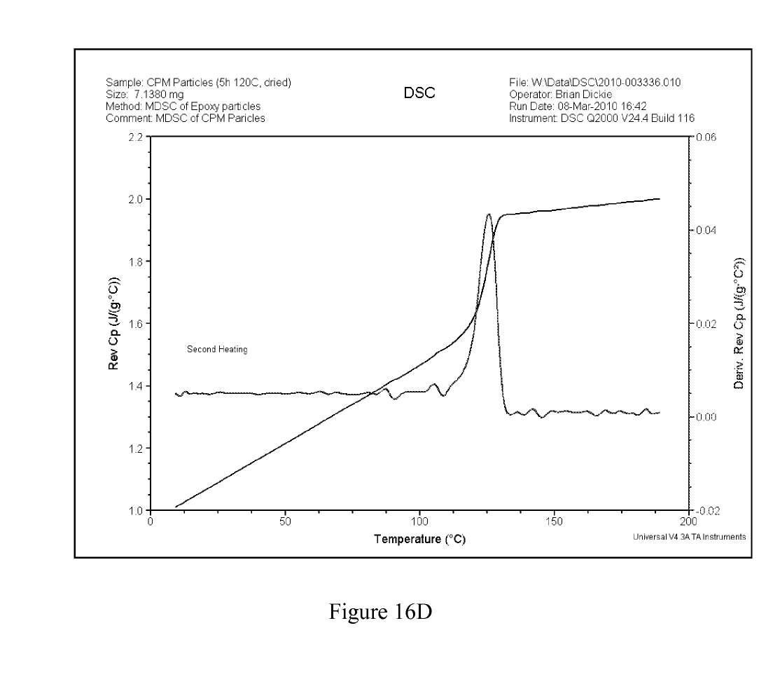

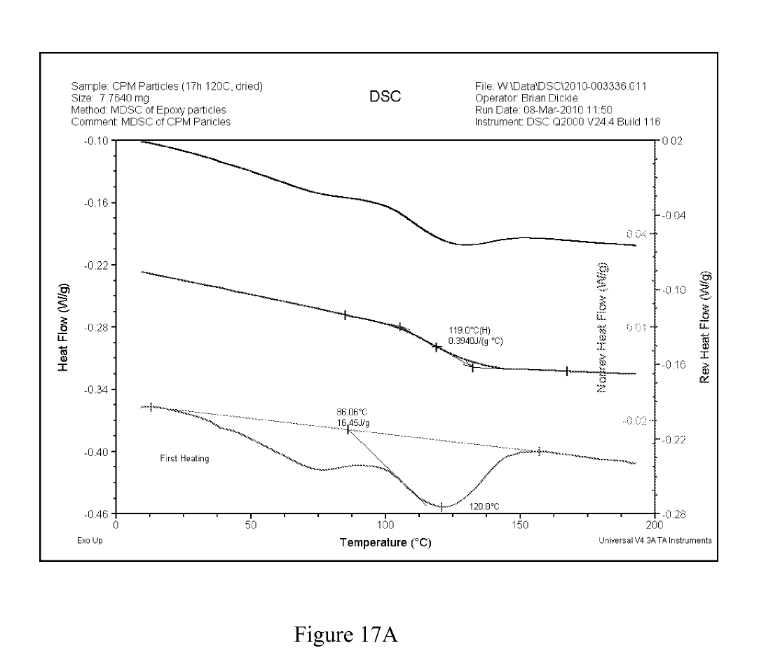

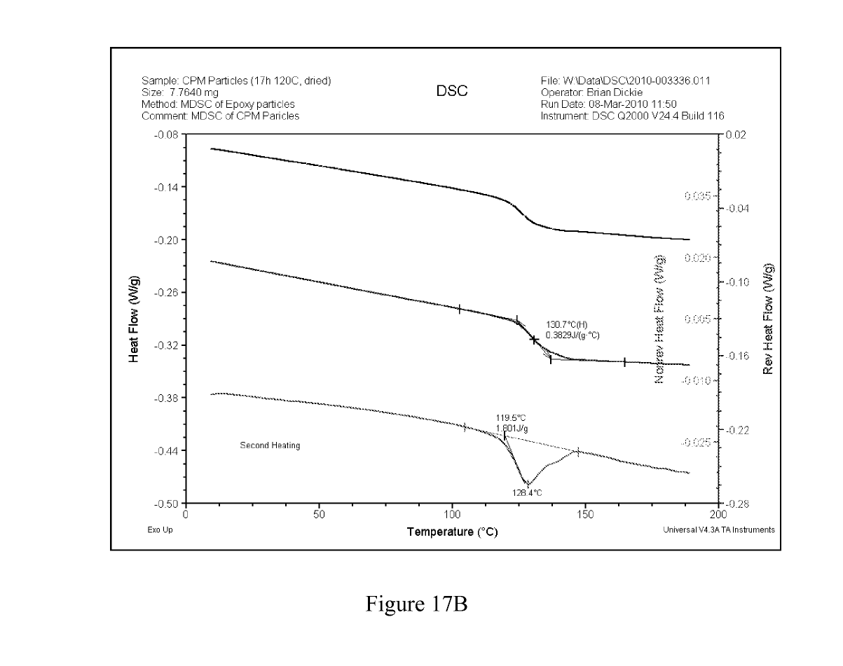

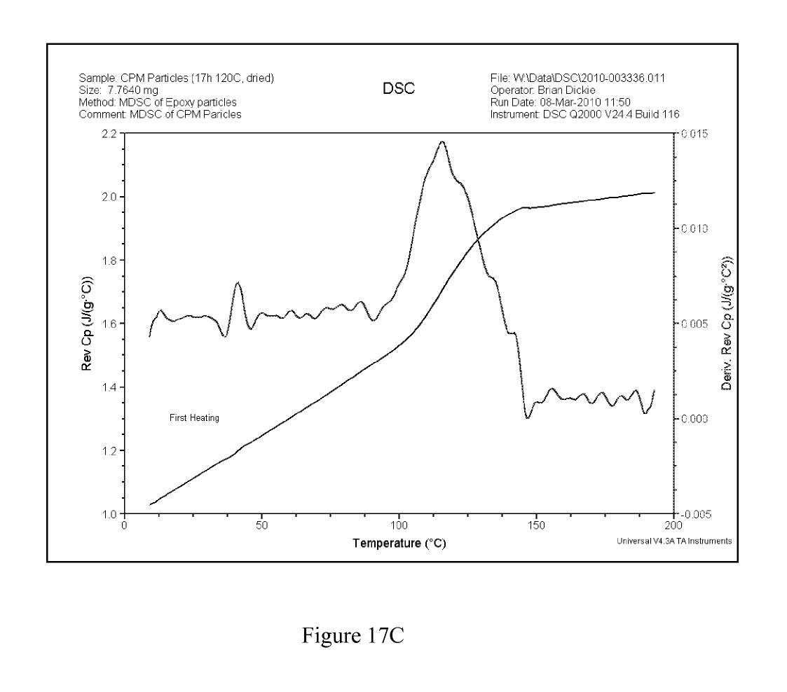

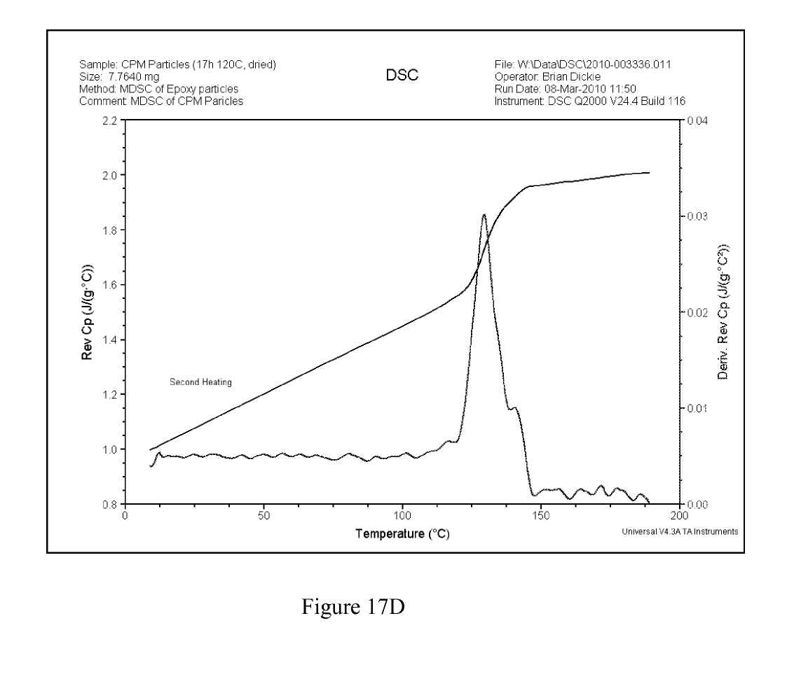

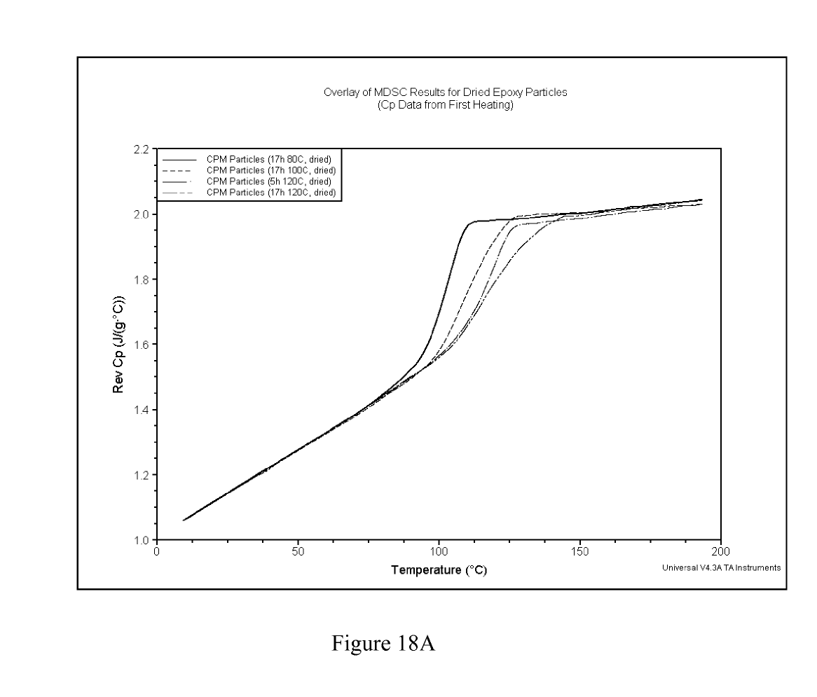

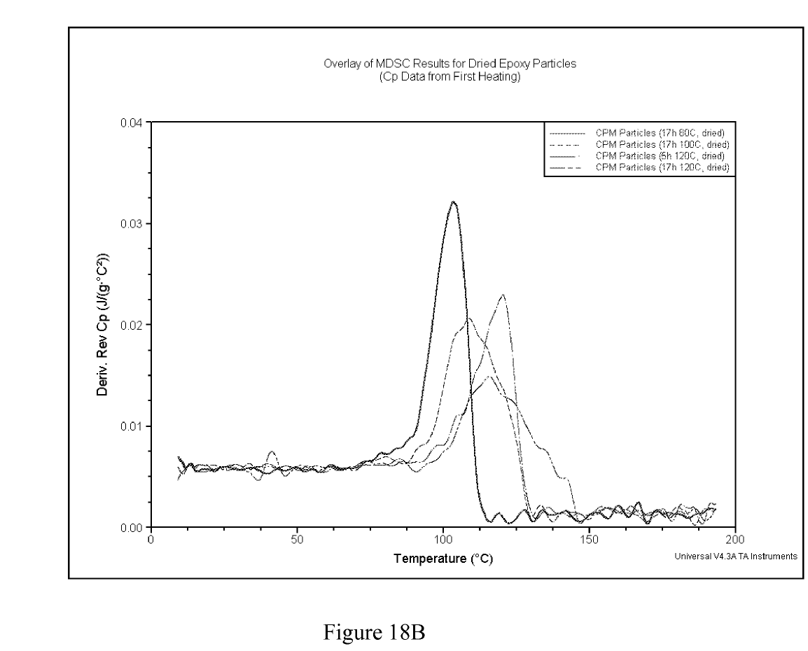

The behavior of Examples 13-18 of the cross-linked reactive polymer microparticles is shown in FIGS. 6-18. Each of the Examples 13-18 on the first heating had a large endothermic peak that is non-reversing in nature (i.e. it goes into kinetic signal of MDSC). The magnitude and width of this peak is indicative of an evaporation process. Table 6 below lists the weight loss by Examples 13-18 during the DSC experiment. Weight loss ranges from about 5.5 wt % up to a maximum of 9 wt %. It appears that a significant amount of solvent (acetone and THF from washing) is still present in the cross-linked reactive polymer microparticles. Drying via a vacuum oven was then performed. These levels of weight loss were confirmed by the TGA-MS analyzes done on the same samples.

The Tg in the first heating ranges from about 50° C. for the cross-linked reactive polymer microparticles produced at 100° C. for 5 hours (Example 15), to about 75° C. for the cross-linked reactive polymer microparticles produced at 80° C. for 17 hours (Example 14) and finally to about 100 to 105° C. for the remainder of the cross-linked reactive polymer microparticles (Examples 13 and 16-18). The shape of the Tg transitions are of interest, particularly on the high temperature side of the transition. This may be indicative of further reaction of the material or it could be coming from the simultaneous loss of solvent. No residual exothermic curing process is observed owing to the large solvent evaporation peak. In addition, if the residual exothermic process is weak and spread over a broad temperature range then it may not be visible even if there is no interference from the solvent evaporation.

In the second heating the Tg transition appears more “normal” in comparison to the first heating results (see FIGS. 6 to 18). The large endothermic peak is absent with just the usual enthalpy relation peak (about 2 J/g) being present. The transition has shifted to much higher temperatures and in most cases has become significantly sharper (i.e. narrower temperature range for transition). Now the Tg ranges from about 110° C. for the cross-linked reactive polymer microparticles produced at 100° C. for 5 hours (Example 15), to about 115° C. for the cross-linked reactive polymer microparticles produced at 80° C. for 17 hours (Example 14), to about 120° C. for the cross-linked reactive polymer microparticles produced at 100 and 120° C. at 17 and 5 hours respectively (Examples 16 and 17) to finally about 130° C. for the cross-linked reactive polymer microparticles produced at 120° C. for 17 hours (Example 18).

The width of the Tg transition is narrowest for the cross-linked reactive polymer microparticles produced at 80° C. (Examples 13 and 14). These Examples have a Tg that is more like a standard thermoplastic material instead of a crosslinked system. In addition, the Tg transition for these Examples 13 and 14 was about as narrow as for the standard thermoplastic material. Although the crosslink density is lower than the material produced at higher temperature (except for 5 hours at 100° C.) it appears that the homogeneity of the network is better (implied from width of Tg transition). As the reaction temperature and time increase the width of the Tg transition increases. This is consistent with a more heterogeneous polymer network.

TABLE 6
Summary of Weight Loss after DSC Analyses of as received cross-linked
reactive polymer microparticles

| Cross-Linked Reactive | Sample Weight | Weight Loss | |
|---|---|---|---|
| Polymer Microparticles | (mg) | (mg) | % Wgt Loss |
| Example 14 | 7.321 | 0.455 | 6.2 |
| Example 15 | 9.222 | 0.839 | 9.1 |
| Example 16 | 7.912 | 0.425 | 5.4 |
| Example 17 | 7.246 | 0.508 | 7.0 |
| Example 18 | 8.553 | 0.455 | 5.3 |

TABLE 7
Summary of Measured Tg Values of as received Cross-Linked
Reactive Polymer Microparticles

| Cross-Linked Reactive | Tg (° C.) from | Tg (° C.) from Second |
|---|---|---|
| Polymer Microparticles | First Heating | Heating |
| Example 14 | 74.4 | 116.2 |
| Example 15 | 51.0 | 111.2 |
| Example 16 | 98.7 | 122.0 |
| Example 17 | 100.0 | 122.9 |
| Example 18 | 104.9 | 131.0 |

The cross-linked reactive polymer microparticles of Examples 14-18 contain significant (5 to 9 wt %) levels of volatile materials as confirmed by both TGA and MDSC. The same level was measured by TGA and weight loss after the MDSC experiments. This weight loss comes from the evolution of residual solvent (THF and acetone) used to wash the residual polypropylene glycol (PPG). There was no clear evidence for the presence of residual PPG in any of the cross-linked reactive polymer microparticles. It is estimated that the level is less than about 0.1 weight percent (wt. %) or 1000 ppm.

The residual solvent acts as a plasticizer for the cross-linked reactive polymer microparticles. The Tg measured during the first heating is much lower and broader than that measured in the second heating. The initial Tg of the partially dried cross-linked reactive polymer microparticles is higher than the as received cross-linked reactive polymer microparticles, but still considerably lower than that measured after complete removal of the solvents. The final Tg is a function of reaction temperature and time. At a reaction temperature of 80° C. the final Tg of the cross-linked reactive polymer microparticles is about 115° C. and this shifts to about 122° C. for reaction at 100° C. and then finally to about 130° C. for reaction at about 120° C. A longer reaction time at a given temperature gives a small increase in Tg and a broader transition. At the highest temperature and longest reaction time the Tg of the cross-linked reactive polymer microparticles is slightly higher than the Comparative Epoxy Example. The cross-linked reactive polymer microparticles and the Comparative Epoxy Example have very similar thermal degradation behavior. The evolved species are essentially the same indicating that the chemical composition of the cross-linked reactive polymer microparticles and the Comparative Epoxy Example are the same. FIGS. 6A to 13b provide the MDSC and TGA-MS measurements on cross-linked reactive polymer microparticles of Examples 14-18.

Analysis of the Cross-Linked Reactive Polymer Microparticles after Drying

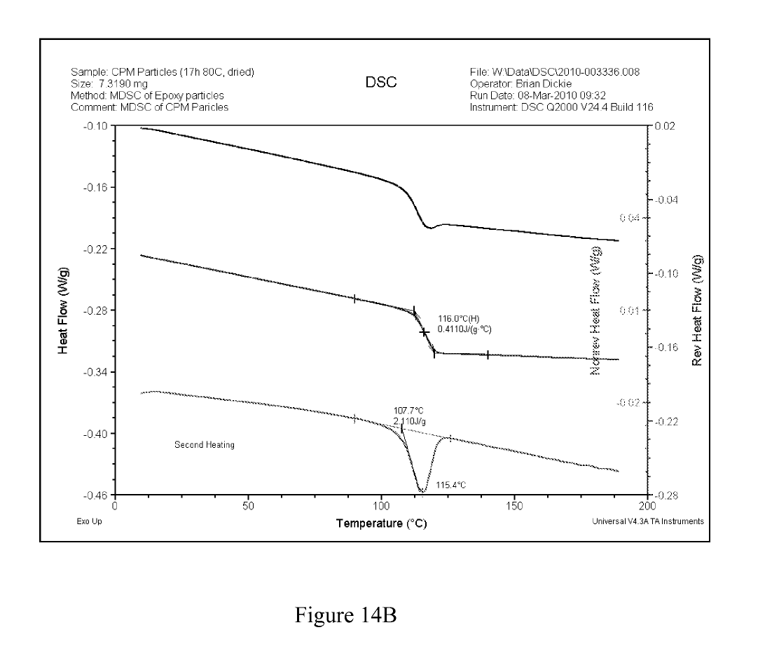

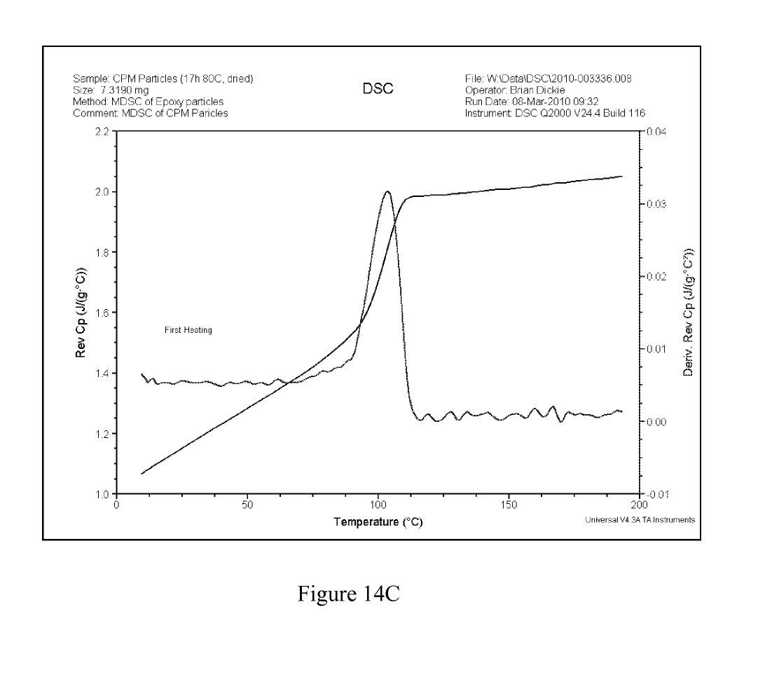

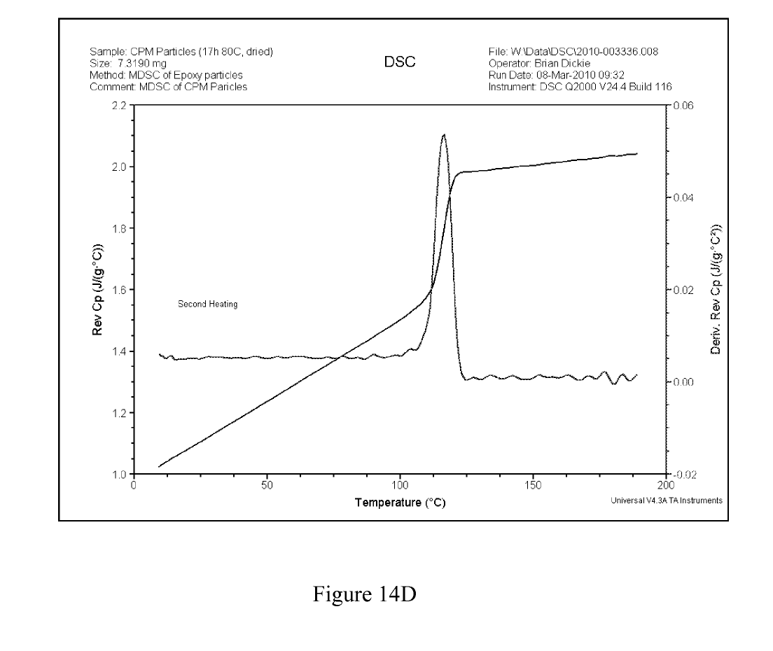

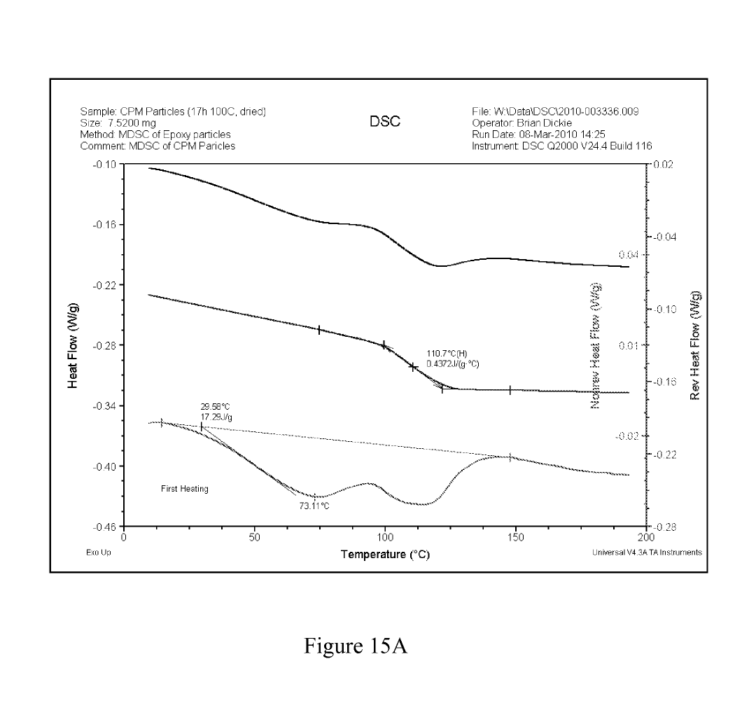

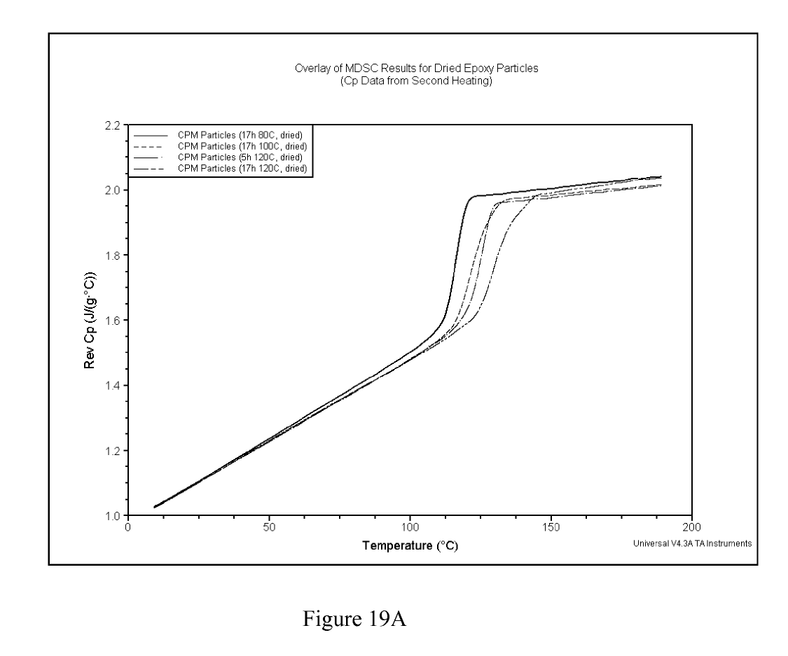

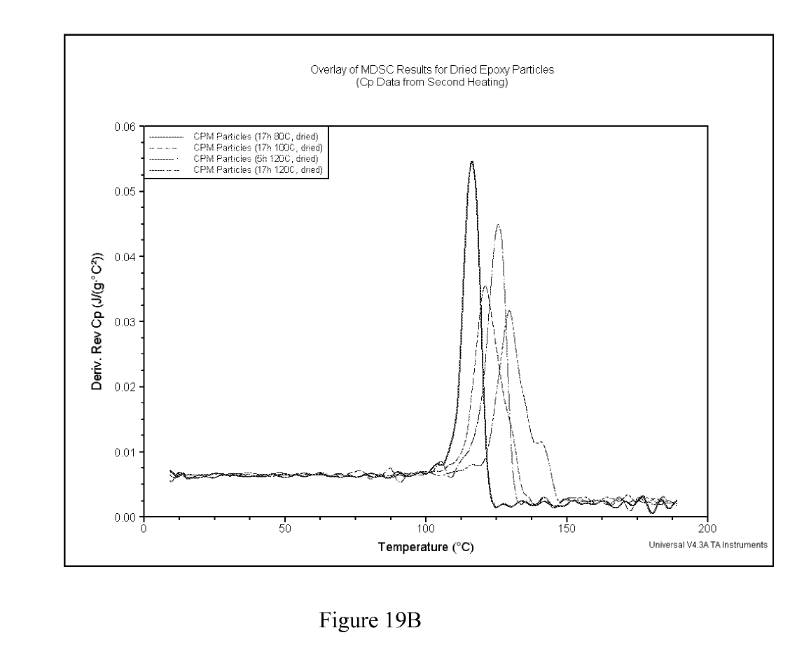

The MDSC results of the four dried cross-linked reactive polymer microparticles (Examples 14-18) are illustrated in FIGS. 14A to 19b and summarized in Tables 8 and 9. It is still clear from the results of the first heating that the Examples 14-18 still contain volatile material. That is, not all of the solvent has been removed by the vacuum drying step at 40° C. for about 64 hours. From the measured weight of the Examples 14-18 before and after analysis (see Table 8) it was observed that all of the Examples 14-18 still lose about 2 wt %. This low temperature weight loss is shifted to higher temperatures in comparison to the as received cross-linked reactive polymer microparticles and as a consequence the measured Tg is shifted to higher temperature and the transition occurs over a narrower temperature range. However, the final Tg measured in the second heating is more or less the same as measured previously.

As the reaction temperature increases the final Tg of the cross-linked reactive polymer microparticles increases. A longer reaction time at a given temperature also appears to increase the final Tg as well as broaden the Tg transition.

TABLE 8
Summary of Weight Loss after DSC Analyses of Cross-Linked Reactive
Polymer Microparticles of Examples 14 and 16-18

| | Sample Weight | Weight Loss | |
|---|---|---|---|
| Material | (mg) | (mg) | % Wt Loss |
| Example 14 | 7.319 | 0.085 | 1.2 |
| Example 16 | 7.520 | 0.167 | 2.2 |
| Example 17 | 7.138 | 0.146 | 2.0 |
| Example 18 | 7.764 | 0.169 | 2.2 |

TABLE 9
Summary of Measured Tg Values of Dried Samples of Cross-Linked
Reactive Polymer Microparticles of Examples 14 and 16-18

| | | Tg (° C.) from Second |
|---|---|---|
| Material | Tg (° C.) from First Heating | Heating |
| Example 14 | 102.0 | 116.0 |
| Example 16 | 110.7 | 122.1 |
| Example 17 | 117.2 | 124.8 |
| Example 18 | 119.0 | 130.7 |

### TGA-MS of Cross-Linked Reactive Polymer Microparticles

The main reason for performing the TGA-MS experiments was to determine if any PPG was still present in the cross-linked reactive polymer microparticles. PPG had been employed as solvent during the polymerization to form the cross-linked reactive polymer microparticles and although the final product was washed several times with THF and acetone some PPG may still be present. In order to check for the presence of PPG the different cross-linked reactive polymer microparticles were analyzed along with the pure PPG and the self-cured epoxy resin. These latter two materials were analyzed to provide reference data.

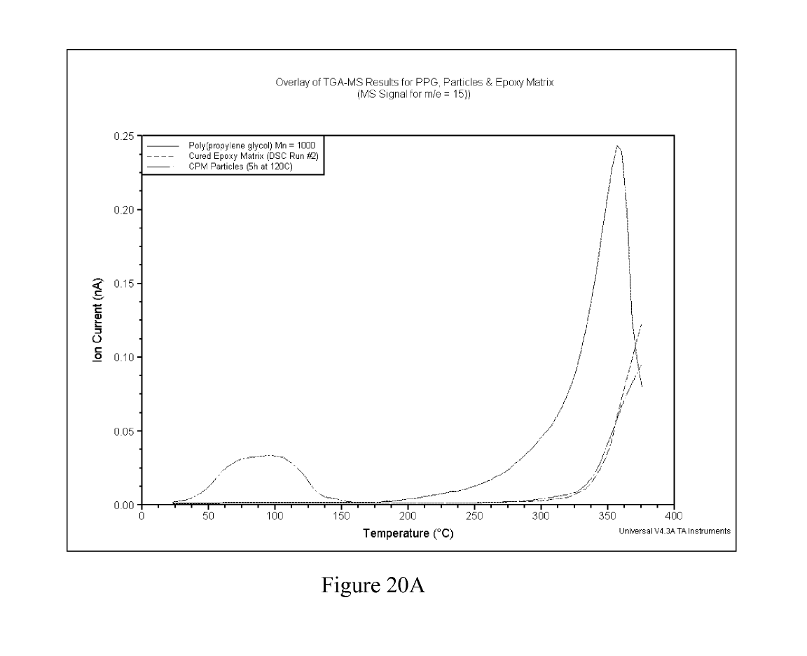

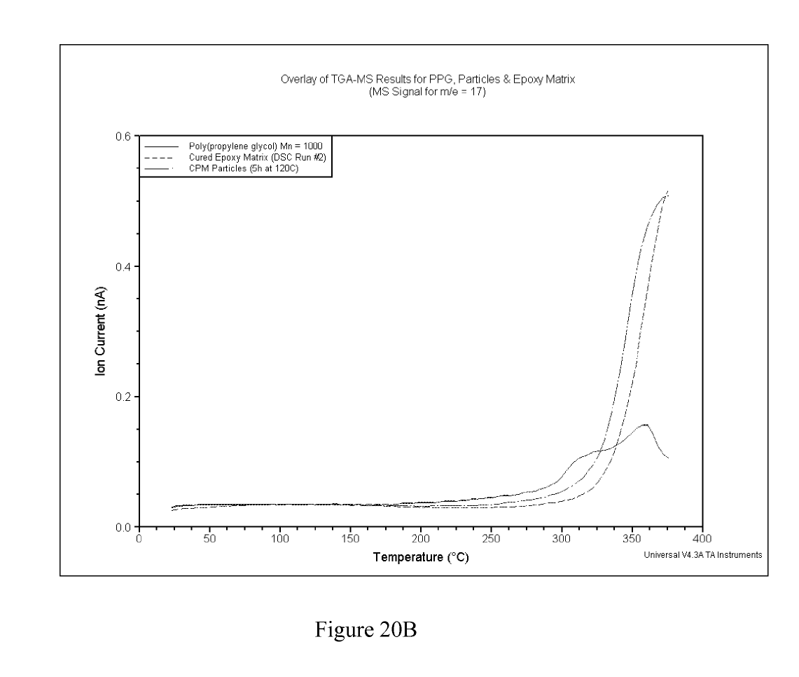

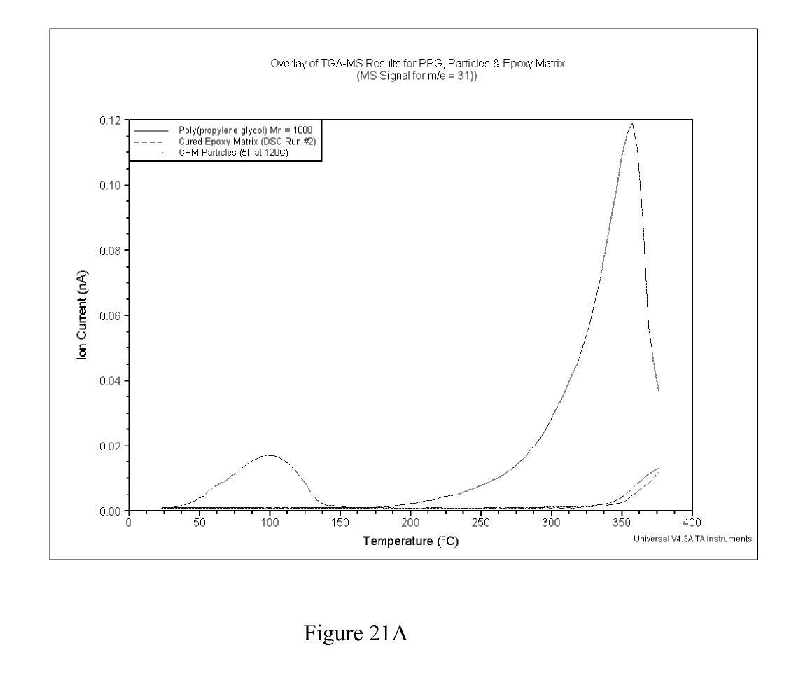

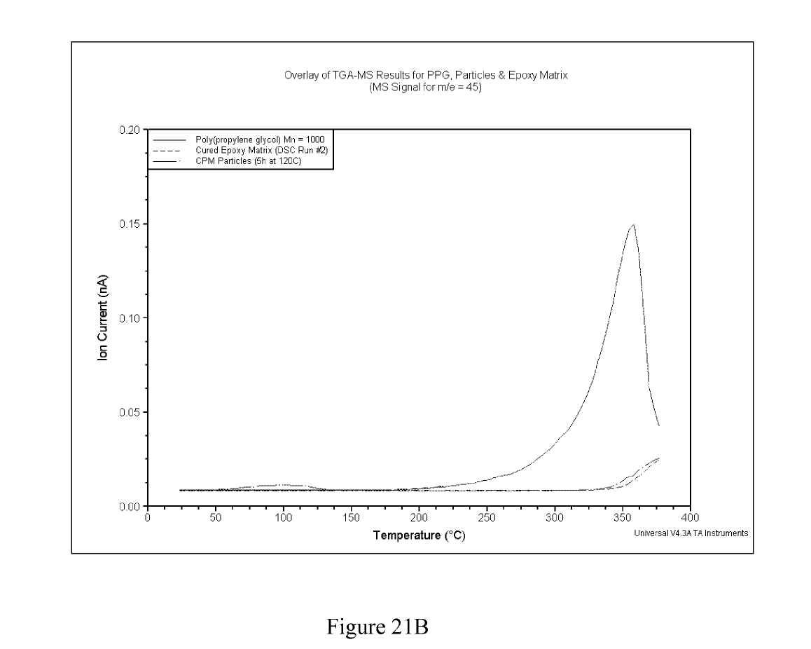

Some overlay plots of MS signals for PPG, Epoxy matrix and Example 17 of the cross-linked reactive polymer microparticles are illustrated in. FIGS. 20A-20B and 21A-21b. All of the samples being compared had a similar starting weight (about 5.5 mg) so that the MS signals can be compared quantitatively without any modification. The choice of MS signals was made on the basis of the strength and/or shape of these signals for the pure PPG material.

In FIGS. 20A and 2013 the MS signals for m/e=15 and 17 are compared for PPG, Epoxy matrix and Example 17 of the cross-linked reactive polymer microparticles. The m/e=15 signal is quite strong for all materials. The cross-linked reactive polymer microparticles give a peak at low temperatures that is coming from the loss of residual solvent (THF and acetone) whereas the other two materials do not give any significant signal for this m/e value until 200 to 250° C. It is clear that the strength and shape of the signal for the cross-linked reactive polymer microparticles is very similar to that of the epoxy matrix. The strength of this signal is the same or weaker for the cross-linked reactive polymer microparticles in comparison with the epoxy matrix. If any significant amount of PPG was still present in the cross-linked reactive polymer microparticles the strength if this signal should be stronger for the cross-linked reactive polymer microparticles. The MS signal for m/e=17 (water) has a characteristic shape for the PPG signal and this is not observed for the epoxy matrix and the cross-linked reactive polymer microparticles. Again there is no evidence for the presence of any significant amount of PPG left in the cross-linked reactive polymer microparticles.

In FIGS. 21A and 21b the MS signals for m/e=31 and 45 are compared for the three materials. These signals are particularly strong for the PPG material and relatively weak for the epoxy matrix and cross-linked reactive polymer microparticles. In both cases the signal for the cross-linked reactive polymer microparticles is slightly stronger than for the epoxy matrix. This could imply that low levels of PPG are still present in the cross-linked reactive polymer microparticles. If this slightly stronger signal for the cross-linked reactive polymer microparticles does indeed mean that some PPG is still associated with the particles it is estimated that the amount is no more than about 0.1 wt % (i.e. 1000 ppm).

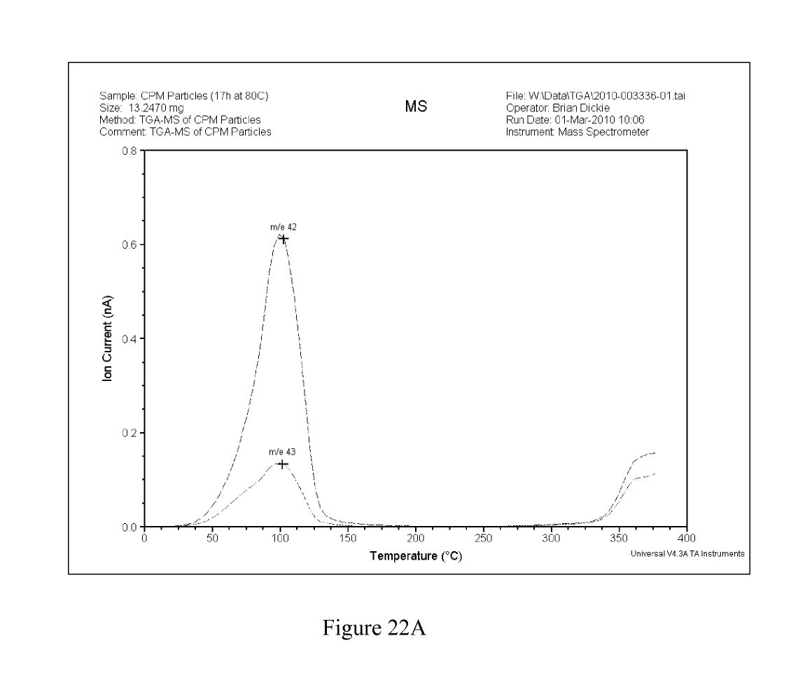

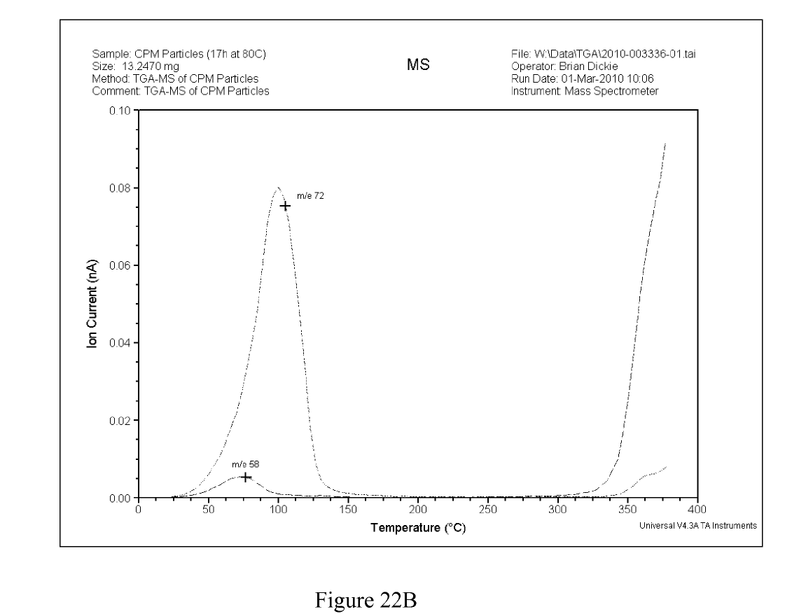

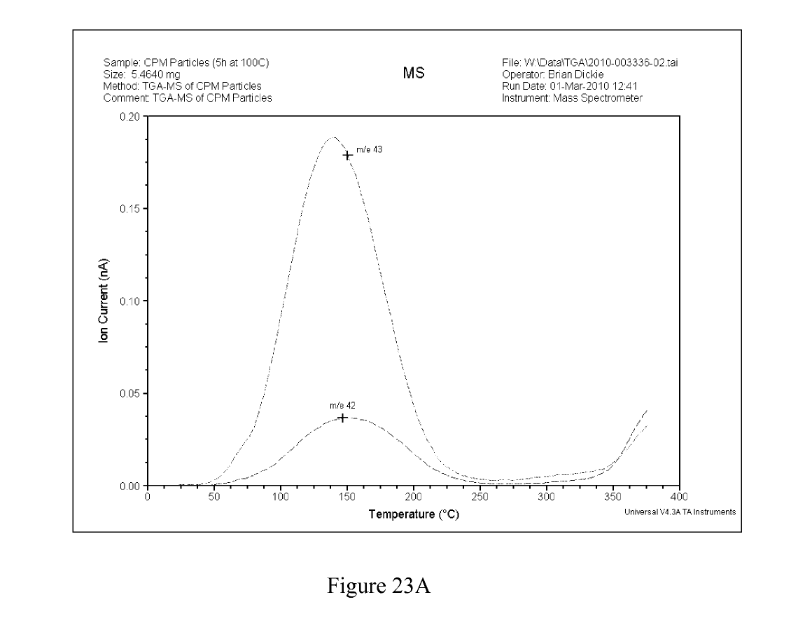

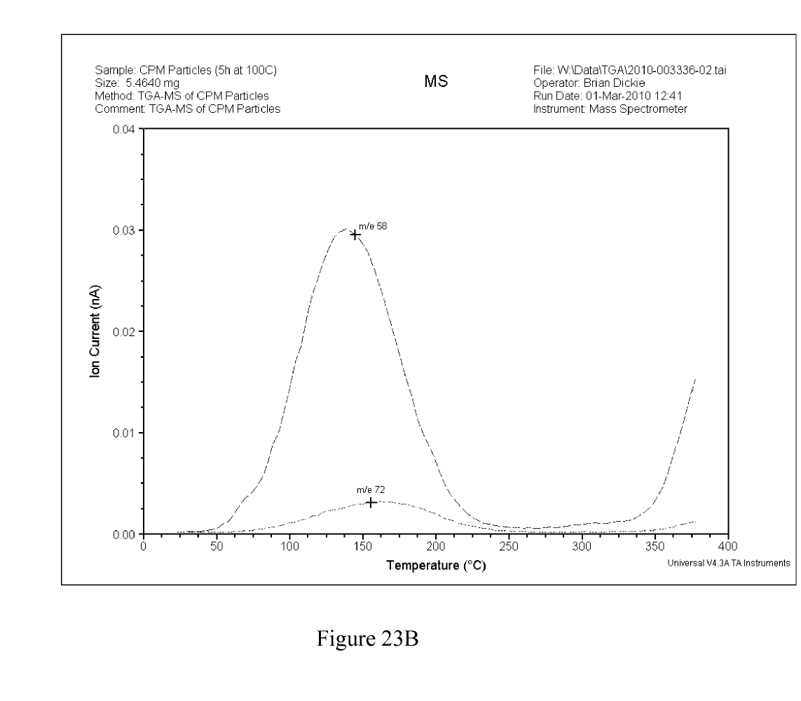

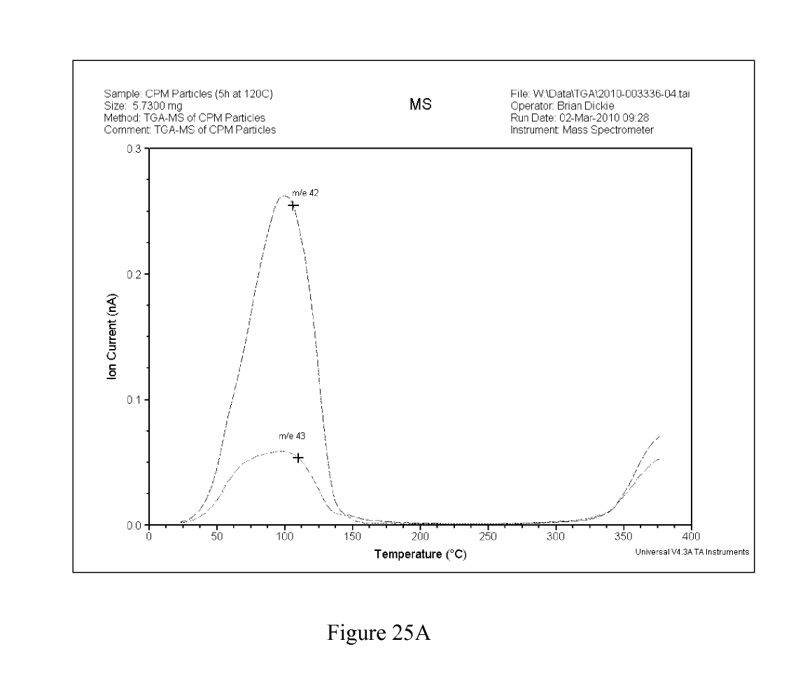

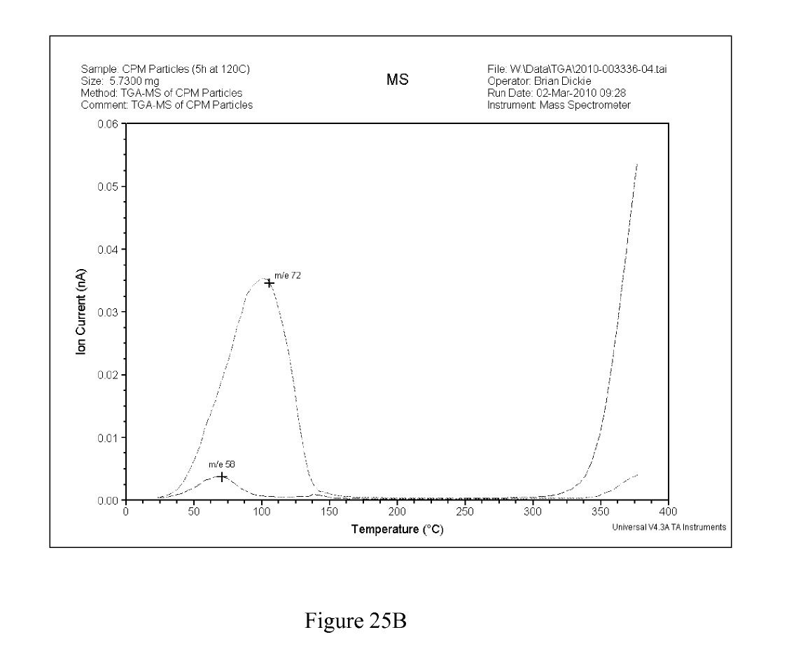

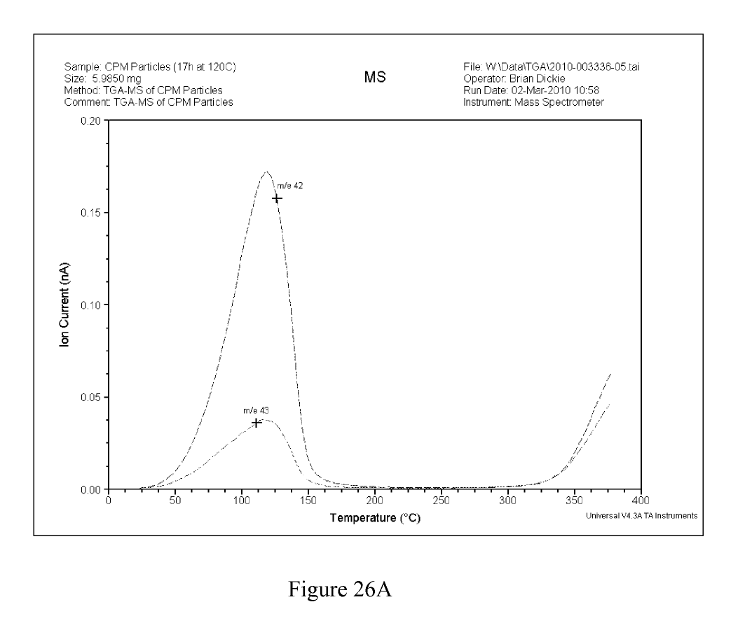

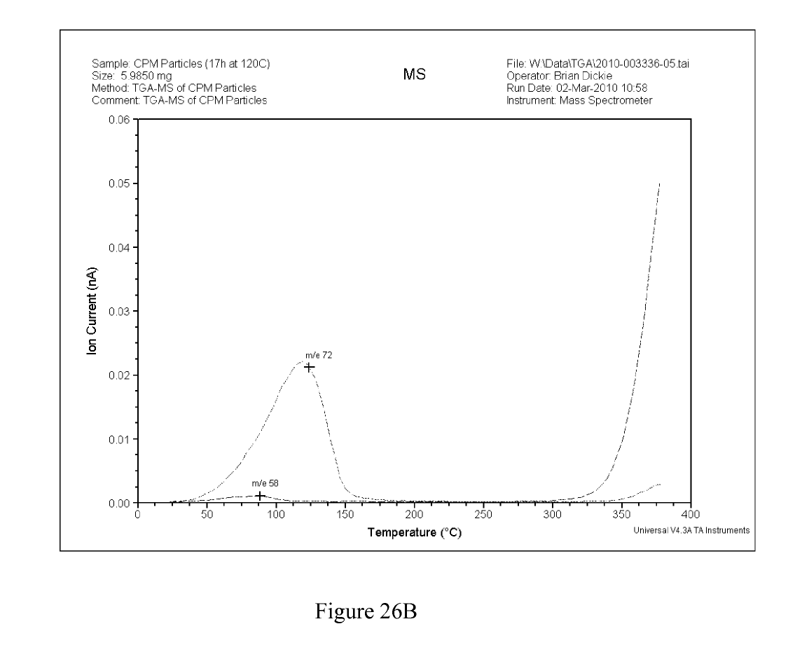

Examples 14-18 of the cross-linked reactive polymer microparticles lose a significant amount of weight (5-8 wt %) at temperatures below 150° C. These weight loss values are in good agreement with that found from the weight lost during the MDSC experiments. Since the samples had been washed with THF and acetone it is logical that one or both of these solvents is giving rise to this weight loss. The selected MS signals of m/e=42, 43, 59 and 72 for the cross-linked reactive polymer microparticles are illustrated in FIGS. 22A to 26B. Examination of MS reference spectra indicate that, at low temperatures, the MS signals for m/e=42 and 72 are mainly coming from THF and the MS signals for m/e=43 and 58 are mainly coming from acetone.

Particle Shape and Size Distribution of the Cross-Linked Reactive Polymer Microparticles

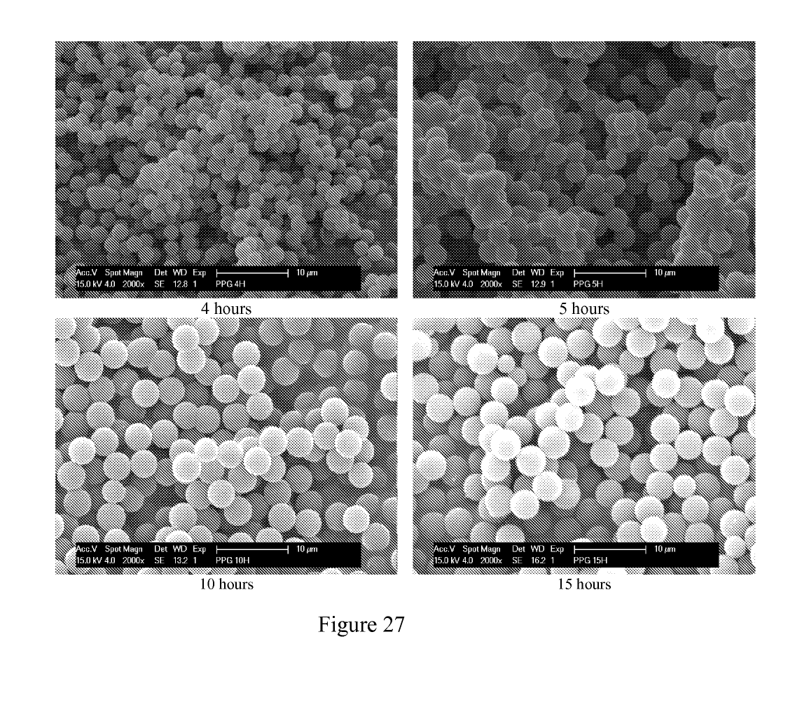

SEM micrographs of a powder of the cross-linked reactive polymer microparticle of Example 1-12 were acquired in order to assess the shape and the dimension of the cross-linked reactive polymer microparticles. FIG. 27 shows the images of cross-linked reactive polymer microparticles where the effect of the reaction time on their diameter is visible. All cross-linked reactive polymer microparticles have a spherical shape.

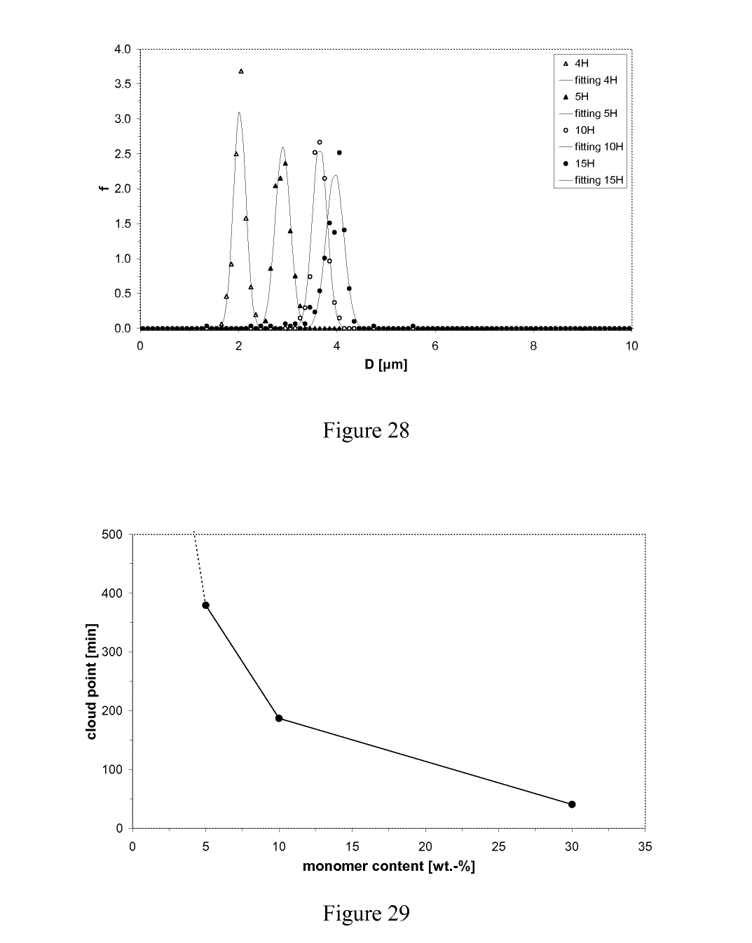

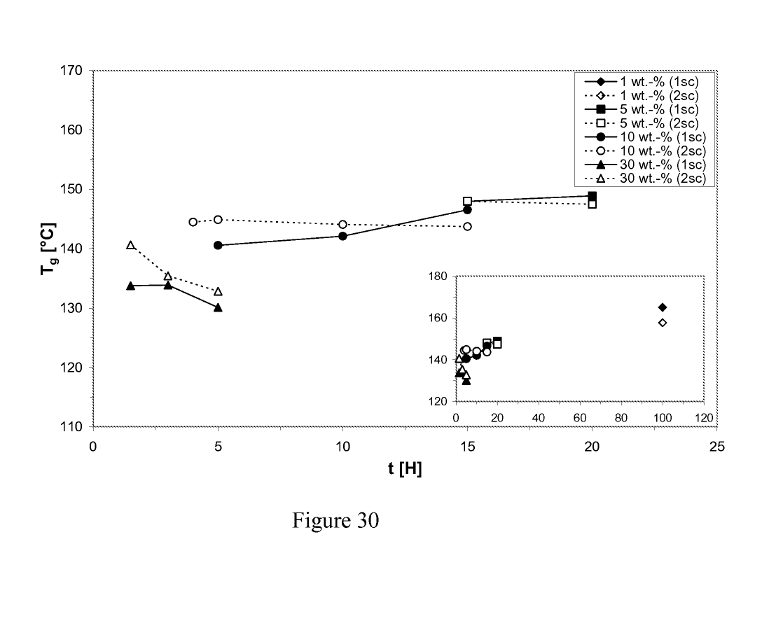

The SEM micrographs were used to determine the particle size distribution. FIG. 28 shows the particle sized distribution and FIG. 30 shows the average diameter of the cross-linked reactive polymer microparticles as a function of the reaction time. The cross-linked reactive polymer microparticle dimension follows a monomodal narrow Gaussian distribution. The average dimension of the cross-linked reactive polymer microparticle increases progressively from 2.02±0.13 μm after 4 hours to 3.9±0.3 μm after 15 hours of reaction time when a plateau value of the diameter is reached. The standard deviation, ranging from 0.13 to 0.3 μm, and the index of polydispersity, lower than 1.01, confirmed the very narrow distributions.

Effect of Monomer Concentration

The effect of the monomer concentration (DGEBA+DAT, a/e ratio=1.35) in the same solvent (PPG-1000) on the synthesis and characteristics of cross-linked reactive polymer microparticles of Examples 1-12 was investigated.

The cloud point shows a clear decrease as the monomer concentration is increased: from 380 minutes to 41 minutes as the concentration changes from 5 wt % to 30 wt %, as shown in FIG. 29. This expected effect was firstly because the epoxy/amine reaction proceeds faster as the concentration is increased and secondly because higher monomer concentration corresponds to a region of the phase diagram that induces phase separation at lower conversion.

Cross-Linked Reactive Polymer Microparticle Characterization

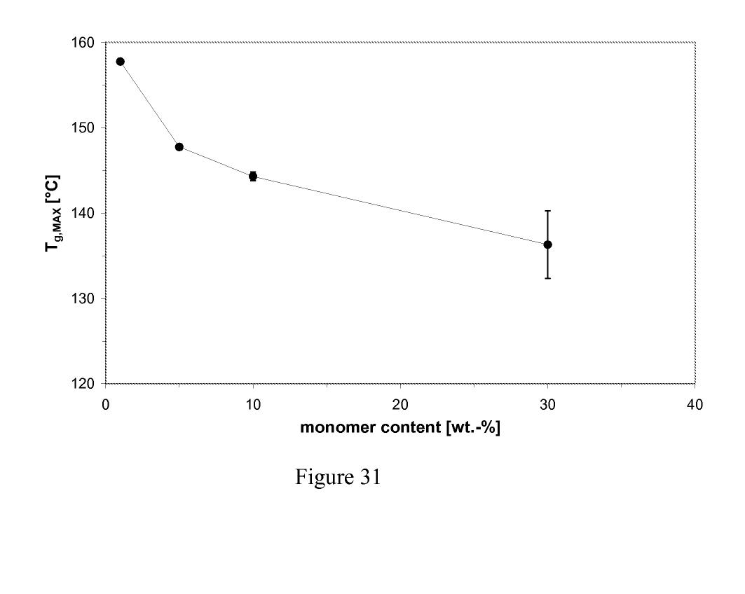

FIG. 31 demonstrates the strong influence of the monomer concentration on the Tg: it decreases as the monomer concentration is increased, from 158° C. at a monomer concentration of 1 wt % to 136° C. at a monomer concentration of 30 wt % (values obtained after the longest reaction time, and during the 2^{nd} DSC scan). This is a significant difference. The trend is the same for Tg measured during the first DSC scan (which is the value at the end of the synthesis) or the second scan (which represents the maximum value that the particles can reach after full cure). A higher Tg means higher crosslink density, so an effective stoichiometry of the cross-linked reactive polymer microparticles is close to 1. This high Tg excludes the presence of PPG as a miscible polymer in the particles, because PPG (if miscible) will have a plasticizing effect. A lower Tg means lower crosslink density, which can have several reasons: incomplete curing, stoichiometry far from 1, and/or plasticizing effect of PPG, among other reasons.

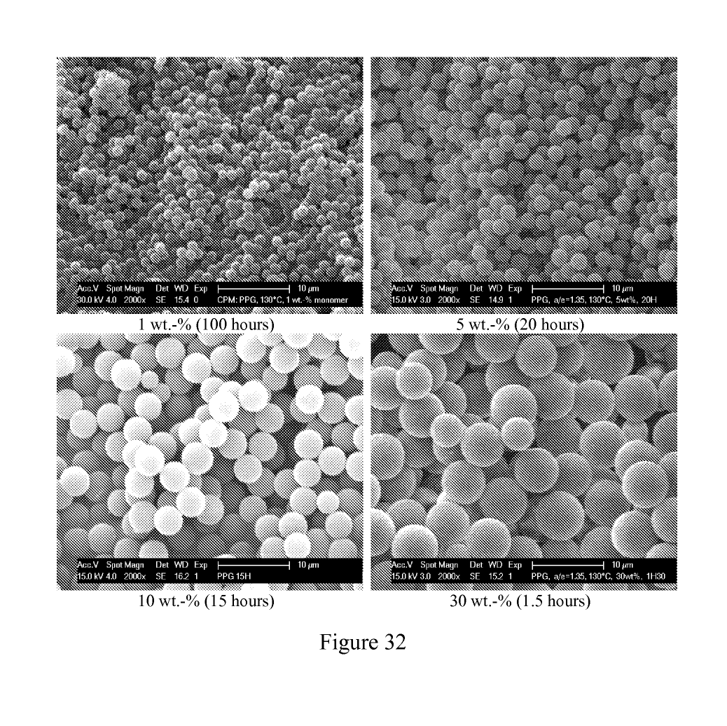

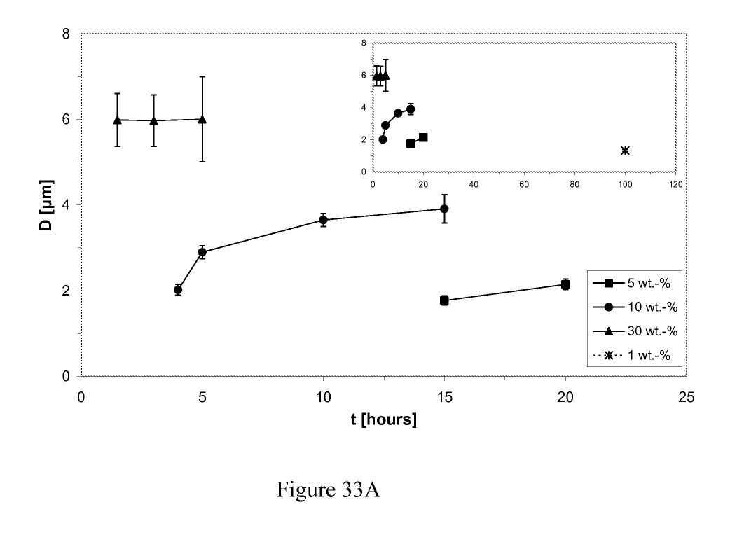

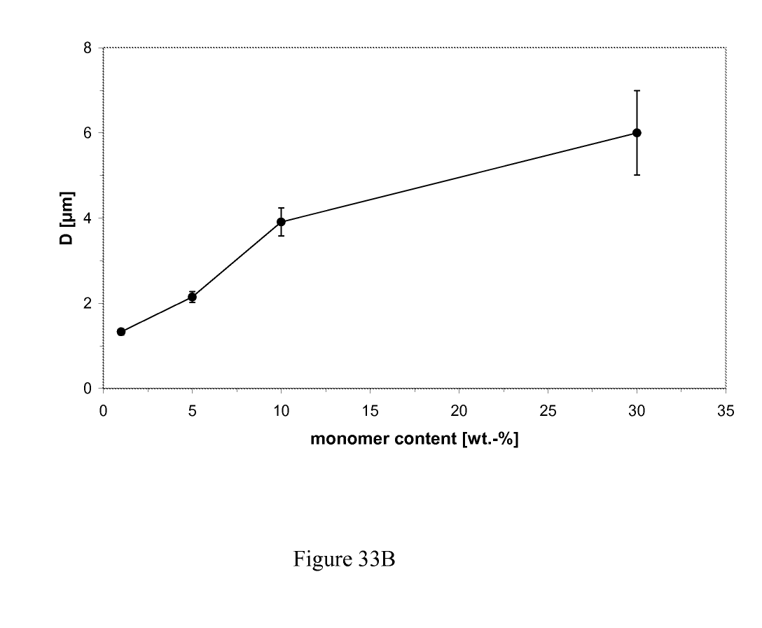

The SEM micrographs confirmed the formation of spherical micrometer-size particles. FIG. 32 shows some examples of acquired SEM micrographs of cross-linked reactive polymer microparticles, which were produced from solutions with different monomer content. Some agglomerates are observed on SEM images of cross-linked reactive polymer microparticles prepared from a 1 wt % monomer concentration. Using the SEM micrographs, the average cross-linked reactive polymer microparticle diameter (with the standard deviation) was calculated and is depicted in FIGS. 33A and 33b.

Similarly to the cross-linked reactive polymer microparticle yield and cloud point, different monomer content caused different particle growth kinetics and different value of the average cross-linked reactive polymer microparticle diameter at the plateau. This value increases almost linearly with the monomer content: the diameter at long reaction time increases from about 1 μm at 1 wt. % to about 6 μm at 30 wt. %. The smallest particles (1 μm) are the one having the highest Tg (158° C.), but the lowest yield. An increase of the polydispersity is observed as the concentration is increased even if it remained in the range of very narrow distribution (1.002-1.03). The standard deviation increased from 0.7 μm in the case of 1 wt. % after 100 hours to 1 μm in the case of 30 wt. % after 5 hours of reaction.

Influence of the Molar Ratio

The effective amine to epoxy ratio (a/e ratio) of the cross-linked reactive polymer microparticles is different from the one in the feed, which was a/e ratio=1.35. The following illustrates the effect of a variation of the molar ratio in the feed on the formation and characteristics of the cross-linked reactive polymer microparticles. Four a/e ratios were studied: 0.7 (excess of epoxy), 1 (same number of amine and epoxy), 1.35 and 2 (excess of amine).

Synthesis

There is a decrease of the time to phase separation as the amine/epoxy ratio is increased: from 267 minutes for a/e ratio=0.7 to 159 minutes for a/e ratio=2. This behavior could be related to the structure of the oligomers, which is strongly dependent on the molar ratio: at a/e ratio>1, the oligomers formed have a more linear structure, with remaining —NH groups, than the ones obtained when a/e ratio<1, which have a branched structure with dangling epoxy groups. As these oligomers do not have the same chemical structure, they have different solubility parameters and as a consequence they do not separate at the same time because of a different phase diagram. This behavior could also be related to the cross-linking kinetics, which is influenced by the relative monomer composition.

### Cross-Linked Reactive Polymer Microparticle Characterization

The time of reaction (as soon as it is higher than 5 hours) and of the values for Tg obtained during the first DSC scan or the second DSC scan do not appear to depend upon a given a/e ratio. On the contrary, there is an influence of the molar ratio, but not as expected. Specifically, a maximum Tg for de ratio=1. A decrease of Tg is observed as a/e ratio in the initial mixture is increased. These values are reported in Table 10.

TABLE 10
Tg as function of initial molar ratio.

a/e ratio (initial)

| | 0.7 | 1 | 1.35 | 2 |
|---|---|---|---|---|
| Tg (CROSS- | 159 | 153 | 146 | 132 |
| LINKED | | | | |
| REACTIVE | | | | |
| POLYMER | | | | |
| MICROPARTICLE - | | | | |
| Examples 1, 2, | | | | |
| 10, and 3, | | | | |
| respectively) ° C. | | | | |
| (2^{nd} scan) | | | | |
| Tg (Comparative | 82 | 157 | 137 | 101 |
| Epoxy Example A - | | | | |
| bulk network) ° C. | | | | |

For a/e ratio=1 and 1.35 the difference between a/e ratio in the initial mixture and in the cross-linked reactive polymer microparticles is small. The difference, however, becomes larger for a/e ratio=0.7 and 2. In both cases, the Tg of the cross-linked reactive polymer microparticles is higher than in the bulk samples (Comparative Epoxy Example A). It appears that, even if the cross-linked reactive polymer microparticle synthesis was done using a broad range of a/e ratio (from 0.7 to 2) ratio, the a/e ratio of cross-linked reactive polymer microparticles is in much more narrow range (from 1 to 1.44). The high values of Tg obtained exclude the possibility to have PPG as a miscible polymer in the cross-linked reactive polymer microparticles.

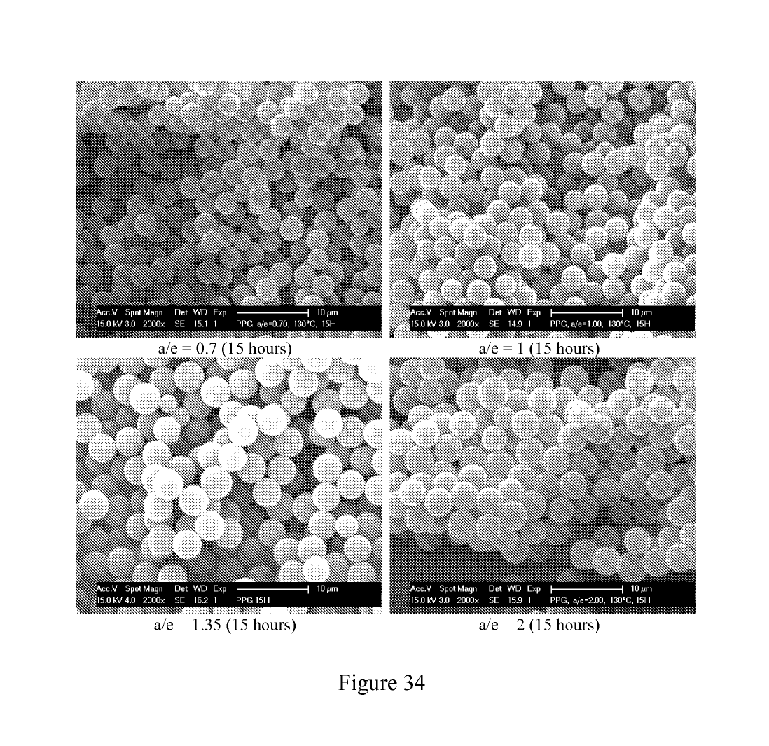

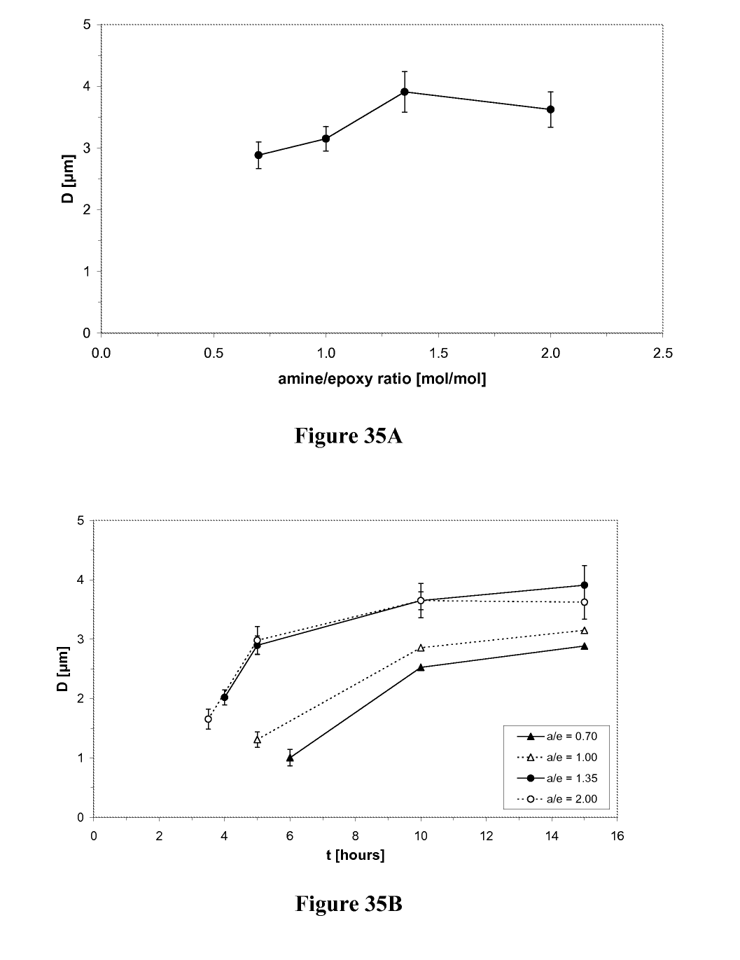

The SEM micrographs shown in FIG. 34 confirm the formation of spherical microparticles, without forming an agglomeration. Micrographs were utilized to calculate the average diameter as function of the reaction time (FIGS. 35A and 35b) for different a/e ratios. The diameter increases with the reaction time and then reaches a constant value after 10 hours of reaction. The molar ratio has a small influence on the size reached by the cross-linked reactive polymer microparticles: the largest particles, 3.6/3.9 μm are obtained with a/e ratio=2 and 1.35, the smallest particles, 2.9/3.2 μm, are obtained with a/e ratio=0.7 and 1.

### Effect of the Reaction Temperature

A parameter that influences the reaction kinetics of the cross-linked reactive polymer microparticles is the reaction temperature. For the cross-linked reactive polymer microparticle preparation via dispersion polymerization, it was varied from 80° C. to 160° C. with the molar ratio in the feed solution a/e ratio=1.35 and the monomer concentration of 10 wt %.

### Synthesis

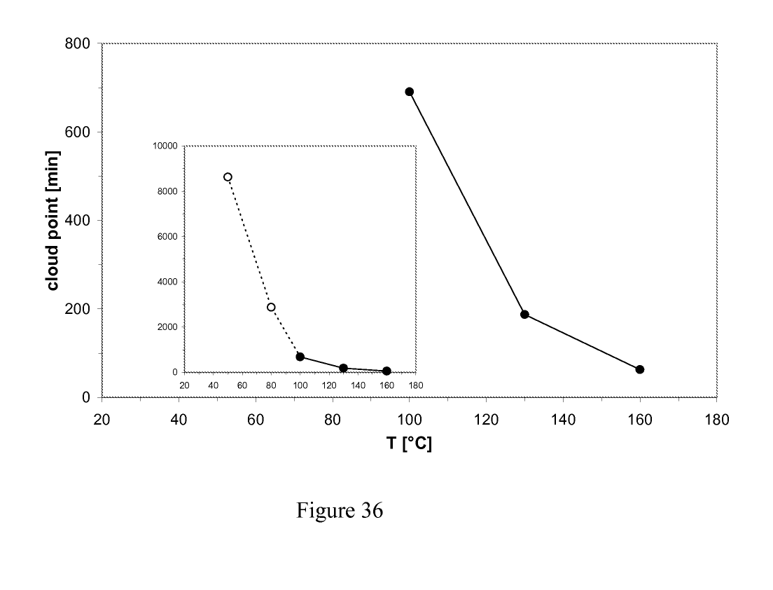

The epoxy-amine reaction is activated by the temperature; as expected with an increase in the temperature, a decrease of the time to phase separate is observed. The conversion at which phase separation takes place occurs more rapidly: cloud point shifts from 1 hour at 100° C. to 11.5 hours at 63° C. At lower temperatures, the cloud point was roughly estimated by optical observation of the solution: it is close to 48 hours at 80° C. and 144 hours at 50° C. (FIG. 36). A solution was left at room temperature during six months: in between 30 and 60 days the solution became opaque, after 90 days, precipitated cross-linked reactive polymer microparticles were observed. A full conversion is reached only when the reaction temperature is high (160 and 130° C.). For the same kinetic reason it is expected to reach a lower yield if the temperature is decreased, for a given time of reaction.

The residual solution was analyzed by SEC for the residual amount of DGEBA and DAT after the reaction was stopped. Indeed when the reaction was performed at 80, 100 or 130° C., residual monomers could be detected, for example, around 10-12 wt % for DGEBA and 2-3 wt % for DAT was left unreacted of the initial feed of the monomers in the case of reaction at 100° C. At higher temperature, less oligomers were found to be present by SEC in the residual solution.

### Cross-Linked Reactive Polymer Microparticle Characterization

At a given temperature, there is no strong effect of the reaction time on Tg (Except at 160° C.: the 1st point taken after 1.5 hours of reaction has a Tg close to 140° C. but a plateau value is reached after 5 hours). The values recorded during the 1^{st} and 2^{nd} scan are reported in Table 11; the values obtained just after the synthesis (1^{st} scan) or after the post-curing cycle in the DSC oven (2^{nd} scan) show a difference which depends on the reaction temperature. It is well known that a vitrification phenomena (where a Tg value is about equal to a cure temperature for a given system) stops the reaction; this reaction will start again as soon as the temperature increases. Nevertheless, high Tg were obtained even at low temperature (e.g., Tg=125° C. for a reaction at T=80° C.). It should be noted that the value of the final Tg depends on the reaction temperature. So the cross-linked reactive polymer microparticles structure is not the same despite the fact that the initial monomer feed is the same. For the comparison, bulk networks, synthesized from the same system (Comparative Epoxy Example A and/or Comparative Epoxy Example B), partially reacted at a low temperature and then post-cure at higher temperature, will show the same final Tg. For solution polymerisation this is not the case.

Two reasons may explain the variation of Tg. First, the effective stoichiometry of the cross-linked reactive polymer microparticles. Reference A (a/e ratio=1.35, T=130° C.) has a real stoichiometry close to 1.2. Based on the hypothesis that cross-linked reactive polymer microparticles are made of only epoxy and amine, the same calculation of effective stoichiometry was done. It is found that the effective stoichiometry increases as the reaction temperature is decreased: from 1 to 1.5 for T=160 and 50° C. respectively. Secondly, PPG is a miscible polymer in the cross-linked reactive polymer microparticles that can produce a decrease in the Tg.

TABLE 11
Values of Tg as a function of the reaction temperature
(a/e ratio = 1.35 in the feed).

| | T ° C. (time hours) | | | | |
|---|---|---|---|---|---|
| | 50 (395 | 80 (100 | 100 (50 | 130 (15 | 160 (15 |
| | hours) | hours) | hours) | hours) | hours) |
| Tg (CROSS- | 61 | 128 | 136 | 146 | 160 |
| LINKED | | | | | |
| REACTIVE | | | | | |
| POLYMER | | | | | |
| MICROPARTICLE | | | | | |
| 1^{st} scan, ° C. | | | | | |
| Tg (CROSS- | 127 | 132 | 140 | 144 | 156 |
| LINKED | | | | | |
| REACTIVE | | | | | |
| POLYMER | | | | | |
| MICROPARTICLE | | | | | |
| 2^{nd} scan, ° C. | | | | | |
| Effective | 1.5 | 1.44 | 1.35 | 1.2 | 1 |
| stoichiometry | | | | | |

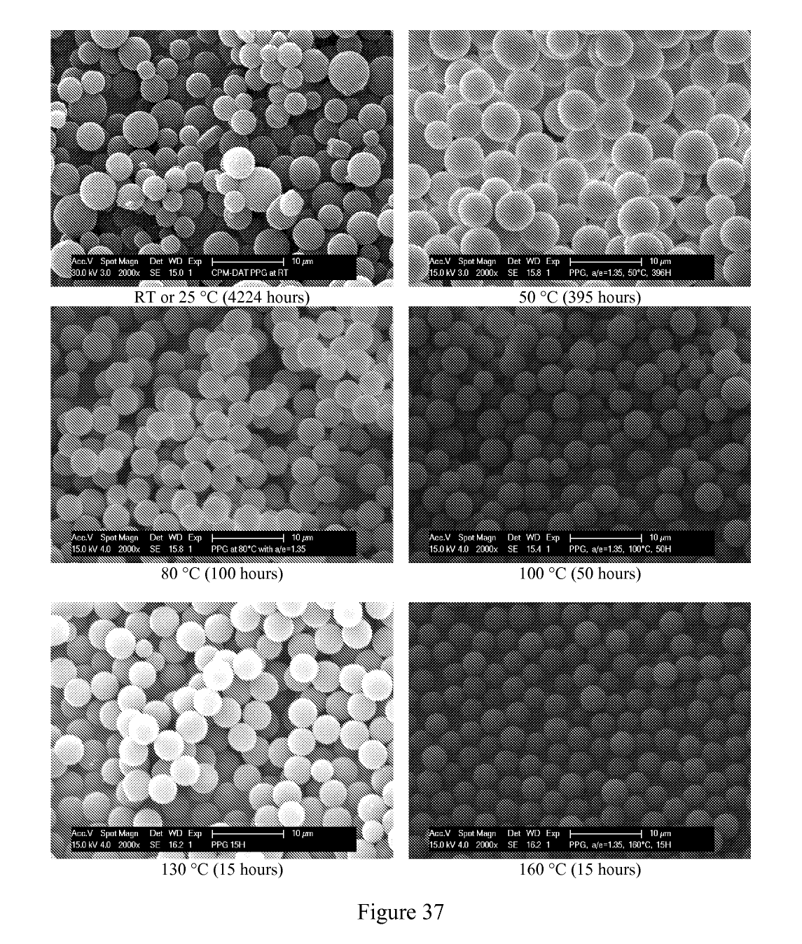

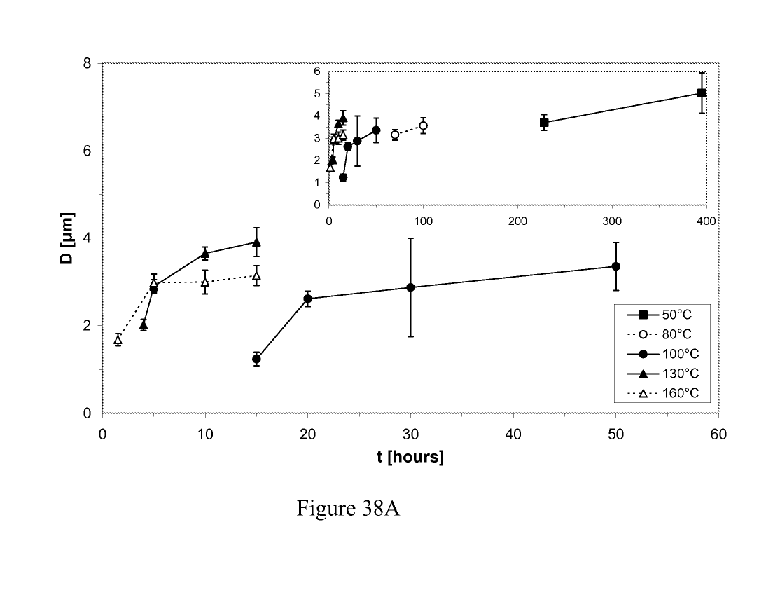

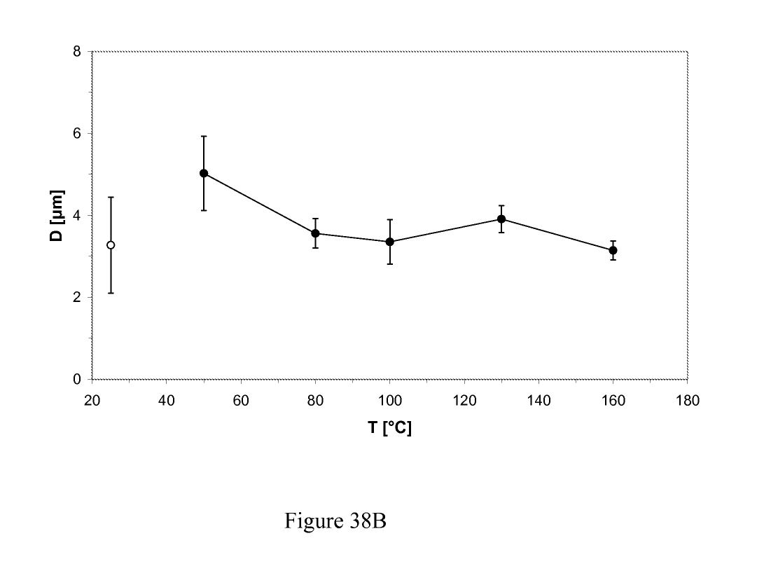

The micrographs depicted in FIG. 37 confirm that spherical microparticles are formed regardless of the temperature, and without apparent agglomeration. The average diameter of these microparticles as a function of reaction time and reaction temperature is depicted in FIGS. 38A and 38b. There is no large change in the average cross-linked reactive polymer microparticle diameter: for the reaction temperature from 80 to 160° C., the diameter is in the range 3.1 to 3.9 μm, only at 50° C. the diameter is slightly higher, around 5 μm.

PPG-Dodecane Mixtures

As solubility parameters of epoxy resins change for different molecular weight and composition, it was necessary to see how the addition of nonsolvents to the dispersion media impacts the dispersion polymerization. Dodecane was chosen for this purpose as it is a nonsolvent for both epoxy and amine and has a relatively high boiling point. The addition of a nonsolvent changes all three components of solubility parameters of the mixture. Two dodecane/PPG mixtures were prepared as dispersion media, containing 10 and 50 wt % of dodecane. The paragraphs below describe the impact of addition of dodecane on the cloud point, yield of the reaction as well as Tg and morphology of the Cross-Linked Reactive Polymer Microparticles.

Synthesis

There is a decrease of the time to phase separation when dodecane is added to PPG: from 380 minutes in the case of pure PPG-1000 down to 58 minutes in the case of 50 wt.-% of dodecane in the solution. This result was expected because of the change in the solubility parameters that was facilitated by dodecane addition. The kinetics of the amine-epoxy reaction should remain the same, since the temperature, a/e ratio and oligomer concentration remain unchanged.

The solution with 50 wt.-% dodecane leads to higher cross-linked reactive polymer microparticle yield as compared to 10 wt-% dodecane mixture.

TGA has been utilized to analyze cross-linked reactive polymer microparticles synthesized using: PPG/dodecane=90/10, reaction time of 15 hours (Example 10) and PPG/dodecane=50/50 reaction time of 10 hours (Example 12) both at T 130° C. The cross-linked reactive polymer microparticles synthesized in PPG or the PPG/dodecane mixture of 50/50 have the same behavior with a T_{5%}=338° C. (lower than the bulk network, Reference A), the cross-linked reactive polymer microparticles synthesized using only 10 wt % of dodecane in the solution has a slightly different behavior with a first mass loss of 1.5% at 140° C. and T_{5%} at 319° C., about 20° C. lower as compared to cross-linked reactive polymer microparticles. This difference probably comes from solvent left after cross-linked reactive polymer microparticles cleaning procedure.

### Cross-Linked Reactive Polymer Microparticle Characterization

The Tg of the cross-linked reactive polymer microparticles sampled after different reaction time is also investigated. For a given system, the Tg increases as the reaction progresses until its values reach a plateau. For DAT based cross-linked reactive polymer microparticles, synthesized at temperature between 100 and 160° C., the “Tg plateau” is reached after 5 hours of reaction. This appears to indicate that the chemical composition and structure of the cross-linked reactive polymer microparticles are not changing after 5 hours of reaction.

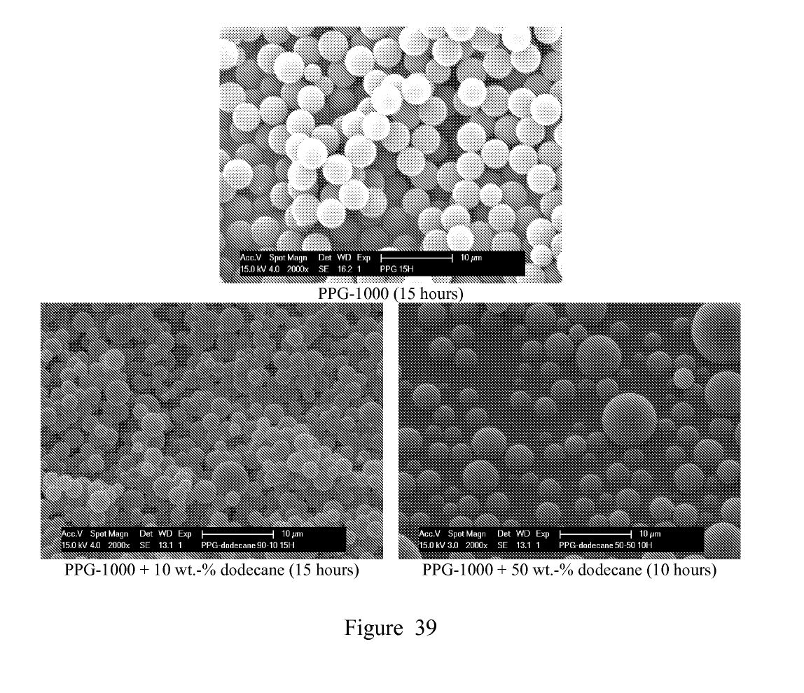

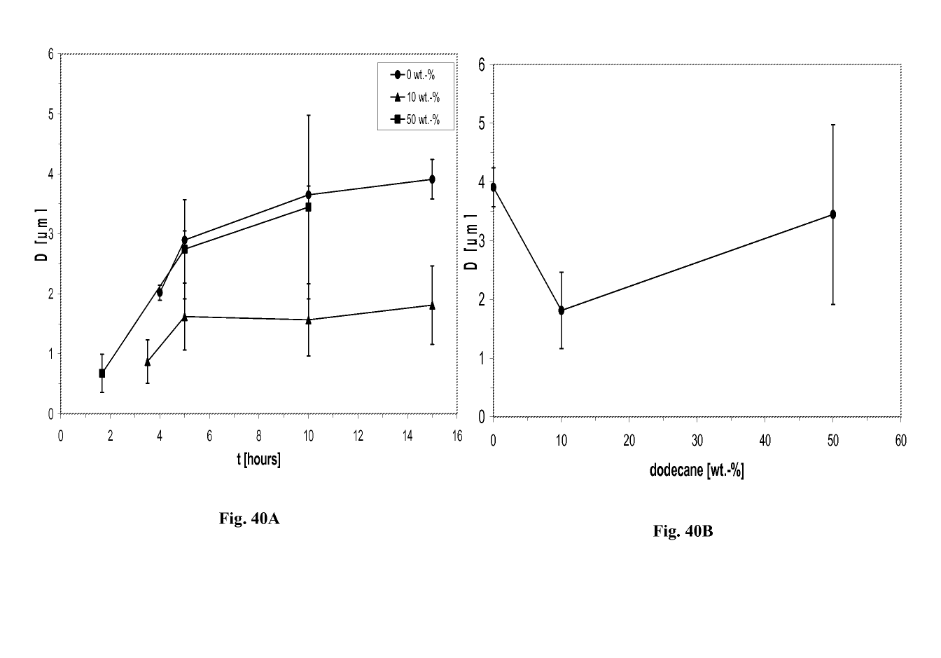

From FIG. 39, it can be seen that spherical particles are formed when the nonsolvent is added to the PPG. The particle size distribution and the average cross-linked reactive polymer microparticle diameter were calculated as a function of the reaction time and are shown in FIGS. 40A and 40B. Some differences appear. First, at short times of reaction, the dimension of the cross-linked reactive polymer microparticle was lower than 1 μm: 0.9±0.4 μm with 10 wt. % of dodecane after 3.5 hours and 0.7±0.3 μm with 50 wt. % of dodecane after 1.7 hours. This could be related to the shorter time to the cloud point in the presence of dodecane. Second, the average dimensions of the cross-linked reactive polymer microparticles in the case of 50 wt % of dodecane are the same as the ones of the cross-linked reactive polymer microparticles synthesized in only PPG-1000, whatever the reaction time. However as it is seen by comparing the micrographs of FIG. 39, the main effect of the dodecane is the broadening of the size distribution. When the reaction was stopped, the diameters were 3.5±1.5 μm and 3.9±0.3 μm respectively. The addition of the dodecane allowed the formation of cross-linked reactive polymer microparticles with diameter as low as 500 nm. Third, the average diameter of the cross-linked reactive polymer microparticles in the case of 10 wt. % of dodecane is smaller than in the case of only PPG-1000 and PPG/50 wt % dodecane: the cross-linked reactive polymer microparticles average diameter reaches 1.8±0.7 μm.

### Conclusions

Synthesis of the cross-linked reactive polymer microparticles in a mixture of PPG and dodecane can be used to obtain a broader size distribution (especially using 50 wt % dodecane) which can potentially lead to a higher degree of heterogeneity in a cross-linked reactive polymer microparticle-filled epoxy network; in addition, using 10 wt % dodecane leads to a decrease by 2 of the average diameter. Others parameters, such as the yield, the glass transition temperature and the presence of PPG in the particles were not influenced by the addition of the nonsolvent.

### Influence of the Structure of the Diamine

Isophorone diamine (IPDA) is a curing agent used with epoxy resins. Due to its chemical structure (cycloaliphatic) it reacts at lower temperature. By using IPDA to synthesize cross-linked reactive polymer microparticles the reaction temperature could be reduced, which allowed use of solvents with low boiling point in synthesizing the cross-linked reactive polymer microparticles. The influence of stoichiometry, temperature and solvents on the cross-linked reactive polymer microparticles morphology and composition is now discussed.

Characterization of the Reference System

The same protocol was applied for the synthesis of IPDA-based microparticles (Examples 19-25) as for DAT based particles (Examples 1-12), except that the reaction temperature for the Reference B was 80° C. instead of 130° C. (a/e ratio=1.35, c=10 wt %, solvent: PPG-1000). It was observed that (1) phase separation occurs after 4 hours at 80° C. (it was ˜48 hours in the same conditions for DAT); (2) the yield of the reaction was found equal to 76 wt % after 24 hours of reaction (similar synthesis done in PPG-3500 gives a yield of 94%); this value was confirmed on different batches of cross-linked reactive polymer microparticles; (3) the TGA analysis of cross-linked reactive polymer microparticles revealed very similar mass loss versus temperature profile as one obtained on DAT-based cross-linked reactive polymer microparticles: the beginning of degradation is at the same temperature (T_{5%} is equal to 336° C.), however the curve is slightly shifted to lower temperature; (4) the glass transition temperature of cross-linked reactive polymer microparticles, which were sampled after a given reaction time, was difficult to determine with the given method without ambiguity.

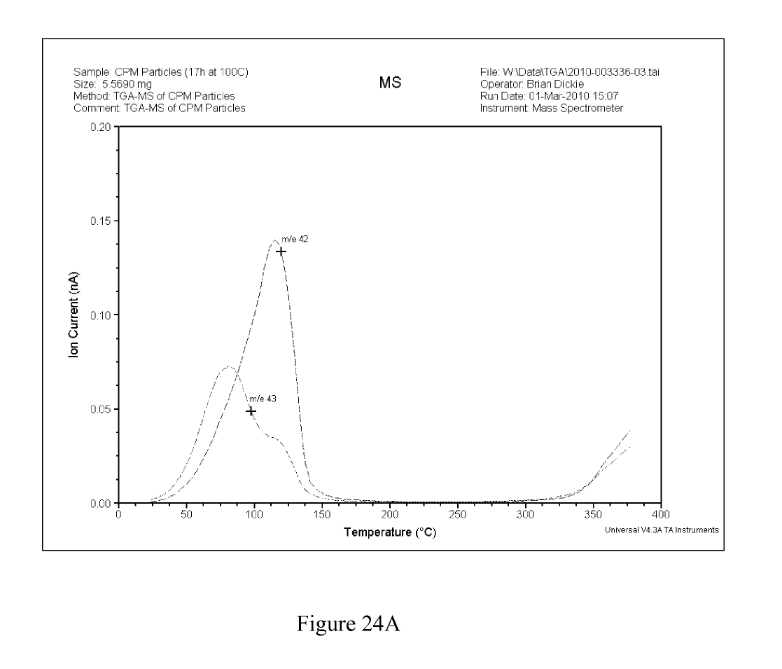

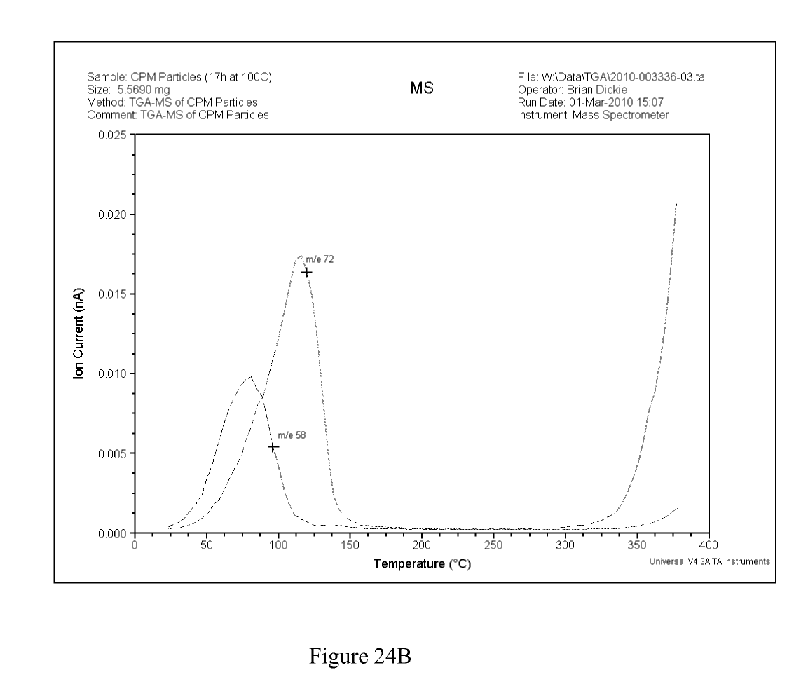

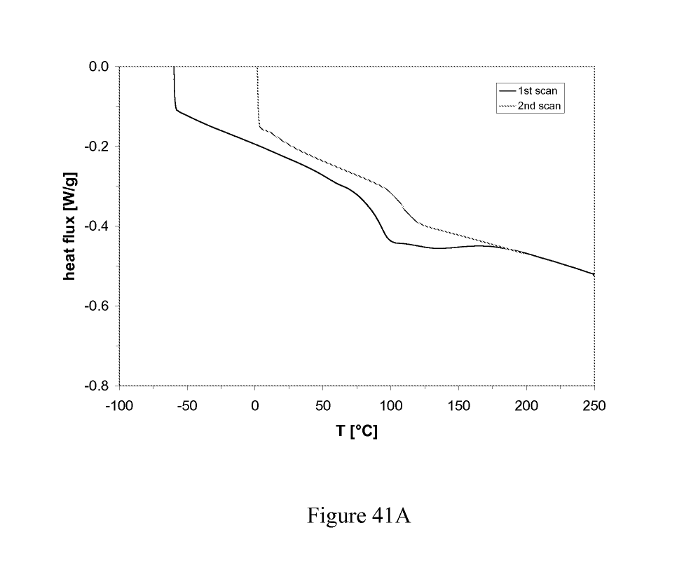

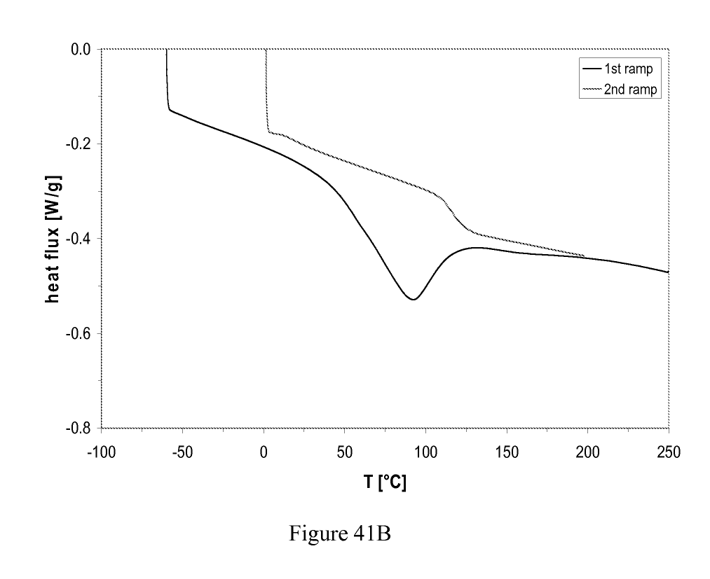

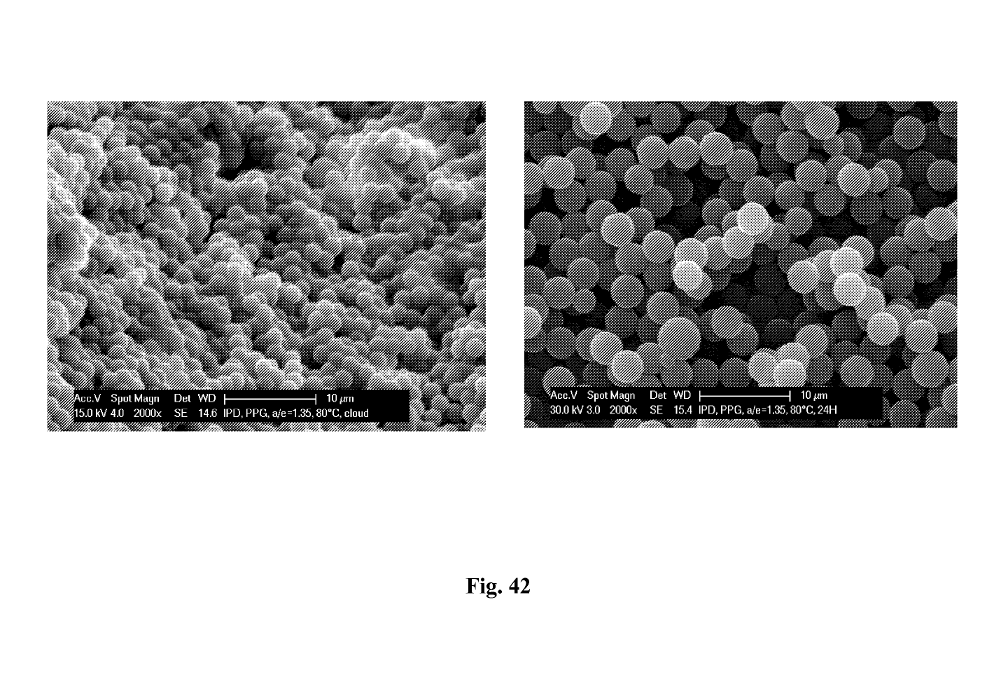

FIGS. 41A and 41b show the thermograms obtained during two successive scans: after 17 hours of reaction (FIG. 41A) and 24 hours of reaction (FIG. 42b). As already mentioned, (thermal properties of cross-linked reactive polymer microparticles) the signal during the 1^{st} scan is very often perturbed by residual solvent evaporation; it is the case in FIG. 41A. Hence the Tg, equal to 53° C., extracted from this graph may be underestimated due to the presence of the endothermic peak of solvent evaporation. For a longer time of reaction the signal is not perturbed by the solvent and a clear Tg equal to 93° C. is observable.

As presented in Table 12, the maximum attainable Tg of this epoxy-amine combination system is as high as 149° C., hence some of epoxy and amine groups remain unrecated in these cross-linked reactive polymer microparticles. This is a different behaviour as compared to DAT-based cross-linked reactive polymer microparticles where maximum Tg value can be reached when the reaction was stopped (15 hours at T=130° C.). However the reaction temperature as well as the reaction time was, in the case of DAT-based Cross-Linked Reactive Polymer Microparticles, more favourable to lead to higher Tg. For a bulk network with amine/epoxy ratio of 1.35, the Tg temperature is equal to 125° C., however even after the second scan, as shown in FIGS. 41A and 41b, these values for IPDA-based cross-linked reactive polymer microparticles is not reached.

This confirms that the effective stoichiometry of cross-linked reactive polymer microparticles is substantially different from the one in the initial monomer solution. Considering the Tg obtained during the 2^{nd} scan, after the post-cure in the DSC, and that no residual solvent (PPG) is present in the cross-linked reactive polymer microparticles, an effective stoichiometry can be estimated from the variation of Tg as a function of a/e ratio. Two values are possible: 0.8/0.85 (excess of epoxy) or 1.5/1.6 (excess of amine). The second value is believed to be more realistic as there was an excess of IPDA at the start of the reaction.

TABLE 12
Values of Tg as a function of reaction time at 80° C.

time (hours) at T = 80° C.

| | 17 | 24 |
|---|---|---|
| Tg (CROSS-LINKED | 53 | 93 |
| REACTIVE | | |
| POLYMER | | |
| MICROPARTICLE of | | |
| Example 19) 1^{st} scan, | | |
| ° C. | | |
| Tg (CROSS-LINKED | 116 | 108 |
| REACTIVE | | |
| POLYMER | | |
| MICROPARTICLE of | | |
| Example 19) 2^{nd} scan, | | |
| ° C. | | |

| | |
|---|---|
| Effective stoichiometry | 0.8/0.85 or 1.5/1.6 |

SEM micrographs show that IPDA based cross-linked reactive polymer microparticles are spherical particles, often agglomerated (especially when samples after short reaction time (4.5 hours) and where the Tg of cross-linked reactive polymer microparticles is low). It is considered that the cross-linked reactive polymer microparticles might have residual amino or epoxy groups, especially at short reaction time, which can react during the drying step and leading to agglomeration. The reaction time has an influence on the particle diameter: it increases from 2 μm to 3.5 μm, but distribution remains narrow. The diameter at the end of the reaction is in the same rage as the one found on the reference DAT-based cross-linked reactive polymer microparticles.

Influence of the Molar Ratio

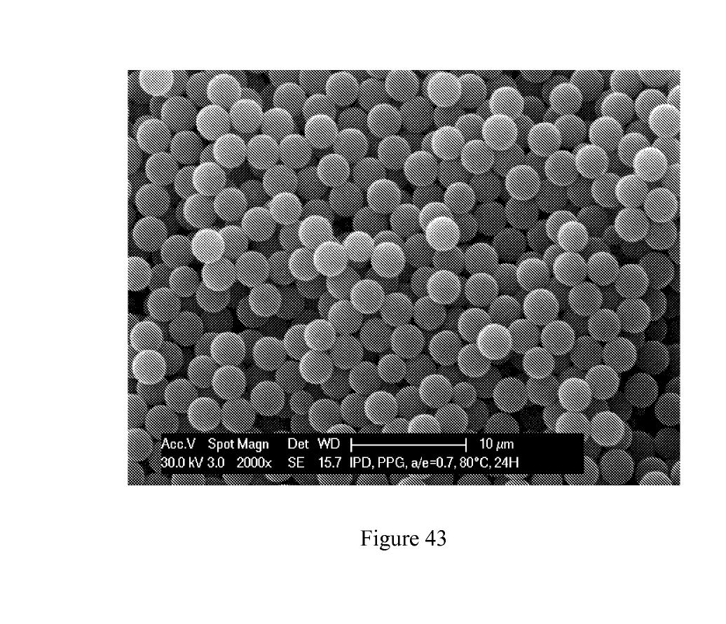

The influence of molar ratios was studied by examining the morphology and Tg for the cross-linked reactive polymer microparticles of Examples 25, 19 and 24 (amine to epoxy molar ratios: 0.7, 1 and 1.35, respectively). The following is observed: the Tgs are reported in Table 13. After a 17 hour reaction time, the first scan reviled the Tg of cross-linked reactive polymer microparticles (1^{st} scan signal was also perturbed by solvent evaporation) as low as 49 to 57° C. However, after post-curing the Tgs increased, especially when the initial a/e ratio was low. As in the case of DAT-based cross-linked reactive polymer microparticles, the maximum Tg was obtained for a/e ratio=0.7; the SEM micrographs show spherical, non agglomerated microparticles. An example of high Tg cross-linked reactive polymer microparticles (a/e ratio=0.7) image is given in FIG. 43. The diameter increases only slightly with the initial value of a/e ratio: from 2.7 μm, to 3 μm and 3.2 for 0.7, 1 and 1.35 respectively.

TABLE 13
Tg as a function of the initial stoichiometry.

| | a/e ratio | | |
|---|---|---|---|
| | 0.7 | 1 | 1.35 |
| Tg (CROSS-LINKED | 57 | 49 | 52 |
| REACTIVE | | | |
| POLYMER | | | |
| MICROPARTICLE - | | | |
| Examples 25, 19, 24) | | | |
| 1^{st} scan, ° C. | | | |
| Tg (CROSS-LINKED | 141 | 131 | 116 |
| REACTIVE | | | |
| POLYMER | | | |
| MICROPARTICLE - | | | |
| Example 25, 19, 24) | | | |
| 2^{nd} scan, ° C. | | | |
| Tg (Comparative | 75 | 149 | 125 |
| Epoxy Example A) | | | |
| ° C. | | | |
| Effective | ~0.95 | 0.92 or 1.3 | ~0.85 or 1.5 |
| stoichiometry | | | |

### Influence of the Synthesis Temperature (80, 100 and 130° C.) and Addition of a Non-Solvent (10 wt % Dodecane to the Dispersion Media).

Through this set of experiments the feed a/e ratio were kept at de ratio=1.35 and monomer concentration at 10 wt %. Synthetic procedures where different solvents (1-octanol, cyclohexanone and cyclohexane) were utilized as a dispersion media: in some cases cross-linked reactive polymer microparticles were obtained, however with the low yield and agglomeration of cross-linked reactive polymer microparticles.

The effect of addition of a non-solvent and of temperature on cross-linked reactive polymer microparticle morphology and composition is as follow: (1) Table 14 shows a dependence of the yield on temperature. At short reaction times (4.5 hours) some correlation exists. However, at long reaction time (17 hours), the yield is above 90% regardless of temperature (2) the Tg of cross-linked reactive polymer microparticles does not vary with the reaction temperature after 17 hours of reaction time and is close to 50° C. although higher Tg were expected with a higher reaction temperature. 50° C. is definitively too low for long reaction times at 130° C. taking into account the high reactivity of IPDA.

TABLE 14
Yield and Tg of CROSS-LINKED REACTIVE POLYMER
MICROPARTICLE
synthesized at different temperature, in PPG + 10% dodecane.

| | T (° C.) | | |
|---|---|---|---|
| | 80 | 100 | 130 |
| Tg (CROSS-LINKED | 51 | 52 | 53 |
| REACTIVE POLYMER | | | |
| MICROPARTICLE - Examples | | | |
| 20, 21, 22) 1^{st} scan, ° C. | | | |
| (after 17 hours) | | | |
| Tg (CROSS-LINKED | 102 | 108 | 125 |
| REACTIVE POLYMER | | | |
| MICROPARTICLE - Examples | | | |
| 20, 21, 22) 2^{nd} scan, ° C. | | | |
| Tg (Comparative Epoxy | 125 | 125 | 125 |
| Example A) ° C. | | | |

| | | |
|---|---|---|
| Effective stoichiometry | ~0.85 or 1.5 | 1.35 |

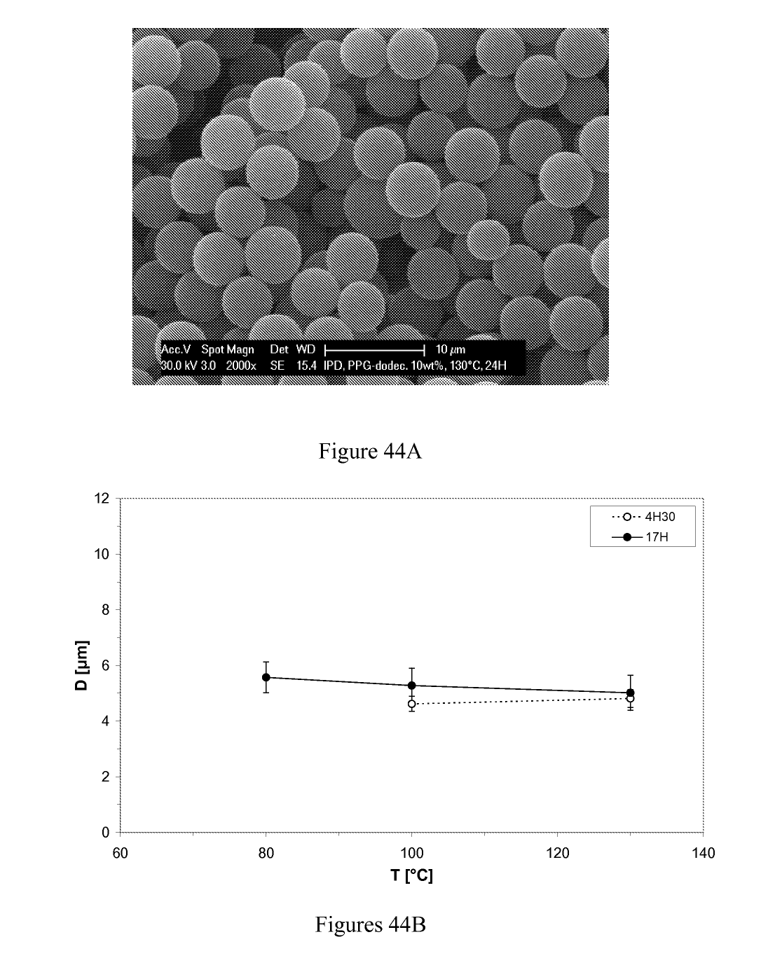

The SEM images reveal spherical microparticles as shown in FIG. 44A. The average diameter as a function of reaction time and temperature is presented in the same FIG. 44b. It is evident that these two parameters have no significant influence on the size of the cross-linked reactive polymer microparticles.

### Conclusions

The synthesis of cross-linked reactive polymer microparticles based on DGEBA and IPDA can be performed, at a lower temperature than with DAT using either in PPG or in a mixture of PPG+10 wt % dodecane as a dispersion media. Spherical microparticles were obtained in both solvents and have narrow size distribution. As for DAT-based cross-linked reactive polymer microparticles, the effective stoichiometry of the cross-linked reactive polymer microparticles is different from the one in the feed based on the DSC analysis. The diameters are in the range of 3 μm for the synthesis in PPG, and around 5 μm for the synthesis in the mixture of PPG and dodecane. After post-curing, the Tg of the cross-linked reactive polymer microparticles is between 102° C. and 141° C. depending on the conditions of the synthesis.

1. A composition of cross-linked reactive polymer microparticles having a number average diameter distribution of 10 nm to 10000 nm as measured using scanning electron microscopy, comprising:
a reaction product of an epoxy resin and an amine curing agent reacted in dispersing media at a temperature of 50° C. to 120° C. for a reaction time of no greater than 17 hours, during which the cross-linked reactive polymer microparticles phase separate in a discrete non-agglomerated form from the dispersing media; and
dispersing media bound to the cross-linked reactive polymer microparticles of no greater than 0.001 weight percent based on the weight of the cross-linked reactive polymer microparticles as measured by Thermal Gravimetric Analysis coupled with Mass Spectroscopy.

2. The composition of claim 1, where the reaction product is formed with an excess of the amine curing agent or the epoxy resin as expressed in an equivalent weight ratio.

3. The composition of claim 2, where the excess of the amine curing agent is a 35 percent excess of amine curing agent to epoxy resin as expressed in the equivalent weight ratio.

4. The composition of claim 1, where the epoxy resin and the amine curing agent each have a concentration in the dispersing media of 5 to 30 weight percent based on the total weight of the dispersing media, the epoxy resin and the amine curing agent.

5. (canceled)

6. The composition of claim 1, where the amine curing agent is selected from the group consisting of an aromatic curing agent, a cycloalophatic curing agent, aliphatic curing agent and combinations thereof.

7. The composition of claim 1, where the dispersing media is selected from the group consisting of poly(oxypropylene), dodecane, aliphatic ketone, cyclic ketone, alkene aliphatic, aromatic alkene, polyethers and combinations thereof.

8. The composition of claim 1, where the dispersing media includes polybutylene oxide and the cross-linked reactive polymer microparticles have a bimodal size distribution of a first diameter and a second diameter, the first diameter being from 100 to 300 nm as measured using scanning electron microscopy and the second diameter being from 0.5 to 10 μm as measured using scanning electron microscopy.

9. The composition of claim 1, where the amine curing agent is isophorone diamine and has an equivalent weight ratio relative to the epoxy resin of 0.7 to 1.35.

10. The composition of claim 9, where the epoxy resin has a concentration in the dispersing media of 10 weight percent based on the total weight of the dispersing media, the epoxy resin and the amine curing agent, and reacts with the isophorone diamine at the temperature of 80° C.

11. The composition of claim 1, where the cross-linked reactive polymer microparticles include no surfactant.

12. A method of producing cross-linked reactive polymer microparticles, comprising:
reacting an epoxy resin with an amine curing agent in a dispersing media at a temperature of 50° C. to 120° C. for a reaction time of no greater than 17 hours so that the cross-linked reactive polymer microparticles have no greater than 0.001 weight percent of the dispersing media bound to the cross-linked reactive polymer microparticles; and
phase separating the cross-linked reactive polymer microparticles and the dispersing media.

13. The method of claim 12, including removing the dispersing media from the cross-linked reactive polymer microparticles to leave no greater than 0.001 weight percent of the dispersing media bound to the cross-linked reactive polymer microparticles.

14. The method of claim 12, where reacting the epoxy resin with the amine curing agent includes forming the cross-linked reactive polymer microparticles with an excess of the amine curing agent or the epoxy resin as expressed in an equivalent weight ratio.

15. The method of claim 14, where forming the cross-linked reactive polymer microparticles is with an equivalent weight ratio of amine curing agent relative to the epoxy resin of 0.7 to 1.35.

16. The method of claim 12, where reacting the epoxy resin with the amine curing agent includes reacting the epoxy resin with the amine curing agent for the reaction time of no greater than 5 hours.

17. The method of claim 12, where reacting the epoxy resin with the amine curing agent in the dispersing media is at a temperature of 80° C.

18. The method of claim 12, including using a solvent to remove the dispersing media from the cross-linked reactive polymer microparticles to leave no greater than 0.001 weight percent of the dispersing media bound to the cross-linked reactive polymer microparticles.

19. The method of claim 12, where each of the epoxy resin and the amine curing agent have a concentration in the dispersing media of 5 to 30 weight percent based on the total weight of the dispersing media, the epoxy resin and the amine curing agent.

20. The method of claim 12, including producing a bimodal size distribution of the cross-linked reactive polymer microparticles of a first diameter and a second diameter, the first diameter being from 100 to 300 nm and the second diameter being from 0.5 to 10 μm.

21. The method of claim 12, including not using a surfactant in producing the cross-linked reactive polymer microparticles.
